(19) United States
(12) Patent Application Publication
(10) Pub. No.: US 2005/0203673 A1
(43) Pub. Date: Sep. 15, 2005

(54) Wireless communication framework

(76) Inventors: Hassanayn Machlab El-Hajj, Coralville, IA (US); Andrew Smith, Cedar Rapids, IA (US); Gregory A. Dils, Tiffin, IA (US); Gregory Kelsey, Cedar Rapids, IA (US); Mark Brown, Iowa City, IA (US); Nik Neymeyer, Marion, IA (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/853,513

(22) Filed: May 24, 2004

Related U.S. Application Data
(63) Continuation of application No. PCT/US04/11326, filed on Apr. 12, 2004.
Application No. PCT/US04/11326 is a continuation-in-part of application No. 10/091,096, filed on Mar. 4, 2002.
Application No. PCT/US04/11326 is a continuation-in-part of application No. 09/640,785, filed on Aug. 18, 2000.
(60) Provisional application No. 60/351,165, filed on Jan. 23, 2002.
(60) Provisional application No. 60/462,561, filed on Apr. 11, 2003.
(60) Provisional application No. 60/462,583, filed on Apr. 11, 2003.
(60) Provisional application No. 60/462,582, filed on Apr. 11, 2003.

(51) Int. Cl. G06F 17/00

(52) U.S. Cl. 701/1

(57) ABSTRACT

A system and method for effectuating messaging between a first unit and a target unit by using a communication framework and one or more transport modules is provided. The system may include at least one application program operable to originate to and terminate electronic messages from a target unit. The transport modules provided for exchanging with the target unit the electronic messages that are originated to and terminated from the at least one application program. The at least one transport module is adapted to provide connectivity to the target unit via at least one of a plurality of networks. The communication framework adapted to select one or more of the transport modules based on dynamic-delivery policies, and in turn, to pass between the selected transport modules and the application program the electronic messages originated to and terminated from the target unit.

### REFERENCE TO RELATED APPLICATIONS

The present application is a continuation of International Application No. PCT/US04/11326, filed Apr. 12, 2004, which claims the benefit of (i) U.S. Provisional Patent App. Ser. No. 60/462,561, filed Apr. 11, 2003, entitled “System, Method and Computer Program Product for Remote Vehicle Diagnostics, Telematics, Monitoring, Configuring, and Reprogramming,” (ii) U.S. Provisional Application No. 60/462,582, entitled “Wireless Communication Framework”, filed Apr. 11, 2003, and (iii) U.S. Provisional Application No. 60/462,583 (Attorney Docket No. 03-050-D), entitled “Vehicle Interactive System”, filed Apr. 11, 2003; the present application is also a continuation-in-part, claiming the benefit of commonly assigned, co-pending U.S. patent application Ser. No. 10/091,096, filed Mar. 4, 2002, entitled “Remote Monitoring, Configuring, Programming and Diagnostic System and Method for Vehicles and Vehicle Components,” which claims the benefit of U.S. Provisional Application No. 60/351,165, entitled “Wireless Communication Framework”, filed Jan. 23, 2002, and is a continuation-in-part, claiming the benefit of commonly assigned, co-pending U.S. patent application Ser. No. 09/640,785, filed Aug. 18, 2000, entitled “System, Method and Computer Program Product for Remote Vehicle Diagnostics, Monitoring, Configuring and Reprogramming,” the disclosures of which are incorporated by reference in their entirety.

The following related applications are hereby incorporated herein by reference in their entirety:
U.S. Provisional Application No. 60/354,673, filed Feb. 5, 2002, entitled “Vehicle-Interactive System;”
U.S. Utility application Ser. No. 10/358,637, filed Feb. 5, 2003, entitled “Vehicle-Interactive System;”
U.S. Utility application Ser. No. 10/084,800, filed Feb. 27, 2002, entitled “Vehicle Telemetry System and Method;”
U.S. Utility application Ser. No. 10/229,757, filed Aug. 28, 2002, entitled “Remote Vehicle Security System;
U.S. Utility application Ser. No. ______ (Attorney Docket No. 03-089-01), entitled “System, Method and Computer Program Product for Remote Vehicle Diagnostics, Telematics, Monitoring, Configuring, and Reprogramming,” filed concurrently herewith; and
U.S. Utility application Ser. No. ______ (Attorney Docket No. 03-050-E), entitled “Vehicle Interactive System,” filed concurrently herewith.

### TECHNICAL FIELD

The presently disclosed embodiment relate generally to telecommunications in conjunction with computer data and information systems, and more particularly to telematics and computer tools for storing, processing, and displaying vehicle information.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### BACKGROUND

It is common for companies to own large numbers or fleets of commercial motor vehicles. Typical examples of such companies include commercial courier services, moving companies, freight and trucking companies, truck leasing companies, as well as passenger vehicle leasing companies and passenger couriers. Optimizing vehicle performance may involve minimizing the time spent in vehicle maintenance and repair, which in turn contributes to the profitability of such companies. Maintaining optimum vehicle performance often involves removing vehicles from service to conduct fault analysis, to perform scheduled maintenance, to monitor and analyze vehicle diagnostics, and to modify vehicle parameters for upgrades and program level changes.

To facilitate this objective, some companies implement on-board vehicle systems to maintain current information and to implement program level changes in various components of the vehicle. In general, these vehicle systems facilitate via tethered or wireless connection data or information transfer between the on-board vehicle systems and a vehicle diagnostic system. Traditional vehicle diagnostics systems have taken two major forms. The first of these includes very limited in-vehicle diagnostics displays (such as oil-pressure gauges and “check engine” indicators). And the second includes comprehensive service-bay scan tools in the form of handheld diagnostic devices or diagnostics software for personal computers. Each form serves a very specific audience.

The former notifies the driver of serious problems, while the latter enables service technicians to diagnose and repair problems indicated by the vehicle's electronic control modules. While these systems function well, they have operational limits that can result in extra cost and downtime for the vehicle. For example, the in-vehicle diagnostics displays often reveal problems only after they have become serious, while there may have been early indications of a problem forming that could have been revealed by more sophisticated tools.

Generally, the vehicle diagnostic systems have a central computer system that communicates with the on-board vehicle systems. The central computer system typically receives data from and/or sends data to the on-board vehicle system through the central computer, which in turn, communicates with a user through a user device such as personal computer, personal digital assistant (PDA), or other electronic device. Various vehicle systems can be used to communicate various types of information, such as vehicle security information, vehicle position/location, driver trip information, jurisdiction boundary crossing information, fuel consumption information, driver messaging, concierge services, and information relating to local and remote diagnostics, such as monitoring the wear and tear of the vehicle and its various components, among others.

While these vehicle diagnostic systems provide a centrally located method for communicating with and maintaining centralized records of activities of a vehicle, some drawbacks exist. Specifically, many different types of software platforms may be used on the centrally located computer, the user device, and/or the vehicle system. Further, each of the vehicle diagnostic systems is typically written in proprietary and non-standard, customized software around a specific vehicle communications protocol (e.g., J1708, J1939, CAN, CANII, and etc). As onboard vehicle systems and communications protocols proliferate and change, the design and development life-cycle of vehicle-interaction applications begins anew, many times creating and re-creating non extensible and non-scalable software. These proprietary and non-standard customized software applications suffer from not being able to support (i) more than one type of platform, (ii) standard operating systems, (iii) widely used embedded computers, Windows portable devices, and PalmOS devices, and (iv) other standardized frameworks

Further, the on-board vehicle systems may include more than one vehicle controller. These vehicle controllers may or may not communicate according to the same protocol. Thus, different customized software applications may be needed to communicate with each of vehicle controllers when a single vehicle protocol may not be sufficient. In addition to the cost of such additional applications, customers may have to pay for the incremental cost of the vehicle information system's users (typically a service station or other attendant) time for switching between applications for each of the differing vehicle controllers. As the number of vehicle controllers and the wage of a user increases, this incremental cost may be quite substantial.

Moreover, because the customized software applications are generally written for specific platforms, its functionality is generally concentrated on a single platform. As such, legacy systems provided customized solutions for each specific software platform used on the mobile unit or central computer, which has resulted in many legacy systems being locked into a single comprehensive, non-distributed and non-scalable customized solution as the difficulty of accommodating all applications and networks is difficult.

Vehicle diagnostic systems may include an integrated, or add-on communications interface unit that can communicate with the computing system via local or remote tethered connections, as well as remote landline and wireless network connections. The proliferation of wireless services, technologies, protocols and wireless service providers as well as the cost and difficulty of accommodating such proliferation in vehicle applications and communication interface units, however, has resulted in many legacy systems being locked into a single comprehensive, non-distributed and non-scalable customized communication solution, thereby limiting competitive marketplace advantages. As a result, vehicles of the same fleet may be required to use a different wireless service providers, different wireless technologies and protocols to communicate with the central computer. While multiple services and/or providers may be available for any given vehicle or fleet, generally, the companies have to choose one of them for all of the fleet without regard to the optimum cost of service in any particular geography. Generally, a compromise has to be made when selecting a carrier and technology rather than being able to make a cost determination of quality of service determination based on location or other on-the-fly parameter.

Consequently, the vehicle diagnostic system, including the communication interface, must be configured for each specific software platform used on the vehicle, fleet, and/or central computer, as well as the desired wireless service and technology used to transmit information between the communication interface unit and the central computer. What is needed therefore is a wireless communication system and framework that, among other things, does not lock the vehicle and/or fleet owner into a single comprehensive, non-distributed and non-scalable customized communication solution.

### SUMMARY

One embodiment is directed to a computer system having an application program, wireless communication framework for processing messages provided by the application program, and a plurality of transport modules that link the wireless communication framework to a respective plurality of networks for transporting the message to a second unit.

In a second embodiment, a system may include at least one application program operable to originate to and terminate electronic messages from a target unit. The transport modules provided for exchanging with the target unit the electronic messages that are originated to and terminated from the at least one application program. The at least one transport module is adapted to provide connectivity to the target unit via at least one of a plurality of networks. The communication framework adapted to select one or more of the transport modules based on dynamic-delivery policies, and in turn, to pass between the selected transport modules and the application program the electronic messages originated to and terminated from the target unit.

In another embodiment, a method directed for transporting such messages from a first unit is also provided. This method may include the following. The message is first transported from an application program to a wireless communication framework. The message is then processed in the wireless communication framework to select one of a plurality of transport modules that correspond with one of a plurality of networks. The message is then transported through the selected network to a second unit.

In yet another embodiment, a method for dispatching a message from a first unit and receiving a message at a second unit is provided. Here, the first unit includes a first application program and a first part of a wireless communication framework. The second unit includes a second application program and a second wireless communication framework. The message is dispatched from the first application program and received in the first part of the wireless communication framework. The message is processed to select one of a plurality of transport modules that correspond to one of a plurality of networks. The message is transported through the network to the second unit. The message is received in a second part of the wireless communication framework and processed for the second application program. The message is provided to the second application program by the second part of the wireless communication framework.

Further embodiments and variations will be apparent from the drawings and description below.

### BRIEF DESCRIPTION OF THE DRAWINGS

Exemplary embodiments are described below in conjunction with the appended drawing figures, wherein like reference numerals refer to like elements in the various figures, and wherein

FIG. 1 is a first block diagram illustrating an overall system according to one embodiment;

FIG. 2 is a second diagram illustrating a system architecture according to one embodiment;

FIGS. 3A and 3B are third and fourth block diagrams illustrating one embodiment of an on-board unit in one embodiment;

FIG. 4 is a fifth block diagram illustrating a wireless communication system according to one embodiment;

FIG. 5 is a sixth block diagram illustrating a wireless communication framework for a wireless communication system according to one embodiment;

FIG. 6 is a first flow chart depicting the operation of a wireless communication system according to one embodiment;

FIG. 7 is a second flow chart depicting the operation of a wireless communication system according to one embodiment;

FIG. 8 is a third flow chart depicting the operation of a wireless communication system according to one embodiment;

FIG. 9 is a seventh block diagram illustrating an off-board architecture for a Wireless Communication Framework, or alternately, a complementary on-board architecture for the Wireless Communication Framework according to an exemplary embodiment;

FIG. 10 is a fourth flow chart illustrating a message flow of the Wireless Communication Framework using a routing, retry, and escalation manager according to another embodiment;

FIG. 11 is a fifth flow diagram illustrating a flow for queuing an outbound message according to yet another embodiment;

FIG. 12 is a sixth flow diagram illustrating a flow for sending, via a connectionless transport network, an outbound message from a transport queue according to one embodiment;

FIG. 13 is a seventh flow diagram illustrating a flow for receiving a Wireless Communication Framework packet at a transport module of a connectionless transport one an on-board architecture according to one embodiment;

FIG. 14 is a eighth flow diagram illustrating a flow for receiving an acknowledgement message for an outbound message that was previously sent according to one embodiment;

FIG. 15 is a ninth flow diagram illustrating a flow for receiving an application message at a transport module of a connectionless transport one an on-board architecture according to one embodiment; and

FIG. 16 is a tenth flow diagram illustrating a flow for delivering an unhandled message in an InBox of the Wireless Communication Framework to a client application according to one embodiment.

### DETAILED DESCRIPTION OF THE EMBODIMENTS

1 System Functionalities and Architecture

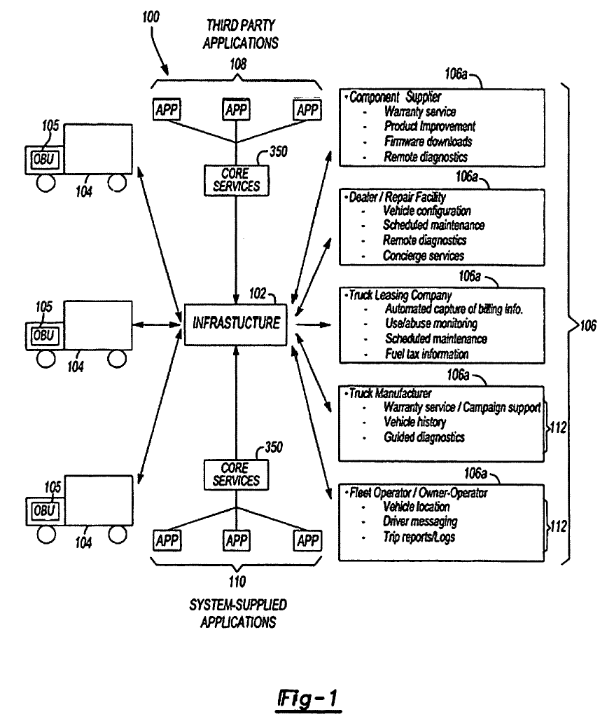

FIG. 1 is a block diagram of a vehicle monitoring and diagnostics system 100 that is configured to use a Wireless Communication Framework (WCF) according to an exemplary embodiment. While the following describes the WCF with reference to vehicle monitoring and diagnostics, the WCF may be used in any telecommunication system in which messages may be exchanged between at least one mobile communication unit and a fixed communication unit over one or more communication systems. As will be described in more detail below, the WCF beneficially provide a cost-effective, modular, portable, extensible, distributed and scalable communication solution.

Referring now to FIG. 1, the system 100 allows monitoring and control of a vehicle fleet by displaying and controlling data according to a user's customized specifications. The system 100 is designed with modular applications that interact with core data and services so that vehicle parameters can be monitored, analyzed and displayed in a format that is meaningful to a particular user and/or a particular industry. This flexibility allows different users and/or industries to use the same overall system 100 for vehicle and component monitoring despite their disparate vehicle data requirements.

Referring to FIG. 1, the system 100 may include an application service provider (ASP) infrastructure 102 that acts as a gateway between a plurality of vehicles 104, each vehicle having an associated on-vehicle computer (e.g., an on-board unit or “OBU” 105) and customizable interface 106. The interface 106 allows a user or machine 106a to select among various applications, such as third-party applications 108 as well as original, system-supplied applications 110, to obtain and analyze various data from the vehicles 104. The applications may include, for example, tools for obtaining real-time fleet characteristics, trend analysis and diagnostics, to perform manual, dynamic or rule-based configuration, as well as allow fleet managers to provide real-time driver/fleet notification. To ensure that the user receives data that is meaningful to the user's specific application, the user interface 106 can be employed to select and operate one or more of the applications. In the example shown in FIG. 1, different types of users 106a may select different application groups 112 to accommodate their specific data monitoring and reporting needs applicable to their own business.

For example, as illustrated in FIG. 1, a dealer/repair facility may select from the offered applications 108, 110, vehicle configuration, scheduled maintenance, remote diagnostics, and concierge services as its application group 112, while a truck manufacturer may select a different collection of applications 112, such as warranty service/campaign support, vehicle history, and guided diagnostics. By offering a variety of modular applications 108, 110 that can be selected and combined according to the needs of a particular user, the same infrastructure 102 can be employed by different users for different purposes with little or no modification of the infrastructure 102. Further, by allowing users to access third-party applications 108 through the same infrastructure as system-supplied applications 110, the system 100 can leverage services not provided by the system 100, further increasing flexibility and adaptability.

Further, by using an ASP-based model, an application service provider may provide and allow access, on a subscriber basis, to a remote vehicle diagnostics, monitoring, configuration and reprogramming tool via the Internet. That is, the application service provider provides the hardware (e.g., servers, an on-vehicle computer) and software (e.g., database) infrastructure, application software, customer support, and billing mechanism to allow its customers (e.g., fleet managers, vehicle distributors, vehicle dealers, original equipment manufacturers (“OEMs”), leasing/rental companies, and the like) to remotely access the vehicles within a fleet. The tool can be used by subscribers to select and access the modular applications 108, 110.

An ASP-based model can eliminate the need to physically distribute software to users. In such a model, new features and updates can be immediately available to users because the system resides and runs on an application server. In one embodiment, applications that are not on the application server can reside on the OBU 105. The on-board unit applications can be loaded onto the OBU 105 during vehicle installation, and additional applications or application updates can be downloaded onto the OBU 105 through a wireless network connection.

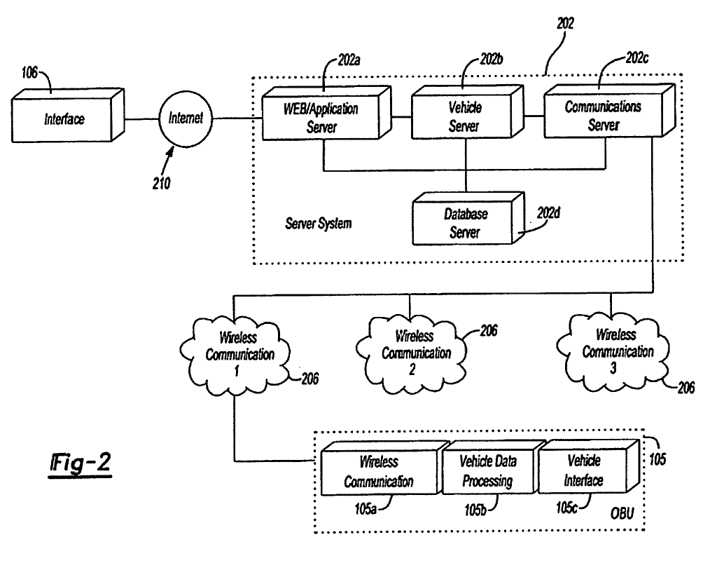

FIG. 2 is a block diagram of system architecture 200 according to an exemplary embodiment. The system architecture 200 shown in FIG. 2 is one possible way for carrying out the functionalities described above and shown in FIG. 1. In this example, the system architecture 200 includes three primary components: the interface 106, a system server 202, and the on-board unit (OBU) 105. All three components 106, 202, 105 are designed to communicate with each other through any known means, such as via wireless networks 206(1-3).

The interface 106 can be, for example, a user interface and/or a machine interface that allows a human or machine to access the infrastructure 102, which includes the system server 202. The system server 202 may include, for example, a series of servers that perform web page hosting, run applications, perform data storage, and/or perform wireless communications network management. In this example, the system server 202 includes a web/application server 202a, a vehicle server 202b, and a communications server 202c, all of which are linked to a database server 202d. As shown in FIG. 2, the system server 202 acts as a link between a web-based client (user) 106 with the OBU 105, allowing user access and control to a vehicle data stream via the Internet 210 or other internetworking system.

The OBU 105 accesses data from various vehicle components and may also generate vehicle data of its own to provide to the system server 202. The OBU 105 may include a wireless communication module 105a to provide a communication link to a wireless network, a vehicle data processing module 105b to process data obtained from the vehicle components, and a vehicle interface 105c connected to, for example, the vehicle data bus to gather data from the vehicle components for processing and managing time-critical or process-critical functions with the vehicle systems, such as electronic control units. The OBU 105 may also include a global positioning system and a driver display interface.

Each of the system architecture components will be described in greater detail below.

(a) Interface

The interface 106 may be a standard browser interface and/or a machine-to-machine interface. In the browser interface, a human user accesses the system via a standard web browser. In one embodiment, the user gains access to the specific set of their authorized vehicles and functions after login-and-password authorization. In a machine-to-machine interface, server and vehicle data and functions may be accessible via a secure application program interface (API). A machine-to-machine interface allows other applications access to the system's 100 capabilities so that the applications can gain remote access to the vehicle and the capabilities offered by the system. This allows the system 100 to interface with existing or planned back office applications and operations, making the system 100 suitable for integration with, for example, overall fleet operations or other systems.

(b) Server System

The server system 202 is the fixed-based component of the system 100, and as explained above, can be an Internet-based system and use an ASP model. The end user can access the system 100 from the interface 106, such as any commercially available web browser. As noted above, the server system 202 in this embodiment includes the web application server 202a, the vehicle server 202b, the communications server 202c, and the database server 202d. Each of these will be described in greater detail below.

i. Web/Application Server

The web/application server 202a contains logic defining one or more applications to an end user. All the data needed for a specific user application is sent to and received from the OBU 105 via one of the wireless communication networks 206(1-3). The applications perform the necessary calculations and then package the results for presentation in a defined format to the user. Further, the web application server 202a is responsible for running business applications related to user activities, which may include performing business logic, interfacing to the systems databases for fleet, vehicle, component, and transaction activity, knowledge-base storage, and sending user-requested vehicle queries or functions to the vehicle server 202b and the communications server 202c.

ii. Vehicle Server

The vehicle server 202b stores and processes vehicle-specific data and acts as a translator between the applications 108, 110 and the specific vehicle and/or vehicle component. More particularly, the vehicle server 202b is responsible for processing data requests and vehicle responses, and converting the outbound and inbound data into translated vehicle information.

The vehicle server 202b translates user requests from the interface 106 into formats specific to the vehicle 104 to which the request is directed. The vehicle server 202b conducts this translation without any user interaction or property selections. For example, the vehicle server 202b may evaluate a message being sent to a particular vehicle and detect the vehicle type, the vehicle bus type, and the vehicle component or sub-component that is intended as the message recipient. The vehicle server 202b then packages the message according to the specific communication protocol mandated by the recipient component. As a result, the vehicle server 202b allows monitoring and control of different vehicles having different components through the same interface 106 for a given user and application.

iii. Communication Server

As shown in FIG. 2, one embodiment of the system 100 allows communication between at least the OBU'S 105 and the server 202 via a wireless network, such as a satellite or terrestrial-based network. A communication server 202c may be included in the server 202 to support wireless communications, and provide a central location for supporting changes and improvements in wireless technology. In one embodiment, the communication server 202c manages the communications activities between the OBU 105 and the vehicle server 202b and processes vehicle/component specific-requests between the OBU 105 and the vehicle server 202b.

In one embodiment, the communications server 202c utilizes the WCF, which provides a communication link between the system server 202 and the vehicle 104. Although any wireless mobile communication system can be used in the system 100, the flexible wireless communication infrastructure of the WCF is capable of handling reliable delivery of messages using multiple platforms and/or multiple communication providers is favored as described in more detail below.

To handle multiple communication providers and/or platforms, the flexible wireless communication infrastructure of the WCF may abstract the needs of a specific wireless communication provider, such as the message size, message format, and specific protocol details, into a standard messaging application program interface (API) understandable by multiple systems and platforms. In one embodiment, the communication server 202c abstracts messages, and stores and forwards messages to ensure later delivery of messages to vehicles that are temporarily outside a wireless communication coverage area, and may even include least cost routing and message escalation rules to select among multiple wireless networks to prioritize message routing based on, for example, cost of delivery, and/or criticality of the message.

iv. Database Server

The system server 202 also includes a database server 202d containing relational data tables designed to retain information pertaining to a user, a vehicle, a fleet, system transaction history and other relationships associated with a given vehicle 104. The database server 202d also may be designed to retain the data resulting from any vehicular transaction, such as transactions between the OBU 105 and the system server 202. In one embodiment, the database is structured such that authorized users can access vehicles in a number of ways, for example, by fleet ownership, leasing fleet, vehicle manufacturer, and component manufacturer. This structure enables the system 100 to provide each of these beneficiaries with specific, customized data and access in a format meaningful to each user.

(c) Communication Networks

As noted above, the server system 202 and OBU 105 can communicate via one or more communication networks. Each of the communication networks may be a partial or full deployment of most any communication or computer network, and thus, can include a few or many network elements, most of which are not shown. Each communication network may include circuit-switched as well as packet-data elements to provide transport of at least data communications between server system 202 and OBU 105. It can be public or private, terrestrial wireless or satellite, and/or wireline, such as the wireless communication networks 206 (exemplified by wireless communication networks 206(1-3)).

Public wired and/or wireless networks typically provide telecommunications and other networking services in a particular geographic coverage area to its subscribers. And generally, any interested member of the public meeting minimal criteria may become a subscriber of public network. In the case of wireless or satellite networks, public networks typically provide coverage to other wireless networks' subscribers who are roaming within the coverage area of network as well.

Additionally, the coverage area of public network is typically wide-ranging. For example, the coverage area of a wireless public network may encompass a metropolitan area, a substantial part of a metropolitan area, numerous metropolitan areas, or an entire nation or region. When integrated with public wired and satellite networks, the combined networks provide national along with international coverage. Thus, each of the wireless communication systems 206 may include portions of a Public Switch Telephone Network (PSTN), the Internet, core and proprietary public networks, and/or wireless voice and packet-data networks (e.g., 1 G, 2 G, 2.5 G and 3 G telecommunication networks).

Each communication network may be a private or “enterprise” wired or wireless network as well. Unlike public networks, private networks advantageously provide the enterprise with greater control over the network, which in turn allows vast customization of the services (e.g., localized abbreviated dialing) provided to the network's users and/or subscribers.

These networks are “private” in that the networks' coverage areas are more geographically limited. Typically, but not necessarily, subscription to such private networks is limited to a select group of subscribers. Networks deployed by many enterprises that only allow their employees, customers, vendors, and suppliers to subscribe exemplify these private networks.

Many enterprises, Small Office/Home Office (SOHO) entities, and private individuals have private-wireline-switching systems. These private-wireline-switching systems may include, for example, private branch exchanges (PBXs) and/or media gateways. The private-wireline-switching systems switch, couple or otherwise connect communications (i) internally, i.e., among the subscribers of the network and (ii) externally, i.e., between the subscribers of the private network and subscribers of public networks.

In addition to the wireline networks, enterprises, SOHOs and private individuals are increasingly deploying private wireless communication systems, such as wireless office telephone systems (“WOTS”) and/or wireless local area networks (WLANs), e.g., Bluetooth and/or IEEE 802.11 WLANs, in lieu of or in addition to wireline switching systems. Similar to public networks, private networks may be integral to or integrated with other private and public satellite, terrestrial wireless, and wireline networks to provide national and international coverage.

Accordingly, each of the wireless communication networks 206 can be any of a private and/or public terrestrial, satellite and/or other wireless network. And each of the wireless communication networks 206 can be incorporated into a wide-area network (WAN), thereby creating a Wireless WAN (WWAN); a local area network (LAN), thereby creating Wireless LAN (WLAN); and/or other wired network. Alternatively, each of wireless communication networks can be a standalone WLAN.

At times, a single wireless service or technology may not provide a desirable messaging cost structure or geographical coverage to support all the features and users of the system 100 (FIG. 1). Multiple services might be used to provide for dynamic balancing between messaging costs and message timeliness. In addition, different wireless services and technologies may have different application program interfaces (APIs) and/or require custom interfaces for given computing environments. Moreover, messaging capabilities may differ across different services and technologies. As described below, the WCF provides the ability to connect to one or more of these communication networks regardless of the network differences, and to take advantage of the differing reliability and cost structures offered by the multiple networks.

(d) On Board Unit (OBU)

As noted above, the OBU 105 may provide the vehicle-side, real-time computing base for the system. In one embodiment, the OBU 105 is responsible for data-stream processing, discrete measurements, vehicle position information, wireless communications, and real-time analysis of data. Within the system's overall framework, the OBU 105 acts as a vehicle server, providing vehicle specific data and functionality. In one embodiment, the OBU 105 may be an expandable custom hardware platform designed and manufactured to reside on a wide variety of vehicles with different component specifications and needs and is capable of running multiple applications while acting as a vehicle data gateway for others.

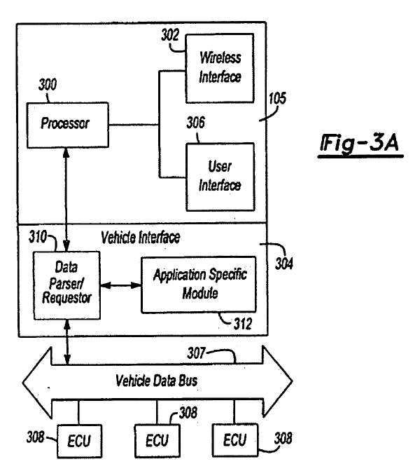

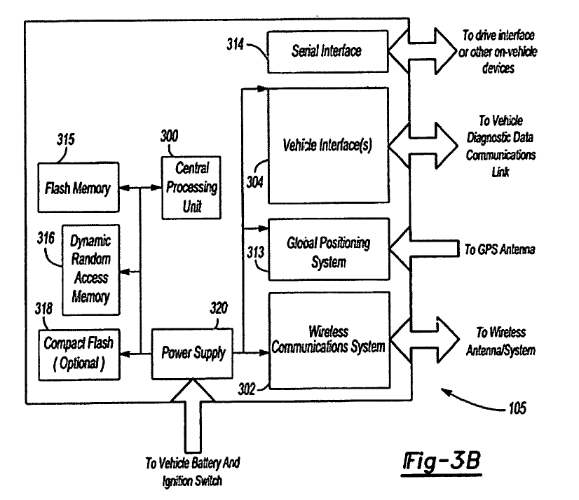

FIGS. 3A and 3B are high-level block diagrams of the OBU 105. One embodiment of the OBU 105 may include a data processor 300 and one or more interfaces 302, 304, and 306. Included among the interfaces is a wireless interface 302 that may control communication between the OBU 105 and the system server 202 via one of the wireless networks 206(1-3), a vehicle interface 304 that allows the OBU 105 to transmit data to and receive data from, for example, electronic control units (ECUs), vehicle controllers, and/or other vehicle components 308, and an optional user interface 306 that allows a user to read information from and to enter information into the OBU 105.

The wireless interface 302 in one embodiment sends data to and receives data from the system server 202, and abstracts communication operating parameters from different wireless network devices to allow the OBU 105 to communicate with a flexible wireless communication infrastructure, such as the type described above with respect to the system server 202. More particularly, the wireless interface 302 may encapsulate protocol differences among various wireless network devices to provide a standard output to the processor 300. In one embodiment, wireless network messages are routed from the system server 202 to the wireless interface 302 for error checking and filtering. After filtering, commands are passed to the processor 300 and then routed to their respective vehicle components.

The processor 300 acts as the central processing unit (CPU) of the OBU 105 by managing the sending and receiving of requests between the system server 202 and the vehicle 104 via the wireless interface 302. In one embodiment, the processor 300 has the logic and intelligence to carry out vehicle specific services such as diagnostic requests and processing. For example, the processor 300 may run specific applications that are loaded into memories 315, 316, 318 (FIG. 3B) of the OBU 105 and that coordinates activities between the vehicle data-stream, GPS unit 313 (FIG. 3B), wireless communications 302, and the system server 202. Further, in one embodiment, the processor 300 can be updated through the one of the wireless networks 206(1-3) to add to and enhance its functionality. This capability eliminates the requirement that the vehicle be at the service bay for software updates that enhance features and functionality.

The vehicle interface 304 allows the OBU 105 to support a wide variety of vehicle components and subcomponents. Possible interfaces that can be supported by the OBU include SAE J1708, SAE J1939, SAE OBDII/CAN, ISO-9141, discrete I/O, proprietary interfaces, and other interfaces (e.g., discrete or instrumentation interfaces). Further, the vehicle interface 304 provides a single point of contact for all vehicle components and control devices on the vehicle 104, allowing the communication between OBU 105 software, and the vehicle's actual data bus line as well as wireless communication devices, such as a satellite-based communications system.

In one embodiment, the vehicle interface 304 may include a data parser/requester module 310 that contains logic, e.g., software code, that is also responsible for handling direct interfacing between the processor 300 and the vehicle data bus 307 for non-application specific (i.e., “generic” SAE J1708 or SAE1939 discrete measurement points) parameter readings, alerts, configuration or reprogramming data, as explained in greater detail below.

The vehicle interface 304 may also include, for example, one or more application specific modules 312, such as one for each manufacturer specific controller 308 within the vehicle 104, each containing logic that is responsible for handling interfacing between the processor 300 and the vehicle data bus 307 (via data parser/requestor module 310 in this example) for application/specific parameter readings, alerts, configuration or reprogramming data.

Note that the OBU 105 may act as a server and/or data gateway for an application that places data directly on the vehicle data bus 307. In one embodiment, the OBU 105 uses an interface standard, such as TMC RP 1210A, as an element of the data gateway. Regardless of the specific standard used, any activity using the OBU 105 as a data gateway may involve data going through the processor 300.

In an embodiment, the OBU 105 is designed to be compliant with the SAE's Joint SAE/TMC Recommended Environmental Practices for Electronic Equipment Design (Heavy-Duty Trucks), Document No. J1455 (August 1994) standard, which is incorporated herein by reference in its entirety, because it will be a component included (or installed) within vehicles 104. As indicated above, the OBU 105 is not limited to be compliant with any particular standard and can accommodate any on-board electronic system standard (e.g., SAE J1708, SAE J1939, SAE J1850, ISO 9141, proprietary data streams, etc.) for any sub-system (e.g., engines, transmissions, braking systems, instrument clusters, etc.) as long as the system 100 is capable of converting commands between the interface 106 and the OBU 105 according to whichever standard is used by a given vehicle electronic system. If the vehicle electronic system uses a proprietary standard, for example, the vehicle server 202b and the associated application specific module 312 on the OBU 105 may be adapted to accommodate the proprietary standard.

FIG. 3B illustrates another embodiment of the OBU 105 and explicitly shows the capability to interface with other devices via, for example, a parallel interface, serial interface, a universal serial bus (USB) interface, a satellite interface, a terrestrial wireless interface (e.g., 802.11b), and/or a global positioning system (GPS) interface. More particularly, the embodiment of the OBU 105 shown in FIG. 3B includes a GPS circuit 313 that receives signals from a GPS antenna and a serial interface 314 that communicates with a driver interface or other on-vehicle devices (not shown), such as a handheld device, a cellular telephone, voice messaging system, data logger, or other devices. Serial interface 314 may comply with the well known RS232/EIA232 standard for serial communications. FIG. 3B also explicitly illustrates a flash memory 315, a dynamic random access memory 316, and an optional compact flash memory 318 coupled to the processor 300 and to a power supply 320 coupled to the vehicle battery and ignition switch (not shown). Those of skill in the art will understand that the elements and concepts shown in FIGS. 3A and 3B can be combined in any manner.

The application software and the application framework are built with both a software and hardware abstraction layer. This approach makes the framework adaptable to a number of alternative operating system and hardware platforms. One embodiment of the OBU 105 may use any known real-time operating system.

(e) Wireless Communication Framework

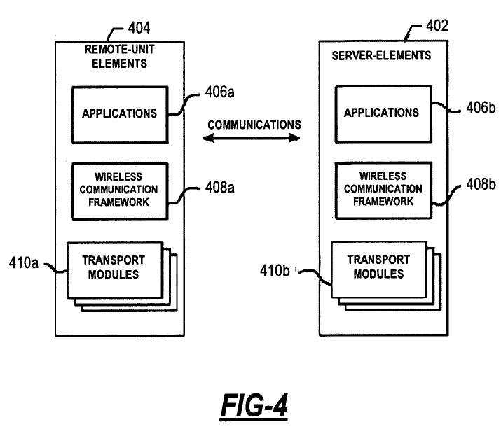

FIG. 4 illustrates exemplary architecture 400 of the wireless communication framework (WCF) in accordance with an exemplary embodiment. The WCF may encompass a number of software and/or hardware program and/or application elements for carrying our wireless communications between two wireless nodes.

The WCF architecture may be concentrated on either the server system 202 or a remote unit that is operable to communicate with the server system 202, such as the OBU 105. In such case, the device having server portions of the WCF architecture may act as a server in a client/server relationship and the device having the client portions may act as the client. Because the server and client responsibilities may change depending on the function to be carried out, the server system 202 can be a server for one function, yet a client for another. Similarly, the remote unit may be a client for one function, and a server for another.

Alternatively, the WCF may be distributed among one or more server-system elements 402 and one or more remote-unit elements 404. In a distributed embodiment, the remote-unit elements 404 may be included within a remote unit, such as the OBU 105, and the server-system elements 402 may be deployed in the server system 202.

In addition to the OBU 105, it is understood that the remote unit may a Personal Digital Assistant (PDA) and/or another computer that can be communicatively coupled with server-side elements 402. As such, the remote unit may contain server-system elements 402 in addition to or in lieu of the remote-unit elements 404, thereby enabling communications between itself, the server-system 202 and/or another remote unit, such as another OBU (not shown).

The remote-unit elements 404 may include (i) remote-unit application programs 406a (e.g., full or partial application programs that reside on the remote unit) such as those as described above, (ii) remote-unit transport modules 410a, and (iii) one or more intermediary remote-unit WCF modules 408a.

Similarly, the server-system elements 402 may include (i) server-system application programs 406b, which may or may not be counterparts to the remote-unit application programs 406a; (ii) server-system transport modules 410b, and (iii) one or more server-system WCF modules 408b, which may or may not be the same as the remote-unit WCF modules 408a.

With reference to FIG. 4, the transport modules 410a, 410b, alone or as a complementary pair, may be deployed as one or more different software programs, software modules, and/or hardware modules for connecting and interacting with various communication networks, such as the wireless communication networks 206(1-3). The transport modules 410a, 410b provide one or more interfaces through which the application programs 406a, 406b couple to the WCF modules 408a, 408b.

In doing so, each of the transport modules 410a, 410b may be configured to (i) execute protocols to access its corresponding communication network, (ii) initialize, maintain, and shut down server-system and/or remote unit communication adapters (e.g., modems), respectively, (iii) test the server-system and/or remote unit communication adapters, and/or (iv) perform any other functions and/or procedures to carry out communications with the corresponding communication network for which the particular transport module 410a or 410b is associated.

Each of transport modules 410a, 410b may be tailored (e.g., abstracted or otherwise configured) for access to a specific implementation and/or format of a communication network. If, for example, each of the wireless communication networks 206(1-3) are different from each other, then a first of the transport modules 410a, 410b may be configured to access wireless communication network 206(1), a second may be configured to access wireless communication network 206(2), a third may be configured to access wireless communication network 206(3), and so on. Other transport modules 410a, 410b can be included to access additional network services, such as those provided by WLANs or WWANs.

The number of transport modules 410a, 410b deployed in the remote-unit and/or server-system elements 402, 404 may be a function of the number, configuration and/or format of the communication networks 206(1-3) that the server-system 202 and/or the remote unit may have access to. For instance, the remote unit might not need to have access to the Internet. And thus, having a transport module 410a for Internet access may be omitted. On the other hand, the server-system elements 402 may have access to a host of networks that the remote unit elements 404 do not. Accordingly, the server-system elements 402 may have transport modules 410b configured to carry out communication with these networks.

If, for example, remote-unit elements 402 are deployed in a number of remote units in a fleet of vehicles that travel in a specific geographical region where access is available to wireless communication networks 206(1), 206(2), but not wireless communication network 206(3), then the remote-unit transport modules 410a may be configured to access the wireless communication networks 206(1), 206(2).

The server-system elements 404, which may or may not be co-located in the same specific geographical region as the remote units, may have access to the wireless communication network 206(3) (e.g., a WLAN) in addition to the other communication networks. Thus, the server-system transport modules 410b may be configured to access wireless communication network 206(3) as well.

Thus, the server-system elements 404 may have access to a host of networks to communicate with each of the remote unit elements 402, even though not all of the remote unit elements 402 have the corresponding access. For instance, one of the remote unit elements 402 may have access to only network 206(1), while another of the remote unit elements 402 may have access to only network 206(2), but the server system elements 404 may have the transport modules 410a, 410b to support both networks 206(1-2).

Moreover, the number of transport modules 410a, 410b may be a function of the monetary and overhead costs of subscribing to multiple communication networks. For instance, the number of transport modules 410a, 410b may be limited when monetary cost savings (e.g., discounted delivery rates) in using more networks cannot be justified. Other non-monetary costs, such as memory usage and processing losses, may also limit the number of transport modules 410a, 410b.

Conversely, the number of transport modules 410a, 410b may be greater when non-monetary and monetary cost savings can be obtained by the use multiple networks. These cost savings may be embodied as discounted rates, which can be apportioned by time, volume of calls; time of day, month, etc; geographical region; and other metrics.

2 Wireless Communication Framework Modules

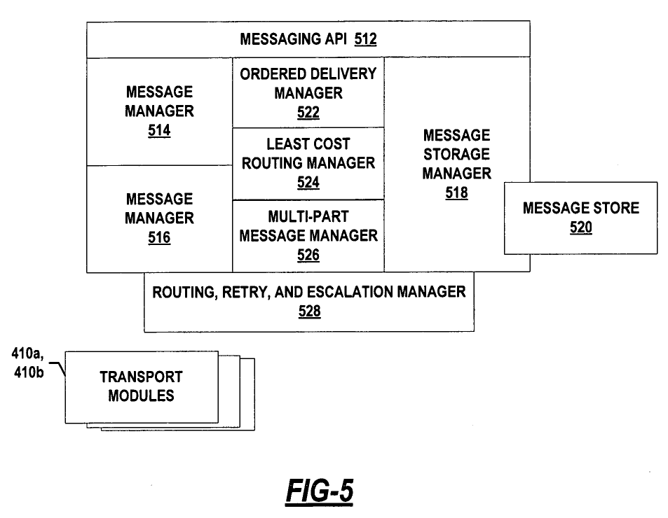

FIG. 5 illustrates the WCF modules 408a, 408b in greater detail. The WCF modules 408a, 408b may be deployed with a messaging Application Program Interface (messaging API) 512, a message manager 514, a transport manager 516, message-storage manager 518, a message store 520, ordered delivery manager 522, a least-cost routing manager 524, a multi-part message manager 526, and a routing, retry and escalation manager (RREM) 528.

Regardless of whether the WCF is distributed among or concentrated on a remote unit and/or server system 202, some or all of the functions of WCF modules 408a, 408b may be deployed in both the remote-unit and server-system elements 402, 404. In the case of a concentrated system, however, function calls may be used to establish communication between the concentrated elements.

In some instances, the remote-unit WCF module 408a might not perform the same functions that are carried out by the server-system module 408b, but rather it may perform functions that complement and/or accompany functions carried out by the server-system elements 408b. Similarly, the server-system WCF module 408b might not perform the functions that are carried out by the remote-unit module 408a, but rather functions that complement and/or accompany functions carried out by the remote-unit elements 408a. Further, some of the functions of the WCF modules 408a, 408b may be applicable to only a remote unit or server system 202. Thus, some of the functions carried out by WCF modules 408a, 408b may only exist in either the remote unit or server-system elements 402, 404. Further detail of the wireless communication framework modules 408a, 408b is provided below.

(a) Messaging API

The messaging API 512 may provide the functionality to receive, send, and process messages sent to or coming from multiple application programs. This functionality can be carried out by the messaging API 512 even if the application programs 406a, 406b use program and data structures different from rest of the WCF architecture.

As such, the messaging API 512 may allow many different application programs to use a common and/or “standardized” messaging format provided by the WCF modules 408a, 408b. This beneficially allows the development of application programs without the need for custom or tailored programming. For instance, the WCF architecture and the messaging API 512 may provide the messaging system, bridge (gateway, and/or conduit), storage, and programming that allow an application program to be developed and implemented independent of the communication network used by the WCF architecture.

In facilitating such application development independence, the messaging API 512 may abstract the differences between transport providers (e.g., the providers of wireless communication networks 206(1-3)) and the differing technologies of the wireless communication networks to allow applications to be written independently of the services and transport providers selected. Accordingly, when a new application program is to be added, the messaging API 512 may provide hooks or other access interfaces to the application programs to achieve communication without substantial custom programming.

(b) Message Manager

The message manger 514 may manage the delivery and acceptance of messages to and from the application programs 406a, 406b. The message manager 514 may also manage a reliable delivery function that insures messages are not dropped or lost. The reliable-message delivery performed by the message manager 514 may be accomplished using message-delivery verification, which will be discussed in greater detail below.

(c) Transport Manager

The transport manager 516 manages the selection of transport modules 410a, 410b available to the remote unit and/or server system elements 402, 404. The transport manager 516 may work in conjunction with other components of the WCF modules 408a, 408b, such as the least-cost routing manager 524 (discussed below) for determining which of the transport modules 410a, 410b to select.

(d) Ordered Delivery Manager

The ordered delivery manager 518 manages an ordered delivery of messages sent by any of the application programs 406a, 406b. Ordered delivery may be any predefined order in which messages are to be sent, and can be configured as an ordered delivery service. This provides a significant advantage when performing database edits or other information that is order dependent.

When ordered delivery is desired or requested by any of the application programs 406a, 406b, the order delivery manager 518 may arrange the messages in any of the plurality of predefined orderings irrespective of when the WCF modules 408a, 408b receive the messages from the application programs 406a, 406b. Under the WCF messaging system, messages can be configured to specify a given delivery queue using, for example, a queue identifier or other notation. Under-this scheme, messages with a given queue identifier may be sent to a particular queue, as indicated by the queue identifier. Before transmission, the messages may be arranged in the particular ordering selected.

(e) Least-Cost-Routing Manager

The least-cost-routing manager 524 may be responsible for selecting one or more of the transport modules 410a, 410b based on a plurality of factors, such as the cost and timeliness of message delivery. This WCF module may be expanded using custom routing factors as desired.

In addition to cooperating with other WCF modules 408a, 408b, the least-cost-routing manager 524 may operate in combination with the transport manager 516 to determine which of the transport modules 410a, 410b to select. The least-cost routing manger 524 may, for example, link or relay information to the transport manager 516 after determining the low cost provider so that the messages may be transmitted via the low cost service provider.

(f) Multi-Part Message Manager

The multi-part message manager 526 may manage disassembly (and reassembly of previous disassembly) of large messages for transport among the server system 202 and any of the remote units. This is particularly advantageous when the message to be sent exceeds the maximum allowable message size for the selected one of the networks 203(1-3). The multi-part message manager 526 may be invoked to ensure that the message adheres to the set maximum message size by disassembling the message into groups of smaller chunks.

The chunk size may be, for example, 16 or 32 byte chunks. Chunk size selection may also depend upon the maximum allowable size message that can be sent over the selected one of the wireless communication networks 206(1-3) without degradation or loss of the contents of the message. The chunk size may be based upon satisfactory transmission accuracy returned from error-control algorithms, for instance. The multi-part manager 526 may be equipped with intelligence, e.g., dynamic and/or statistical algorithms, for selecting a proper chunk size for maximizing throughput, bandwidth and/or other transmission parameter.

The following describes, by way of a simple, non-limiting example, of how the multi-part manager handles such overage. Assume for this example that the wireless communication networks 206(1) may have a maximum allowable message size of about 100 bytes per message, and the network 206(2) may have an allowable message size of about 512 bytes per message. In either case, however, a certain number of bytes per chunk, e.g., 2 bytes, may be allocated to overhead, reducing the number of available bytes for transmission of content over wireless communication networks 206(1-3).

Assume for this example that a message having content equaling about 100 bytes is destined for transmission across the wireless communication networks 206(1). Since the content of the message exceeds the 100 byte maximum allowable message size, the multi-part message manager 526 can disassemble the message into the smaller 16 and/or 32 byte chunks.

If, for example, the 16 byte chunk is selected, the chunk size dictates that the message will be first broken down into five 16-byte chunks, totaling 80 bytes (16×5=80)+10 bytes overhead. At this chunk size, another 16 byte chunk cannot be sent because the sixth 16-byte chunk causes the accumulated byte size to equal 106 bytes (plus 2 bytes overhead), thereby exceeding the maximum allowable message size of 100 bytes by 8 bytes. The multi-part message manager 526 can reassemble the five chunks into a first-part message, leaving the 10 remaining bytes (100−90) for a second-part message, which may be have other content added to optimize available bandwidth. In such case, the first-part message will only have 10 unused bytes.

If, on the other hand, the larger 32 byte chunk size was selected, then the chuck size dictates that the first-part message will be broken down into only two chunks (2×32=64)+4 bytes overhead. A third chunk will cause the accumulated byte size to exceed the maximum allowable message size of 100 bytes by 2 bytes ((3×32)+(3×2)=102). Consequently, the first-part message would have 32 bytes of unused space, which is 22 bytes more than when using the 16 byte chunk size. Accordingly, the smaller chunk size allows more of the available message size to be utilized.

The added number of smaller chunks, however, may cause more chunks to be sent. This may increase the amount of overhead, which may accumulate as a function of the number of chunks. With smaller message sizes, not many chunks need to be sent. In some circumstances, an optimization penalty resulting from overhead incurred when sending a smaller message with smaller chunks might not outweigh the reduction of unused bytes accomplished with the smaller chunk size.

When using the second wireless communication networks 206(2), for example, the multi-part message manager 526 may more optimally disassemble the message using the larger 32 byte chunks. As noted, the increased number of chunks required to be sent to accommodate the 512 byte size message increases the amount of corresponding overhead needed to send the message. Such an increase may fail to outweigh the reduction of unused bytes that accompanies the use of smaller chunks. As is apparent, larger chunk size may be beneficial for larger message sizes, the smaller chunk size may be more beneficial for smaller available message sizes. As such, a programmer or user of the WCF can flexibly pick a predetermined maximum byte size limit of a network at which the multi-part message manager 526 will disassemble a message into smaller or larger chunk sizes. The user, for example, could select a prescribed threshold of 200 bytes, which may allow a message to be disassembled into smaller chunks only when the maximum allowable limits falls below this threshold. Messages otherwise may be disassembled into larger chunks when the maximum allowable limits rises above this level.

The multi-part message manager 526 can also break messages into chunks for other reasons than to accommodate large messages. For instance, the chunk size may be set to a size slightly smaller than the maximum allowable byte size of the wireless communication networks 206(1-3) regardless of actual message size. With this alternative and with smaller chunk sizes in general, the probability that a message will get through a network without unacceptable retry attempts increases.

Additionally, the multi-part message manager 526 might not need to re-send already-acknowledged message chunks even if a partially complete message is re-routed through another network (e.g., from network 206(1) to network 206(2)). Accordingly the chunk size may be changed to another size based on which networks are available. If, for example, the message is rerouted from a network 206(2) to network 206(1), the chunk size may change from 32 bytes to 16 bytes. However, the chunk size in one network may be compatible with another, and thus, need not to be changed. Other variations on the size of the chunk in relation to the network may be utilized as well.

(g) Routing, Retry and Escalation Manager

The Routing, Retry, and Escalation Manager (RREM) 528 has the responsibility for choosing the wireless communication networks 206(1-3) over which one or more messages may be sent. The RREM 528 is a customizable component that can be tailored to the system 100 and/or application programs 406a, 406b for which the WCF is being used. The RREM 528 may implement a routing algorithm that may be a lot more sophisticated than a least cost routing algorithm, which sends the message on the cheapest available network.

The RREM 528 can also make decisions based on a message priority assigned by the application programs 406a, 406b, and on the size or other properties of the message. The RREM 528 may send a high priority (e.g. emergency) message simultaneously on all of the available wireless communication networks 206(1-3) to have the best possible chance of getting the message through quickly.

The RREM 528 may also manage the messaging behavior over a particular one of the wireless communication networks 206(1-3) according to both the particular rules of the particular network and the needs of the application programs 406a, 406b. For example, a satellite network provider might want to avoid network saturation if a user action causes a message to be sent to many vehicles. In such case, the RREM 528 may determine that a message has low priority, and responsively space out the time at which such messages can be sent to avoid saturation.

To facilitate the disposition of messages, the RREM 528 may carry out the following. The RREM 528 may queue each message for delivery over one or more of the wireless communication networks 206(1-3). The messages may be queued for transport over multiple transports simultaneously. For example, messages may be queued for both wireless communication network 206(1), which may be embodied as a WLAN, and wireless communication network 206(2), which may be embodied as a Public CDMA wireless network. Given that a message queued for transmission over the wireless communication network 206(2) may not even be sent immediately (e.g., due to message window and network throttle considerations as described in more detail below), the message could be simultaneously queued for transport over the wireless communication network 206(1). If the message is successfully sent over wireless communication network 206(1), it can be removed from the queue for the wireless communication network 206(2). The RREM 528 may establish a transport-specific priority level with which messages are queued.

The RREM 528 may escalate messages from one of the wireless communication network 206(1-3) to another. Such escalation may be based on network-specific timeouts and application-program 406a, 406b specific rules. The RREM 528 may determine timeout values for each message, and may fail a message if certain conditions are met. A message might be deemed failed if it could not be sent within a certain time period or number of retries. With Ordered Delivery, messages might not be failed, but rather replaced as described above to avoid creating holes in the ordered delivery sequence numbering. An alternative to failing a message might be to log a system alert that a message could not be delivered.

The RREM 528 may implement application-specific rules. This allows the system designer (using the WCF) to establish their own rules for routing, retry, and escalation based on the needs of the system 100. The RREM 528 might require some knowledge of the specific transports in use by the system.

The RREM 528 might not interface directly with the Message Storage Manager 518. Instead, it may receive notifications of significant events and be expected to take action based on the event. Such events may include (i) a new outbound message that has been queued and requires disposition by the RREM 528; (ii) a message previously queued by the RREM 528 for transmission that has been successfully sent on one or more of the wireless communication networks 206(1-3); and/or (iii) a message previously handled by the RREM 528 that has reached an escalation or timeout time.

When receiving a notification of the event regarding a message previously queued by the RREM 528 for transmission that has been successfully sent on one of the wireless communication networks 206(1-3), the RREM 528 may (i) update the timeout time for the message to reflect the time the message was sent, (ii) modify or remove the message's escalation time; (iii) remove the message from other queues; and/or (iv) treat it in some other way.

When receiving a notification of the event regarding a message previously dispositioned by the RREM 528 has reached an escalation or timeout time, the RREM 528 may re-queue the message on the same or a different one of wireless communication networks 206(1-3), remove the message from other queues for the other wireless communication networks 206(1-3); and/or treat it in some other way.

(h) Message Storage Manager

The message-storage manager 518 may be responsible for keeping a queue of messages that are waiting to be sent, have been sent or are awaiting an acknowledgement. In the former case, the message-storage manager 518 may operate in conjunction with other WCF modules 408a, 408b to maintain the message in the queue until one of the transport module 410a, 410b connects to the chosen network.

In the latter case, the message-storage manager 518 may maintain a record (e.g., a table) of sent messages. This record may be used to ensure reliable delivery of the message in case of a failure of system 100, an out-of-coverage area error, and/or other error. With the record, a message is able to be resent from the message store 520 in response to such a failure.

At the receiving end, the message-storage manager 518 may also maintain a copy of the message as a handshaking mechanism. This copy may be maintained until the message is successfully delivered to the target application. If, for example, the server system 202 sends to OBU 105 a message when the vehicle 104 is outside the coverage area of any of the networks 206(1-3), then the message-storage manager 518 may store the message in the message store 520. After the vehicle 104 enters the coverage area of one or more of the networks 206(1-3) the message may then be sent.

If the multi-part message manager 526 has disassembled the message into chunks, then the chunks already sent may be stored at the message store 520 of the OBU 105, and the chunks not sent may be maintained at the server system 202. This beneficially prevents unnecessary and costly retransmission of already sent chunks in the case of, for example, system failure, out-of-coverage area errors or other connectivity failure. Such benefit may be realized because only the chunks maintained in the message store 520 of the server system 202 are sent to the OBU 105. Since the chunks that have been already sent may be maintained in the message store 520 of the OBU 105, the message can be reassembled using the earlier stored chunks and the chunks sent after reconnection.

(i) Message Services, WCF Extensibility, and WCF Portability

The WCF may also carry out certain message services such as encryption, compression and packaging. The WCF may use standard as well as custom encryption algorithms and cryptography over the entire communication route. Different types of encryption services may be used over different segments of the communication route. The encryption services may be used in addition to or in lieu of any encryption provided by the network service providers. Conversely, the WCF may use the encryption services provided by the network service providers in lieu of the services provided by the WCF.

To limit bandwidth that is required for transmission, messages can be compressed using standard and custom compression algorithms. Different types of compression services may be used over different segments of the communication route. The compression services may be used in addition to or in lieu of any compression provided by the network service providers. Alternatively, the WCF may use the compression services provided by the network service providers in lieu of the services provided by the WCF.

As noted, the WCF may carry out packaging, which allows one or more messages to be packed together to reduce the cost of transmission over transports that support large message sizes. Thus, instead of incurring the overhead and/or acknowledgement costs for each message, these costs may be incurred only once for several messages.

The WCF may be extended in various ways so as to provide extension interfaces that allow the system and/or application designer to customize and extend the WCF for the particular computing platform capabilities and behavior. Included in the extension capabilities are message store, transport modules, least-cost-routing manager, compression, and encryption extensions.

The message store 520 provides the storage for messaging functions, including message persistence in which messages are maintained message information over a system or component reset, reliable message delivery, order delivery processing, and multi-part messaging. The message store 520 may be customized according to platform capabilities and system requirements.

In addition to customizing the message store 520, new transport modules 410a, 410b may be added to support additional communication services and providers. The least-cost routing manager 524 may be customized to provide sophisticated routing and escalation logic.

As new standards and protocols are developed for message compression and encryption, the WCF may be extended to incorporate the changes. New compression and encryption modules may be used to support non-standard and proprietary protocols.

In addition to being extensible, the WCF may be ported to between platforms and systems. In one exemplary embodiment, an operating-system-thin layer isolates the WCF from operating system differences, thereby allowing portability between platforms. The message store 520 may abstract the file system, memory structures, and/or database structures in which messages are stored. The WCF may be deployed as dynamic-link libraries or shared libraries on platforms that support such libraries. Alternatively, the WCF may be deployed as static-linked libraries on platforms that support such libraries. The WCF may make use of Computer Object Model (COM) and can be integrated with COM+ on a Windows 2000 platform. As such, the WCF may use the transactional and security features of COM+.

(j) Reliable Message Delivery

As noted, the WCF modules 408a, 408b may bridge or provide a gateway between the application programs 406a, 406b and the transport modules 410a, 410b. In an exemplary embodiment, the WCF modules 408a, 408b can bridge or otherwise couple the remote-unit application programs 404a with the server-system application programs 404b, the transport modules 410a, 410b using standardized and/or proprietary messaging system.

As noted, the API 512 may manage the acceptance of messages from remote-unit application program 406a and the delivery of messages to server-system application programs 406b. The message manager 514 may also manage a process for carrying out a function for ensuring that messages are reliably delivered (i.e., reliable-message delivery). The reliable-message delivery may include the process for verifying that a sent message was properly received (hereinafter “message-delivery verification”). The response time and deployment of message-delivery verification can be based on the urgency of the message, for example.

(k) Exemplary Message Dispatch

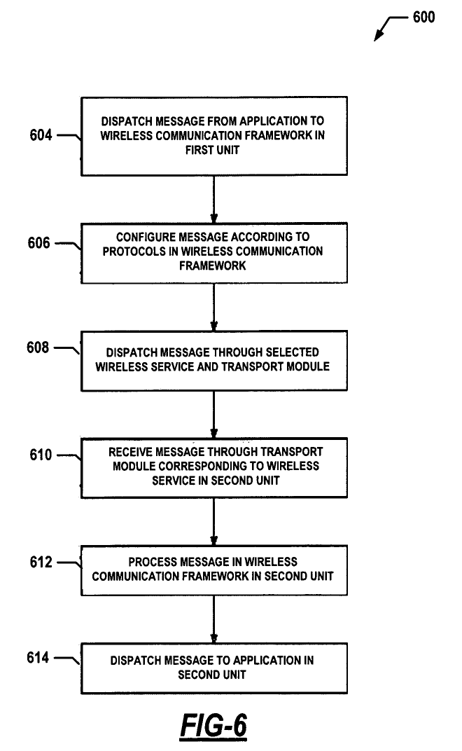

FIG. 6 illustrates a flow chart depicting a communication flow 600 between the service server 202 and the OBU 105. The following describes the flow 600 of one or more messages originating from the system server 202 and terminating at the OBU 105. The flow 600, however, may also be carried out in the reverse direction, i.e., originating from the OBU 105 and terminating at the system server 202. Moreover, other devices besides the server system 202 and the OBU 105 may carry out the following flow 600.

In block 604, one or more of the messages is dispatched to the WCF from one of the application programs 406a. This dispatch may be carried out via messaging API 512. As noted, the messaging API 512 can receive and process messages coming from one or more application programs 406a, 406b. Since the messaging API 512 can select and provide a corresponding interface for the one or more of the transport modules 410a, the applications 406a can be written to communicate with the messaging API 512, thereby allowing a programmer to focus on the vehicle application at hand and not the code for carrying out communications over the wireless communication networks 206(1-3).

In block 606, the messages are configured and formatted for dispatch. The desired transport module 410b that corresponds to the selected one of the wireless communication networks 206(1-3) may be selected. The selection may be based on many factors, such as those described hereinafter. The process of selecting one or more of the transport modules 410b (and in the reverse direction, transport modules 410a) may include reviewing and/or determining network services that are available to the OBU 105. The server system 202 may contain a library of the network services available to one or more of the remote units, such as OBU 105, to assist in the selection of the desired transport module 410b. After determining the available network services, the WCF architecture can proceed to select one or more of the available transport modules 410b for each available network 206(1-3). Other factors, such as cost or transmission speed, may be likewise included in making the determination.

In block 608, the messages are dispatched through the selected transport module 410b for the desired wireless communication networks 206(1-3). In block 610, the messages are received by the OBU 105 via one of the transport modules 410a that corresponds with the wireless service selected by the server system 202.

In block 612, the messages are processed by the WCF architecture of the OBU 105. This may include the multi-part message manager 526 reassembling messages that may have been disassembled by the server-system elements 404 of multi-part message manager 526. Also, the message storage manager 518 or message manager 514 may store the messages in the message store 520 for later processing. The WCF architecture may also perform other desired processing, as noted above, including formatting the messages for delivery to and receipt by one or more of the application programs 406b. Since many application programs 406b may be run simultaneously or concurrently in the OBU 105, the WCF architecture and functionality has the ability to format the messages to suit a number of different possible application programs 406b. Such formatting may be accomplished through the messaging API 512.

In block 614, the messages are sent to one or more of the application programs 406b via the messaging API 512. As noted in block 606 described above, the message manager 514 may be used to provide reliable-message delivery. To facilitate the reliable-message delivery, the messages may be assigned a delivery option by one or more of the application programs 406b. This delivery option may be either unreliable or reliable status. If unreliable status is applied to one or more of the messages, then the message manager 513 may cause the message to be delivered without requiring the OBU 105 to return a confirmation acknowledgement or receipt. In the simplest case, the delivered messages are sent and forgotten. If, however, one or more of the application programs 406b assigns a reliable status to one or more of the messages, then these messages may be repeatedly sent to the OBU 105 until the application programs 406b and/or server system 202 receive a return confirmation acknowledgement or receipt.

Also noted in above, ordered delivery manager 518 can provide order delivery processing of the messages or message chunks. To facilitate the order delivery, one or more of the application programs 406b may assign a particular order to a plurality of the messages. In this case, the particular assigned order is the order in which the messages are to be sent. The OBU 105 may use the order delivery processing to properly process transmitted information. The ordered delivery manager 518 may collect the messages until the ordered-delivery processing is complete, and then forward the messages to the application programs 406b. Then, the ordered delivery manager 518 dispatches the messages according to the assigned order. The WCF architecture and functionality supports multiple, independent, ordered delivery queues.

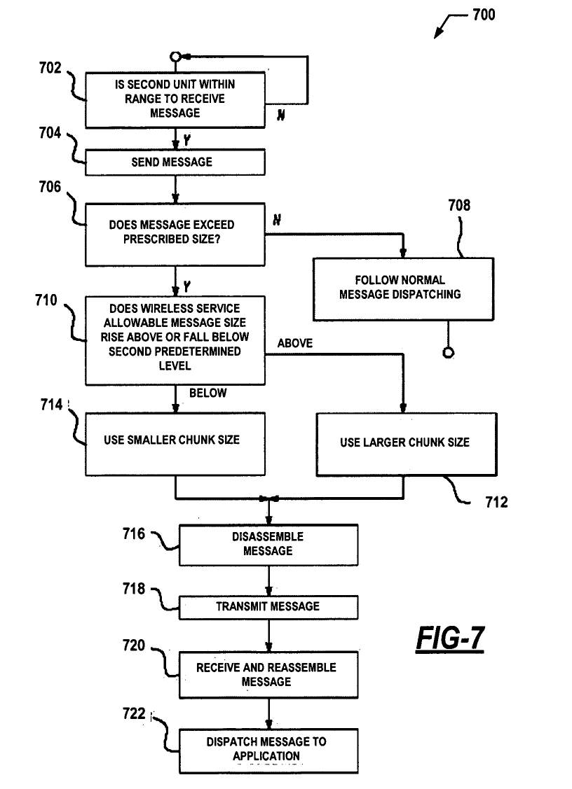

Referring now to FIG. 7, a communication flow 700 illustrating a dispatch of one or more messages via the messaging API 512 is described in greater detail. The messaging API 512 communicates with the transport module 410b of a desired network 206(1-3) via a transport-send agent of the transport manager 516 to query whether the transport module 410b is allowed to send messages as shown in block 702. This ensures that the OBU 105 is within range to receive messages before any message is dispatched. Determining whether the OBU 105 is within range of the network 206(1-3) may be facilitated using capabilities of the communication hardware and software of the OBU 105, as is known to one skilled in the art.

If, for example, the OBU 105 is within range of network 206(1) and/or network 206(2), then the messages may be sent in block 704. If the vehicle is not within range, then block 702 is repeated until the vehicle becomes within range of the corresponding network. During this wait time, messages may be stored within the message store 520 by message-storage manager 518, thereby freeing up the application program 410a to perform other tasks.

With continued reference to FIG. 7, the operation of the multi-part message manager 526 is described in greater detail. As noted, the multi-part message manager 526 may disassemble large messages that exceed the maximum allowable size of the selected network 206(1-3). In block 706, messages sent to the messaging API 512 from the application program 406b are tested to determine whether they exceed the maximum allowable size for the selected network 206(1-3). If the message size does not exceed this limit, the messages are dispatched according to the flow described in FIG. 6 as shown in block 708.

If one or more of the messages are smaller than the limit, and then multiple messages can be packaged to reduce overhead for a number of messages. This may be accomplished by placing a number of smaller messages into a packet for transmission over the selected network 206(1-3). This reduces the cost and latency for sending messages over networks that have an overhead cost or additional latency cost for each packet.

If, on the other hand, the size of one or more of the messages exceeds the maximum allowable limit, then the oversized messages may be disassembled as shown in block 710. To carry out block 710, the oversized messages may be compared to a prescribed message size to determine the more optimum method for disassembly. The prescribed message size may be used to the balance between efficiencies of sending larger chunks and disassembling the message into smaller chunks, as described previously. This prescribed message size may be an arbitrary or learned byte size specified by the system or it may be a maximum allowable limit dictated by the network on which the message is to be transmitted. Oversized messages that exceed the prescribed message size may be disassembled using the larger or smaller chunk size as shown in blocks 712, 714.

In block 716, the oversized messages are disassembled according to the determination of which chunk size to use. Disassembly may be carried out using identification coding or otherwise marking the order in which the portions of the disassembled messages should be reassembled at the OBU 105. The disassembled messages may then be transmitted to the OBU 105 as shown in block 718.

The multi-part message manager 526 keeps track of the portions of dissembled messages that have been transmitted and the portions that have not been transmitted. This allows only the un-transmitted portions of the messages can be later transmitted in case of a failure of system 100 or an out-of-range fault during message transmission. Accordingly, when the system 100 comes back on-line or the OBU 105 comes re-enters the coverage area of one of the wireless communication networks 206(1-3), then entire messages not need to be re-transmitted even if the messages are subsequently routed onto a different one of the wireless communication networks 206(1-3).

In block 720, the messages along with re-assembly information are received in the multi-part message manager 526 of the OBU 105. Like the multi-part message manager 526 in the system server 202, the multi-part message manager 526 also maintains a record of the portions of messages that have been received in case of a failure of the system 100 or an out-of-range fault. Once re-assembled, the messages are sent to the application program 410a of the OBU 105 as shown in block 722. As noted, the above-described communication are for exemplary purposes only and carried out by in the reverse direction and/or with devices other than the server-system 202 and OBU 105.

In conjunction with FIGS. 5 and 7, the following provides a description of an exemplary operation of the RREM 528. As noted above, the RREM 528 may work together with transport manager 516 to select the desired one of the wireless communication networks 206(1-3) to carry out message transport. Like the other portions of the WCF architecture, the RREM 528 may be deployed as a customizable component that can be tailored to the server-system 202, remote units, such as OBU 105, and applications 406a, 406b.

In one embodiment, selecting the desired wireless communication network 206(1-3) may be accomplished, in part, by analyzing the number of available networks 206(1-3), transmission timeliness, cost considerations in transporting messages, and other factors. Using a list of available transport modules 410a, 410b, the RREM 528 may select a network for transport depending on WCF determined message priority alone, or alternatively, in lieu of and/or in combination with priority determined by applications 410a, 410b. For instance, if the application 401a sets the priority of a given set of messages to a high degree of urgency, then the RREM 528 may route messages through one of the networks 206(1-3) that provides high transmission speed, broad geographic coverage, and/or highly-reliable message delivery. Alternatively, messages requiring high urgency can be routed through multiple, rather than one of the networks 206(1-3) to ensure that the messages are received in the fastest and most reliable manner. In another alternative, if many messages are available for delivery, the RREM 528 may dispatch the messages with the highest priority message first.

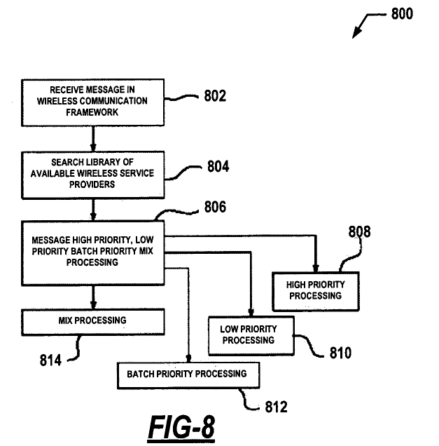

FIG. 8 illustrates a flow chart depicting another communication flow 800 between the service server 202 and the OBU 105. In communication flow 800, one or more messages are dispatched from the server system 202 to a remote unit, such as OBU 105. Like above, the flow 800 may also be carried out by in the reverse direction, i.e., originating from the OBU 105 and terminating at the server system 202. Moreover, other devices besides the server system 202 and the OBU 105 may carry out the following flow.

At block 802, the server-system portion of the WCF architecture receives one or more messages from one or more of the application programs 410b. Before sending the messages, however, the application programs 410b may assign a particular priority to each of the messages. This priority, for example, may be set to a low priority, which indicates that the message or messages need not be sent with urgency. Alternatively, the priority may be set to a high priority, which indicates that the message or messages need to be sent with some degree of urgency and be delivered soon.

The priority may also be set to a batch priority. The batch priority may indicate to the WCF architecture that the messages may be held in a queue, e.g., the message store 520, until other messages with the same priority level are accumulated. Once accumulated, the group of messages can be then sent as one batch.

Alternatively, the priority assigned to one or more of the messages may be multi formatted. In this embodiment, the messages may have a low priority for a predetermined time. After the predetermined amount of time is expended, the WCF architecture may be notified that the message has not been sent. The WCF architecture then can reassign the priority for the messages or take a different action to dispatch the message with greater urgency.

At block 804, the API 512 may determine which of wireless communication networks 206(1-3) are available to the OBU 105. Each of the messages' priority is reviewed to determine whether high, low, multi-formatted (mixed processing) or batch priority conditions exist, as shown in block 806.

High priority processing is carried out for messages having a high priority, as shown in block 808. Low priority processing is executed for messages having a low priority, as shown in block 810. Batch priority processing is executed for messages having a batch priority as shown in block 812. It should be noted that many different levels of priority are possible can be assigned. In each case, the severity of the urgency of the priority assigned by the application programs 406b may be “escalated,” “de-escalated,” or otherwise changed by the RREM 528 depending on the factors mentioned above.

The high priority processing of step 808 may use the RREM 528 to identify the most reliable coverage service provider. Then the RREM 528 works together with the transport manager 518 to select the transport module for the service provider that may provide the most reliable service. Messages are then sent via the wireless communication networks 206(1-3) of the selected service provider. Alternatively, the RREM 528 may review the available service providers to determine the fastest, broadest coverage area, etc. for delivering the high priority messages. On the other hand, the RREM 528 may review the available service providers to determine lowest cost provider for low priority messages. The least-cost routing manger 524 may links to the transport manager 518 for the low cost wireless provider, and then transmits the messages via the low cost service provider. Batch priority processing of step 710 is used for very low priority messages, which may be batched together and dispatched at one time. For this, the RREM 528 may use message manager 514 to batch messages together and send them at one time.

In block 814, multi-formatted or mix processing may be carried out if the message priority is assigned by the application programs 406b. For instance, messages provided from the application programs 406b may be tagged with a low priority number for a predetermined period of time. If the message is not sent within that predetermined period of time, then the RREM 528 processes the message as a higher priority message.

Accordingly, in block 814, the RREM 528 attempts to send the message via a low cost wireless service during the predetermined time. If the message is unable to be sent through the low cost wireless service within the period time, then the RREM 528 reassigns the message to be sent via a high speed, higher cost, greater coverage or more reliable network to increase the ability of the message to reach its destination. As noted, the above-described communication flow 800 is for exemplary purposes only and carried out by in the reverse direction and/or with devices other than the server-system 202 and OBU 105.

3 Alternative WCF Architecture

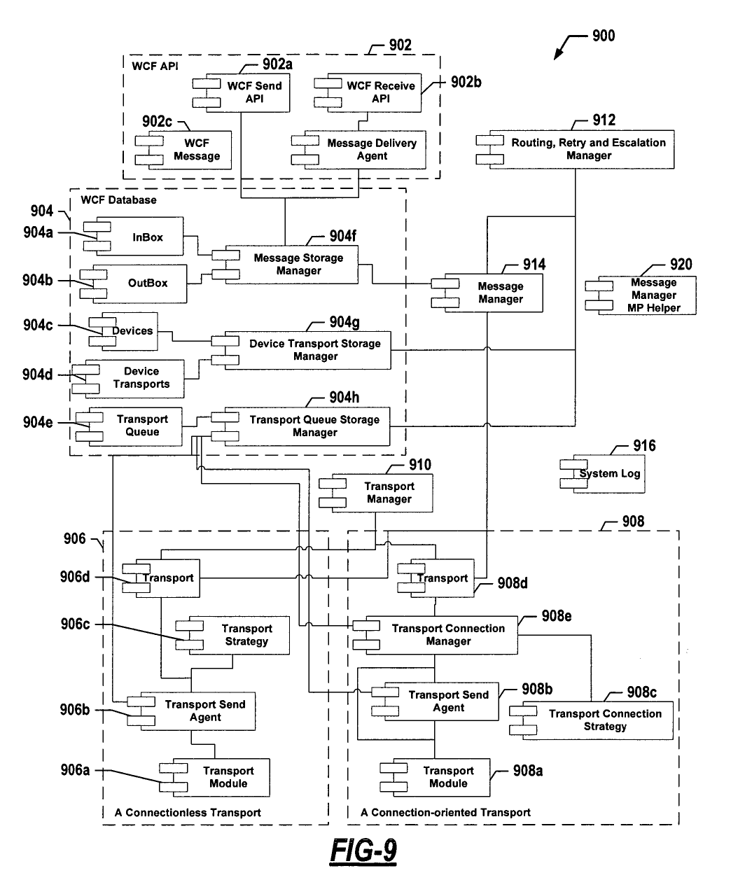

FIG. 9 illustrates an off-board architecture for a Wireless Communication Framework, or alternately, a complementary on-board architecture for the Wireless Communication Framework according to an exemplary embodiment. The off-board and on-board architectures together form an overall Wireless Communication Framework (WCF) 900 that may encompass a number of software and/or hardware program and/or application elements for carrying our wireless communications between the off-board and on-board architectures over a number of transport network, such as the wireless communication networks 206(1-3) noted above. In addition to the embodiments disclosed hereinafter, other alternatives to the WCF 900 architecture and functions are disclosed in outline form a later section entitled “Alternative Data and Processing Objects for the Wireless Communication Framework”.

The off-board architecture is “off-board” in that it is not directly coupled to a vehicle bus, but rather interacts with the on-board architecture of the WCF 900 that is contained in a remote unit, such as the OBU 105, and that is directly coupled to the vehicle bus. The off-board architecture may be concentrated or distributed on either the server system 202 or other devices that are operable to communicate with the OBU 105. The on-board architecture may be concentrated or distributed on the OBU 105 or other devices that is operable to communicate with the server system 202.

In either case, however, the architecture having server portions of the WCF 900 may act as a server in a client/server relationship, and the architecture having the client-side portion of the WCF 900 may act as the client in the relationship. Because the server and client responsibilities may change depending on the function to be carried out, the server system 202 can be a server for one function, yet a client for another. Similarly, the OBU 105 may be a client for one function, and a server for another.

The off-board architecture of the WCF 900 may be deployed with a WCF Application Program Interface (API) 902 that is communicatively coupled to, a WCF database 904. The WCF database, in turn, is communicatively coupled to a connectionless transport interface 906, a connection-oriented transport interface 908, a routing, retry, and escalation manger (RREM) 912, and a message manager 914. The connectionless transport interface 906 and connection-oriented transport interface 908 are communicatively coupled to and under the control of a transport manager 910. The off-board architecture may also include a system log 916 for logging various events occurring in the WCF 900. The on-board architecture of the WCF 900 may be similar to the off-board architecture of the WCF 900. As will be described in more detail below, differences from the off-board architecture of the WCF 900 may include (i) message tables that do not need to support multiple device identifiers (“Device Ids”), (ii) transport address abstractions that may support only the addresses for the off-board architecture of the WCF 900, and/or (iii) send and receive operations that assume that the opposing end is the off-board architecture of the WCF 900. Given that the off-board and on-board architectures are substantially the same, the following describes the WCF 900 in the context of either of the on-board architecture or the off-board architecture, except as otherwise noted.

(a) WCF API

The WCF API 902 may contain components that are used by client applications (e.g., application programs 406a, 406b discussed above) to send and receive application messages. The WCF API 902 may include a send API component 902a that implements the interface for sending application messages, and a receive API component 902b that implements the interfaces for receiving application messages. The messages may be sent and received by poll, notification and fetch, or delivery operations. The WCF API 902 may also include a message component 902c for abstracting the application messages that may be sent or received through the WCF API 902, and a message-delivery agent 902d for communicating the sent and received application messages to the WCF database 904.

(b) WCF Database

The WCF database 904 may provide storage for application and other messages, one or more identifiers of the complementary architecture(s) (i.e., the WCF database 904 in the off-board architecture stores identifiers of the onboard architectures and vice versa), and information associated with transport interfaces 906. 908. For example, the WCF database 904 may deploy tables or other structures to store information, such as (i) a InBox 904a for storing inbound messages, (ii) a OutBox 904b for storing outbound messages, (iii) an device information object 904c for storing information associated with the complementary architecture; (iv) a transport information object 904d for storing information associated with the transports interfaces 906, 908; (v) a transport queue information object 904e for storing information about the contents of the transport queue 904e; and (vi) an application map (not shown) for storing mapping information for the components of the WCF 900.

i. InBox

The InBox 904a may be used to hold all inbound (i.e., received) application messages (referred to hereinafter as “inbound messages”) from the application programs 406a, 406b. Acknowledgement messages (hereinafter referred to an “Ack”) typically are not stored in the InBox 904a.

An inbound message in the InBox 904 may be in one of the following status states. The inbound message may be in an MP_InProgress state. This state indicates that the inbound message is being sent in multiple parts, and not all of the parts have arrived. The inbound message may be in an unhandled state, in which the inbound message has been received, but not delivered to its destination application, such as one of the application programs 406a, 406b. The inbound message may be in a handled state in which the inbound message has been delivered to its destination application and the destination application has acknowledged delivery.

In the case of ordered delivery (discussed below), inbound messages may remain in the InBox 904a, for at least until they have been delivered. The InBox 904a may also maintain the last delivered inbound message so as to be able to determine whether later inbound messages are eligible for delivery. For applications programs 406b that may be distributed across multiple processing platforms on the off-board architecture, ordered delivery requirements may dictate that an ordered delivery of an inbound message may not be delivered until its predecessor (within the same ordered delivery queue) is successfully delivered.

If distributed processing is used to handle the inbound message (e.g., using component software architecture, such as COM+ Queued Components) on the on-board architecture, the order of processing might not be guaranteed if the inbound message is delivered to the application program 406a. To preserve ordered delivery semantics, the application program 406a may return a status message indicating that the inbound message has been accepted for queued processing. The InBox may use this status message indicate to the off-board architecture to release the next ordered delivery message.

If using COM+ Queued Components to handle inbound messages, transactional queuing may be used to avoid lost delivery of application messages and/or Acks. An exception class may be used to handle delivery failures of poison messages. For more information on component software architectures, see the MSDN Library regarding COM+ and Queued Components. The MSDN Library is incorporated herein by reference in its entirety.

ii. Outbox

The OutBox 904b may store all outbound (i.e., to be sent) application messages destined to application programs 406a, 406b. Outbound messages may also include acknowledgment to received application messages originated by application programs 406a, 406b.

The OutBox 904b may maintain sending-side sequence number pools for use with sequencing the outbound application messages. The sequence number pools may be implemented by maintaining separate tables for each sequence number pool or by keeping last-message-sent information from each pool and determining the pool boundaries from the separation of the last-message-sent information. Other implementations are possible as well.

An application message in the OutBox 904b may be held there for a period of time, e.g., an escalation time, before being handled, in this case escalated, by the RREM 912, as will be descried in more detail below. The message manager 914 may periodically query the OutBox 904b for application messages whose escalation time has passed. If the OutBox 904b locates application messages that have exceeded the escalation time, the message manager 914 notifies the RREM 912.

An application or Ack (or collectively referred to as an “outbound”) message in the OutBox 904b may be in one of the following status states. The outbound message may be in a queued state, which indicates that the outbound message is available for initial disposition by the RREM 912.

The outbound message may be in a pending state, which means that the outbound message has been processed by the RREM 912. An outbound message in pending status may have an escalation time specified, and/or be queued in the transport queue 904c. If an outbound message in the pending status does not have either of these, then it may revert to queued status to avoid being forever trapped in the transport queue 904c.

The outbound message may also be in an MP_Pending state, which indicates that the outbound message is being sent in multiple parts to the destination application, and at least the first part has been processed by the RREM 912. The outbound message may be in a sent condition, which indicates that the outbound message has been successfully sent on a transport network, if no acknowledgement was required, or has been acknowledged if an acknowledgement was required.

The message storage manager 904f may delete any outbound messages having the sent status. If, however, the outbound messages having the sent status are used to remember sequence number assignment, these messages may be deleted after a subsequent message is queued from the same sequence number pool. The outbound messages may be also in an undeliverable state. In this sate, the outbound messages might not be delivered because, for example, a transport error occurred indicating that a transport address of a selected transport network was invalid.

Each outbound message in the OutBox 904b may include (i) a device ID, which identifies the device to which the outbound message is addressed; (ii) a message service parameter, which indicates whether the outbound message is to be sent by unreliable, reliable, or ordered delivery; (iii) a message type parameter, which indicates whether the outbound message is an application message or an Ack; (iv) a message priority parameter, which indicates a priority level (e.g., low, high, mixed) that is assigned by the sending application program 406a, 406b; (v) a message number parameter, which indicates that the sequence number assigned to the outbound message; and/or (vi) a message Date/Time parameter, which indicates the date and/or time at which the message was queued for sending. Alternative time zone fields may be used for time-zone-agnostic computations if the WCF database 902 does not support GMT-based operations, for example.

Each outbound message in the OutBox 904b may also include a (vi) message content parameter otherwise known as a payload, which contain the actual bytes (and length) of the outbound message; (vii) a message status parameter, which indicates at least one status values noted above; (viii) a message RREM Escalation Time parameter, which is an optional date/time value at which the outbound message may be delivered to the RREM 912 for escalation; and (ix) a message transport parameter, which, in the case of an Ack, is the transport network over which the corresponding application message was received. This message transport parameter may be used by the RREM 912 to disposition the Ack to an appropriate transport interface, and in turn, the appropriate transport network.

Each outbound message in the OutBox 904b may also include a RREM Retry Count parameter, which is a number, maintained by the RREM 912 to track the number of times an outbound message has been retried. The RREM 912 may reset this number when escalating the message to a different transport interface, and in turn, the appropriate transport network.

Queuing an Ack may duplicate an existing Ack, in which case the outbound message may be treated as a duplicate and discarded, taking into account the following rules. For an Ack to multi-part message (described below), the existing Ack may be replaced by the new one If the existing Ack is of type ‘Ack just this part’, and an Offset and BlockSize of the multi-part message are the same.

For an Ack to non-multi-part messages, the existing Ack may remain and the new Ack is discarded if the existing Ack has a queued status. Otherwise, the existing Ack may be replaced by the new one if the existing Ack has a sent or pending status. Replacement of a pending Ack (and setting its status to Queued) allows the RREM 912 to re-disposition the Ack, which might be advantageous in cases that the duplicate application message had already been escalated. The Ack may be sent over the most recent one of the transport interfaces 906, 908 and corresponding transport network. When replacing the outbound message, it may be removed from the transport queue 904e.

A duplicate Ack can be deployed if an application message is received multiple times. For example, a duplicate Ack may result from sending the application message over different transports due to retries, escalation, or multiple-transport-transmit; sending the application message multiple times over the same transport network due to retries; and duplication of the application message in transit (if this is a characteristic of the transport network).

If an existing Ack has the sent status, then a duplicate Ack may result of a retry of the Ack if it was deemed to be lost or sent too late. If, however, the existing Ack has the queued or pending status, then an additional Ack might be unnecessary to acknowledge the queue or pending Ack.

iii. The Device Information Object

The device information object 904c may store information about each of the complementary (e.g., on-board) architecture to which the present (e.g., the off-board) architecture may connect; (ii) the transport information object 904d may store information associated with each of the transport interfaces 906, 908, including, for example, transport-specific addresses; (iii) the transport queue information object 904e may store references to messages queued for transmission over one or more specific transports; and (iv) the application map may provide a mapping between the identification of a specific one of the application programs 406a, 406b that messages are intended for (hereinafter “Application ID”) and a destination component and/or node to which push delivery of messages should occur.

iv. Transport Queue

The transport queue 904e may be used to track the assignment of inbound and outbound messages (collectively referred to a WCF messages) to specific transport networks and the timeouts of the WCF messages sent over such transports.

The transport-queue-storage manager 904h may expose WCF messages (or parts thereof in the case of multi-part messages) as if they were duplicated in the transport queue 904e. Alternatively, the transport queue 904e may hold references to WCF messages in the OutBox 904b rather than copies of the WCF messages. In the case of multi-part messages, the transport queue 904e may hold Offsets and size references to the message in the OutBox, rather than copies of the message parts.

The transport queue 904e may maintain an independent, concentrated, or distributed queue for each transport network. A single physical table (with transport identification as a key field) may be used also.

The transport queue 904e may be used to measure the sending window, per off-board architecture, of a sending channel of the transport network. For example, in some networks, only one outstanding message may be pending-at a time to an on-board architecture. For an unacknowledged Ack, a subsequent message might not be sent for some time period following a successful send. The WCF messages in the transport queue 904e may be counted to determine sending window status per on-board architecture.

Each WCF message in the transport queue 904e may have a part identifier. For a WCF message that is sent as a single part (i.e., a non multi-part message), this part number may be 0. For a WCF message sent in multiple parts, the transport queue 904e may hold one of the WCF message parts with a part identifier of 0 in a queued state until all parts of the message have been sent. Each message part of the multi-part message may have an incremented part identifier, thereby allowing each message part to be uniquely identified in the transport queue 904e.

A WCF message in a transport queue 904e may have one of the following status states. The WCF message may be in a queued state in which the WCF message is available to be sent over a transport network. Associated with the WCF message in a queued state is a trigger time, which may be a date and/or time at which the WCF message will trigger a transport-level send if it has not already been grouped into an existing packaged message (described in more detail below).

The WCF message may be in a pending state, which indicates that the WCF message has been successfully sent on the transport network and is awaiting an acknowledgement. Associated with a WCF message in the pending state is a timeout time at which a date and/or time the WCF 900 will assume that either the WCF message or its Ack is lost. When the timeout occurs, the RREM 912 may be notified of the event. The RREM 912 may responsively re-queue the WCF message for dispatch to the same or a different transport network.

In transport networks in which some time can elapse between a call to send the WCF message and the message being handed to one or more of the transport networks, the transport modules 906a, 908a may implement an internal queue so that send can return quickly. In the event that the sent WCF message cannot be successfully handed off to one or more of the transport networks, a send failure notification may be made by the transport modules 906a, 908a.

The WCF message may be in a pending, not in window status condition in which the WCF message has been successfully sent on at least one of the transport network and is awaiting an Ack. The WCF message may also be in a sent, no Ack expected status condition. In this condition, the WCF message has been successfully sent on at least one transport and no acknowledgement is expected. Associated with a WCF message in this status is a window timeout value, which may represents the date and/or time at which send status of the WCF message no longer blocks the sending window to the destination application program 406a, 406b. A WCF message in the sent, no Ack expected status condition may be deleted once its window timeout has passed.

In a sent status condition, the WCF message has been successfully sent on one or more of the transport network and has been acknowledged. When a WCF message transitions to a sent status, the WCF message may be deleted from the transport queue 904e.

A sent, but not received status condition accommodates a message part was NAck'd by an Ack with current status. This is particularly useful for multi-part messages. The WCF message may also be in a sent, but timed out status in which a part of the WCF message timed out waiting for an Ack with current status. This also is particularly useful for multi-part messages.

Each message in a Transport Queue may include (i) a transport identification parameter, which is the identification of the transport queue 904e in which the WCF message is queued; (ii) a transport-specific priority parameter, which is an RREM-assigned priority level that is meaningful to the specific transport network and used to guide the transport network's behavior; (iii) a message priority parameter, which is the priority level assigned to the WCF message by the application programs 406a, 406b; (iv) a timeout parameter, which corresponds to the a date and/or time of the trigger or timeout in the WCF message status; (v) a status parameter, which specifies the message statuses as noted above; and (vi) a sent time parameter, which specifies the time at which the WCF message status changed to Pending (e.g., successful Send was confirmed).

The transport networks send window status for a destination application program 406a, 406b may be determined by counting the messages with status send pending, pending, and sent no Ack expected (when window timeout has not passed). The Removal of a WCF message from the transport queue 904e, or a status change to queued or sent, may clear the WCF message from the send window. This may occur as a result of the WCF message being Ack'd on the same or a different transport network. Alternatively, the removal or change may occur as a result of the RREM 912 escalating the WCF message, even though it is pending in its transport queue 904e. If clearing the window is undesirable, the RREM 912 may leave the message in the transport queue with a pending status until the WCF message times out. The removal or change may also occur as a result of the RREM 912 retrying a WCF message due to a timeout.

v. Storage Manager Components

Various storage manager components, e.g., message-storage manager 904f, device-transport-storage manager 904g, and transport-queue-storage manager 904h may be used to manage manipulation of the specific objects and to provide management interfaces that may be used by the rest of components of the WCF 900. For instance, the message-storage manager 904f may provide the functions of storing, deleting, reading, and managing the properties of messages. The message-storage manager 904f and OutBox object 904b may also be responsible for maintaining a pool of send-side sequence numbers, which may be used for (i) acknowledging receipt of messages and/or (ii) message identification. The send-side sequence numbers may be different for each message. Additional internal tables or other structures may be used for the maintenance of the sequence number pool(s).

The device-transport-storage manager 904g may provide the functions for querying and updating information regarding architectures and transport interfaces 906, 908. The transport-queue-storage manager 904h may provide the functions of adding, dropping, and querying messages in the transport queue 904e.

(c) Connectionless Transport Interface

The connectionless transport interface 906 may contain components for sending and receiving WCF messages over one or more connectionless transports, i.e., one or more of the wireless communication networks 206(1-3) that subscribes to connectionless communication. Included in the connectionless transport interface 906 are one or more transport modules, shown collectively as transport module 906a, which is communicatively coupled to a transport-send agent 906b. The transport-send agent 906b, in turn, is communicatively coupled to a transport-strategy module 906c and a transport-interface manager 906d.

Each transport module 906a may implement (via abstraction) the parameters and/or protocols for of one or more transport network, such as a CDMA data communication network, and/or a pager communication network. The transport module 906a may provide (i) the parameters and/or protocols for sending and receiving WCF messages over the transport networks; (ii) the status of the transport networks (e.g., available/not available); (iii) information about the transport networks requirements (e.g., maximum packet size, etc.); and/or (iv) provide other services, such as registration, associated with transports.

The transport-send agent 906b may implement operations for managing the sending of WCF messages over a selected transport network. The transport-send agent 906b may (i) check the transport module 906a to determine if it is acceptable to send a message; (ii) manage a send window of the selected transport network; (iii) manage a send throttle of the selected transport network (i.e., manage the send-side message rate to comply with network utilization requirements); (iv) pull queued messages from the transport queue 904c via the transport-queue-storage manager 904h; and/or (v) package (e.g., group) WCF messages, at the same transport-specific priority level, that destined for the complementary architecture.

Each transport module 906a may expose transport-specific priority levels to other WCF components. For instance, the RREM 912 may be responsible for determining which of the transport interfaces 906, 908 and transport-specific priority level for each message. This allows the transport-send agent 906b to package WCF messages into single transport packets based on common transport-specific priority.

The transport-strategy module 906c may contain the throttle rules for each of the transport windows and corresponding-transport networks. The transport-interface manager 906d may provide an interface to manage the other components of the connectionless transport 906.

(d) Connection-Oriented Transport Interface

Similar to the connectionless transport interface 906, the connection-oriented transport interface 908 may include components for sending and receiving WCF messages over connection-oriented transports, i.e., one or more of the wireless communication networks 206(1-3) that subscribe to connection-oriented communications. Included in the connection-oriented transport interface 908 are one or more transport modules, collectively shown as transport module 908a, which is communicatively coupled to a transport-send agent 908b and a transport-connection manager 908e. The transport-send agent 908b is also communicatively coupled to the transport-connection manger 908e. The transport-connection manger 908e in turn is communicatively connected to a transport-connection-strategy module 908c, and a transport-interface manager 908d. The transport module 908a, transport send agent 908b, and the transport 908d are the same or similar to those for corresponding devices in the connectionless transport 906, with some of the differences as follows.

The transport module 908a may implement additional or different interfaces to support connection management. It may expose a connection component to model the behavior of a connection. The transport-send agent 908a may handle notification and termination of connections in addition to functions described above for the connectionless transport 906.

Not included in the connectionless transport interface 906 is the transport-connection manager 908e, which manages the characteristics of connection-oriented transports. The transport-connection manager 908e may (i) trigger the transport-send agent 908b to send WCF messages when a connection is established; (ii) terminate send operations when the connection is ended; (iii) notify the connection that it may be safe to close when all queued WCF messages have been sent; and (iv) trigger or initiate a connection when the transport-connection-strategy module 908c determines that a connection is needed.

The transport-connection-strategy module 908c, which may be specific to application programs 406a, 406b, may determine when a connection should be triggered or initiated. The transport-connection-strategy module 908c may make its decisions based on factors such as (i) the time since last connection; and (ii) the number, priority, and age of messages queued.

(e) Routing, Retry and Escalation Manager

The RREM 912 may carry out decisions regarding the disposition of outbound messages. To facilitate this, the RREM 912 may queue each outbound message for delivery over one or more of the transport networks. The outbound messages may be queued for transport over the multiple transport networks simultaneously. For example, outbound messages may be queued for both a transport network embodied as an IEEE 802.11 network, and a transport network embodied as a CDMA wireless network. Given that the outbound messages queued for transmission over the CDMA wireless network may not be sent immediately due to, for example, message window and network throttle considerations; the outbound messages may be simultaneously queued for delivery over the IEEE 802.11 network. If the outbound messages are successfully sent over the IEEE 802.11 network, then they can be removed from a portion of the transport queue 904e for the CDMA wireless network. The RREM 912 may also establish a transport-specific priority level, in addition to an application specific priority level established by the application programs 406a, 406b, with which outbound messages are queued.

The RREM 912 may escalate the outbound messages from one transport network to another transport network (assuming, of course, that the complementary architecture supports multiple transports). Such escalation may be based on transport-specific timeouts, timeouts determined by the RREM 912, and rules specific to the application programs 406a, 406b (hereinafter “application-specific rules”). The RREM 912 may determine timeout values for each outbound message and may fail an outbound message if certain conditions are met. Alternatively, the message-storage manager 904f may manage the timeout and retry responsibilities of WCF 900.

An outbound message might be deemed failed if it could not be sent within a certain time period or given number of retries. With ordered delivery, outbound messages might not be failed, but rather replaced with dummy messages to avoid creating holes in the ordered delivery sequence numbering. An alternative to failing an outbound message might be to log in the system log 916 a system alert that notes that the outbound message could not be delivered.

The RREM 912 may implement application-specific rules. This allows the system designer, who is using the WCF 900, to establish his/her own rules for routing, retry, and escalation based on the needs of the system being implemented. The RREM 912 might require some knowledge of the specific transports in use by such system.

The RREM 912 might not interface directly with the message-storage manager 904f. Instead, the RREM 912 may receive notifications of significant events with which the RREM 912 may react or ignore. Such events may include (i) a new outbound message (e.g., new data or an acknowledgement to a previously sent message) that has been queued and requires disposition by the RREM 912; (ii) an outbound message previously queued by the RREM 912 for transmission that has been successfully sent and not acknowledged on a transport; and/or (iii) an outbound message previously handled by the RREM 912 that has now reached an escalation or timeout time.

When receiving a notification of the event of type (ii) above, the RREM 912 may (a) update the timeout time for the outbound message to reflect the time the outbound message was sent, (b) modify or remove the escalation time for the outbound message, and/or (c) remove the outbound message from other portions of the transport queue 904e. When receiving a notification of the event of type (ii) above, the RREM 912 may (a) re-queue the outbound message on the same or a different transport network, and/or (b) remove the outbound message from the original portion of the transport queue 904e.

(f) Message Manager and System Log

The message manager 914 may manage the flow of WCF messages in the system, which may include (i) notifying the RREM 912 that outbound messages have reached timeout or escalation times, and (ii) queuing Acks in response to received WCF messages. The system log 916 may provide a common logging interface for WCF components, thereby allowing WCF messages that are logged to be written to a file (or other storage mechanism) as needed.

(g) WCF Data and Processing Objects

The following data and processing objects may represent some of the types of information that is passed between the elements of the WCF 900, and some of the processing that occurs within the WCF 900 and the across a WCF API 902. The data and processing objects may be represented individually by objects and collectively by tables or other storage mechanisms in the WCF 900.

i. Message Table Object

To begin with, the WCF 900 may include a message-table object as shown in Table 1. In this embodiment, the message-table object defines one exemplary configuration for storing WCF messages in, for example, the WCF database 904 of the WCF 900.

TABLE 1

| Field | Type | Description |
|---|---|---|
| MessageDeviceID | Int (Int32) | Device Identifier (e.g., OBU 105) that the |
| | | message is to/from |
| MessageNumber | Smallint (Int16) | The message number/sequence number. The |
| | | values are assumed to be a signed 16-bit value |
| | | that is designed to be rolled-over. Initital, the |
| | | value will start at 0 and be incremented by 1. |
| MessageDirection | Tinyint (Byte) | A number indicating the direction of the message: |
| | | 0 = incoming (mobile originated) |
| | | 1 = outgoing (mobile terminated) |
| MessagePriority | Tinyint (Byte) | A number indicating the priority of a message |
| MessageStatus | Tinyint (Byte) | A number indicating the status of a message. |
| | | MESSAGE_QUEUED_STATUS 0x01 |
| | | MESSAGE_PENDING_STATUS 0x02 |
| | | MESSAGE_SENT_STATUS 0x04 |
| | | MESSAGE_UNHANDLED_STATUS 0x08 |
| | | MESSAGE_HANDLED_STATUS 0x10 |
| MessageLast | Bit (Boolean) | A flag telling whether this is the last message that |
| | | was sent to the device, from the same sequence |
| | | number pool. |
| MessageDateTime | Date/Time | The date/time of the message. |
| MessageTZOffset | Smallint (Int16) | A integer representing the number of minutes the |
| | | MessageDateTime is offset from GMT. This is |
| | | taken from the Time Zone of the Site at the time |
| | | the message was created. |
| MessageContent | Image (BLOB) | The actual message content. |

Given that one of the features of the WCF 900 is to provide reliable delivery, the WCF 900 may implement a message key for facilitating ordered and reliable delivery of WCF messages. That is, the message key may facilitate a standardized communication format between the components of the WCF 900. In one exemplary embodiment, the message key may be as shown in Table 2.

TABLE 2

MessageDeviceID
MessageNumber
MessageDirection
MessagePriority

To facilitate ordered delivery, one or more virtual message queues may be maintained. Each of the virtual message queues may correspond to a specific priority level (e.g., low, high, or multi-format). Consequently, one set of sequence numbers may be assigned to each Device ID corresponding the complementary architecture, each direction (e.g., to or from the off-board architecture) in which the WCF message is traveling, and each priority level assigned to the WCF message.

To reduce message delivery contention, the WCF 900 may decouple operations on inbound and outbound messages. As such, the InBox object 904a and OutBox object 904b may be maintained separately on both the off-board and on-board architectures of the WCF 900.

ii. Ordered Delivery Selection

While the WCF 900 provides ordered delivery function by default, the ordered delivery function may be made optional. To facilitate this, a sequence number may be added to the WCF message and message key for ordered delivery so as to distinguish ordered delivery and for non-ordered delivery WCF messages. This may add the field “Ordered Delivery” of the type “Bit (Boolean)” to the message table. However, non-ordered WCF messages might still require a sequence number in order to facilitate identification and acknowledgement of the messages.

iii. Reliable Delivery Selection

Like the ordered delivery function, the WCF 900 provides reliable delivery function by default. However, the WCF 900 may be configured to make reliable delivery function optional. For internal identification purposes, sequence numbers may be assigned to WCF messages to be delivered with unreliable delivery. However, such identification may be removed from the WCF message envelope, realizing that such WCF messages might not be storable in the destination application program's message table without such identification fields.

Sequence numbers for unreliable delivery may be drawn from a different pool than for reliable, non-ordered delivery. An additional field, such as “Reliable Delivery” of the type bit (Boolean), may be required for the message key and table: A WCF message without reliable delivery essentially skips pending acknowledgement handshaking, and can never timeout and/or be resent. However, the outbound message may progress through transport escalation if escalation strategies include a mode for waiting for an inexpensive transport to become available. Unreliable delivery service might not attempt to eliminate duplicate message delivery. As an alternative to separate fields for unreliable, reliable, ordered, and non-ordered delivery, the type of delivery service requested may be combined into a single option entitled “Message Service.”

iv. Sequence Number Recovery

The ordered delivery service relies on a strict ordering of sequence numbers to determine the order of WCF messages. When sequence numbering is lost, due to, for example, a database crash in the off-board architecture or file system error in the on-board architecture), a sequence number recovery function may be used to recover the sequence number(s) to be used. Without the sequence number recovery function, WCF messages can become lost because they are considered duplicates. Moreover, the transport queue 904e may be held up indefinitely waiting for these non-existent WCF messages.

In the case of non-ordered delivery, sequence numbers may be used for Acks, and may or may not be used for the detection of duplicate messages. This is because some sequence numbered messages may never arrive (if, for example, the sequence numbers for reliable and unreliable messages are drawn from the same pool). Consequently, a separate pool of sequence numbers may be used for reliable and unreliable delivery of outbound messages, as noted above.

Sequence number recovery may be carried out as follows. Sequence numbers are maintained on a sending side, i.e., the off-board or on-board architecture that is attempting to send an outbound message. When the sending side detects that it does not have a valid sequence number, e.g., when the first outbound message is sent that would draw from that sequence number pool, the sending side sends a notification message with a flag set to indicate that this outbound message has the first assigned sequence number. The initial sequence number may be randomized and the outbound message can include the requested payload.

The outbound message may contain, for example, a random 32 bit key that must be returned in an acknowledged message (“Ack”). Upon return, the random 32 bit key may then be matched to the sent message to allow the Ack to be accepted. This allows the sending side to positively acknowledge and confirm that sequence number recovery has begun. The outbound message may be routed and escalated as appropriate for the message's priority level. Since sequence number pools may span across a plurality of priority levels, this might force high priority outbound messages to wait for low priority outbound messages. To prevent this from happening, the sending side may limit its transport window to 1 for the pool in question. This causes no more outbound messages to be sent from the same sequence number pool until the Ack for the previously sent outbound message is received.

When the outbound message is received, the receiving side may note the new sequence number and renumber the received outbound message within that pool so that previously received outbound messages within that pool may are placed or ordered before the newly received outbound message. The receiving side may send to the sending side an Ack that contains the message sequence number and the 32 bit random key.

When the sending side receives the Ack with the matching 32 bit key, it may release the transport window on that sequence number pool, thereby allowing subsequent outbound messages to be sent. This may avoid multi-transport escalation issues created by subsequent outbound messages reaching their destinations before the re-sequencing message.

In an alternative embodiment, instead of a window-of-1, the sending side may include the 32 bit key and initial sequence number in every outbound message until an acknowledgement is received, which indicates that the re-sequence was completed. This might be simpler to implement and may beneficially reduce latency at the expense of extra bytes during the re-sequence operation.

Table 3 illustrates some of the fields that are used to identify a sending-side sequence pool:

TABLE 3

| Field | Description |
|---|---|
| DeviceID | On-board identification. Note that the on- |
| | board implementation only needs to |
| | consider itself. |
| Priority | |
| Message Service | One of: |
| | Ordered Reliable Delivery |
| | Reliable Delivery |
| | Unreliable Delivery |

When the WCF 900 uses multiple transports or when messages can be re-ordered in transit, an out-of-sequence outbound message may be sent before sequence number recovery is effected, which may result in the out-of-sequence outbound message being received at the receiving side after the first recovery message is received and acknowledged by the receiving side. Consequently, the out-of-sequence outbound message might not have features to distinguish it from an outbound message sent after sequence number recovery was complete, other than possibly having a sequence number that is significantly distant from other outbound messages already received. To overcome this, the WCF 900 may include all or part of the sequence key in every outbound message. This, however, may increase the size of every outbound message and acknowledgement by the size of the sequence key (e.g., 32 bit), while reducing the probability of sequence recovery overlap by 2\hat{ }32.

Alternatively, the WCF 900 may use a relatively small transport window for allowing unacknowledged outbound messages to be sent (e.g., 16). An outbound message received outside of the transport window can be discarded. This strategy, however, may conflict with using a small transport window strategy to support message cancellation for reliable messaging. Such a scheme may reduce the probability of overlap by the remaining sequence numbers (e.g., 2\hat{ }32-32), but might have the side effect of allowing less than optimal use of efficient transports when sufficient messages are queued.

In another alternative, the WCF 900 may use a large transport window (e.g., 256) for allowing unacknowledged outbound messages to be sent. This may reduce the probability of overlap by the remaining sequence numbers (e.g., 2\hat{ }32-256). A transport window of 256 may be generous enough to rarely limit transmission due to transport window size. A message cancellation algorithm might also need to be sensitive to this transport window, in that if many outbound messages in a row were canceled, some dummy messages might be required to keep the receive-side transport window updated.

In yet another alternative, the WCF 900 may use a 32-bit sequence number in conjunction with a larger transport window. This may reduce the probability of overlap by the remaining sequence numbers (approx. 2\hat{ }32) but would increase by two bytes the size of every message. Except that in the case of sequence number recovery, some out-of-order outbound message delivery might occur, causing the receiving application to be prepared to deal with such condition.

In sum, the sequence number recovery may (i) maintain sequence number pools as described above, (ii) accept received outbound messages within a window of 256 messages, (iii) not make queued messages in the OutBox 904a eligible for routing via the RREM 912 if a message, in the same sequence pool, has a sequence number 256 numbers less that the current message and remains unacknowledged, (iv) limit the number of sent outbound messages to 256 to ensure that the transmission of the outbound messages does not exceed the received transport window, (v) use 16-bit sequence numbers, (vi) use re-sequence information in each outbound message in the same sequence pool until an Ack is received to confirm re-sequencing, (vi) have 16-bit new initial sequence number and/or a 32-bit random session key re-sequencing information, (vii) persist received messages that include the last received re-sequencing information so as to detect an unlikely case that re-sequencing occurs twice in succession, and (viii) may flush the transport queues 904e of all messages within the sequence number pool in the event that on the send-side re-sequencing may be necessary

v. Reliable Delivery Sequence Pools

Each priority level of reliable, but not ordered, delivery may not have a corresponding independent sequence number pool. Doing so, however, may avoid transport window size issues (as described below) that could occur if all reliable delivery outbound messages used the same sequence pool. Consider the following example. Outbound messages with low priority are queued in the transport queue 904e. Then outbound messages with high priority are queued in the transport queue 904e. Due to escalation, all the high priority outbound messages may be sent before the low priority outbound messages. If both the high and low priority outbound messages belong to the same sequence pool, it is possible that the number of high priority outbound messages will exceed the allowable size of the transport window (as described below). Following that event, the high priority outbound messages will be held until the preceding low priority outbound messages are sent and Ack'd. Maintaining a separate sequence pool for each priority level may avoid this conflict. It is assumed that outbound messages of the same priority level may be escalated in an approximately equal manner.

vi. Loss of Receiving Side Sequencing

Persistence of sequence number information is important on both receive and send sides of the WCF 900 because the sequence numbers may be used to manage a receive side transport window and the ordering of deliverable messages for ordered delivery service. For example, the send side of the WCF 900 sends to the receive side outbound messages numbered 1, 2, 3, 4, 5, and 6 from a single sequence pool. If such messages were to arrive in order, but the receive side InBox was reinitialized after message 3 was received, when the receive side InBox later receives messages 4, 5, 6, it may pick up where it left off. In this case, a recovery algorithm of WCF 900 may be to simply begin tracking sequence numbers from the first message received (in this case, 4). If an earlier sequence number were subsequently received (e.g., 2) it would be treated as a duplicate and acknowledged.

However, if the receive side InBox resets after receiving and acknowledging out of order outbound messages, e.g., messages 1, 2, 3, 4 and 6, a hole, i.e., message 5, in the sequence pool may be created. To resolve this situation, logic of the receive side of the WCF 900 may detect when an outbound message was received into an empty sequence pool. When this event is detected, a sequencing message may be sent back to the send side of the WCF 900, thereby allowing the sending side to reinitialize the sequencing information. In response, an outbound message containing a re-sequence indication is responsively sent to the receive side of the WCF 900 to initialize or reinitialize the receive-side sequence numbers after reinitializing the OutBox storage and send-side sequencing. On the other hand, if the detected outbound message contains the re-sequence indication, then there is no need to send a sequencing message back to the send side of the WCF 900.

As noted, the sequence number recovery allows reliable delivery to resume without adverse side effects due to holes in received sequence numbers. The loss of storage on the receive side may mean that some received outbound messages may have been lost or duplicated. Sequence number recovery may allow the receiving side to (i) initiate re-sequencing as if its send-side sequence information was reinitialized, starting with the first unacknowledged outbound message; (ii) reset previously Acks with later sequence numbers to unacknowledged states, (iii) eliminate the re-sequencing or replacing with empty messages previously Ack and deleted from the sending side, and (iv) calculate a new sequence seed to avoid overlap with the existing sequence pool rather than relying on a random number to do the same since the sending side has not lost the re-sequence information.

The sequence number recovery may also allow the sending side to respond by starting at alternative start points (i.e. which outbound messages to resend) for the new sequence, including starting at (i) a first outbound message that was received into an empty sequence pool, (ii) a first outbound message after the one that was first received into an empty sequence pool, or (iii) the first unacknowledged message, which may be before or after the one that was received into an empty sequence pool. In addition, the sequence number recovery may allow the sending side to retain the existing sequencing, but ensure that no holes exist in the sequence by resetting acknowledged messages to unacknowledged or filling in holes with empty messages.

Assuming that the sending side responds by initiating a re-sequence, the choice of start point may be coordinated with the behavior of the receiving side so as to minimize the loss or duplication of messages. For example, the receiving side might refuse to Ack received into a particular sequence pool until a re-sequence operation is received, in which case the outbound message that triggered the sequence number recovery may be resent. The receiving side might achieve this by checking whether a receive-side sequence pool has ever had a re-sequence operation. If not, the first received outbound message that does not have re-sequence information may initiate the re-sequence operation, and subsequent received outbound messages may be discarded without acknowledgement.

In the alternative, receive-side outbound messages may be integrated into a new sequence. This could be problematic because the outbound messages can be received out of order and additional state information would be required to identify the outbound messages received after the re-sequence as being valid for the sequence and needing renumbering. However if only outbound messages received prior to the re-sequence were considered, then such an approach could save a few resent outbound messages without additional complexity.

When a sequencing message is used to communicate that a message has been received into an empty sequence pool, then an additional risk exists if the sending side OutBox is subsequently reinitialized before the outbound message is delivered, making the WCF 900 unable to recover. To overcome this, a non-acknowledgment message (“NAck”) may be used to cause a discard of each outbound message received into an empty sequence pool so that the WCF 900 may eventually recover. On receipt of the NAck, the sending side can renumber outbound messages and initiate re-sequencing. Thus, if multiple such NAcks are received, later-received outbound messages will not match the unacknowledged message.

Applications, such as the application programs 406a, 406b, that rely on ordered delivery might want to receive notification of messages lost during an InBox re-initialization. This may be achieved by filling empty sequence numbers with empty messages or a specific system message, and allowing the receiving applications to subscribe for notification of such messages. Since the outbound messages have lost their original target application identification, the notification may be sent to all applications so that the notification reaches the target application.

As an alternative, missed message detection may be carried out by receiving applications. The receiving application may be configured to check message sequence numbers. When a discontinuity is detected in the received message sequence numbers, the application can assume that some outbound messages were lost. To facilitate this, holes in sequence numbering may be retained. In yet another alternative, acknowledged ordered delivery messages could be preserved in the Outbox until all prior outbound messages are acknowledged.

vii. Priority Levels

The WCF 900 may accommodate an application-specific number of priority levels, such as a Periodic Batch, e.g., monthly report query, in which messages may be held for off-peak time and transmitted with a low priority; an Ad-hoc batch, e.g., multi-vehicle ad-hoc report query in which application messages may be transmitted with a low priority but might not be held for off-peak time, or an Ad-hoc single vehicle query, e.g., RDA, in which application messages may be transmitted as soon as possible and may be transmitted with a higher priority. Ideally, the application-specific priority levels may be entered through the use of a configuration entry.

The lowest priority level may be “0” and the upper level may be “0” through “255.” The on-board architecture may use a compile-time constant to reserve space for priority-specific queue information. For ordered delivery, priority level may also identify a message queue, i.e., ordered delivery may be carried out for application messages within a priority level, and all application messages in a queue have the same priority level.

The transport-specific mapping of application message priority to transport behavior (e.g., hold-off, and network priority) may be configured at the transport level, rather than hard coded. This allows a transport implementation to be used for different application programs 406a, 406b. While advantageous, a range of 256 priority levels may become unwieldy and since priority level may also determine the number of queues in the case of ordered delivery. A total of 32 levels may provide an appropriate balance between complexity and size, however, almost any number of priority levels may be used.

viii. Multiple Transports

Given the availability of multiple transports, an Ack may be accepted from any transport interface, not just the transport interface on which the Ack'd message was sent. This is possible because sequence numbering and acknowledgements may be managed above the layer provided by the transport modules 906a, 908a. As noted, the transport modules 906a, 908a may abstract the parameters of the transports. For example, the transport module 906a may abstract parameters from connectionless transports, such as Mobitex narrowband, packet-data network and/or Qualcomm CDMA network. The transport abstraction may accommodate, for example, (i) connection to a network operation center (NOC), which may be unavailable at times; (ii) connection to an on-board modem, which may also be unavailable at times; and (iii) when the architectures' modems are out of their respective coverage areas.

The transport module 908a may abstract parameters from connection-oriented transports, such as remote access server (RAS)-over-Sprint and/or 802.11 networks. In this case, the transport abstraction may to accommodate one or both ends of the transport, e.g. connection to the NOC and the modems, which may be able to initiate or trigger a connection. In the case of a Sprint network, one embodiment allows the off-board architecture to trigger a connection by contacting the onboard architecture, and then having the on-board architecture respond by initiating a RAS connection back to the off-board architecture.

The transport abstraction may determine that (i) one or both ends of the transport that may need to accept a connection, (ii) the rules for triggering or initiating a connection may be application specific; and/or (iii) some transports use of TCP/IP or UDP/IP over the underlying transport protocol. For example, TCP may be preferred in the case of 802.11, but UDP may be preferred in the case of the Sprint network.

The WCF 900 minimizes the effort required to develop and maintain transport-specific modules, and to this end, the transport abstractions might place more responsibility on the components of the WCF 9i00 and less on transport modules 906a, 908a. To facilitate this, a transport table may be used to hold the list of transports and corresponding transport-specific configuration information. A device-transport table may be implemented in both the off-board and on-board architectures to hold device-specific transport-specific addresses. A status flag may be included to allow specific device transports to be disabled.

In addition, Acks may be queued in the OutBox object 904a. When queued, the Ack may be tagged with the transport identifier on which the original message was received. The RREM 912 may be responsible for queuing Acks with the corresponding transport networks, and may choose to override the initial transport of the Acks. Conseqyuently, Acks are valid when received from any transport over the connection-oriented transport interface 908.

ix. Transport Identification

A transport may be identified by, for example, an 8-bit integer that is assigned at design. Alternatively, a 32-bit integer may be applied at the level of the WCF API 902. A transport identifier (“transport ID) may be unique for each of the transport modules 906a, 908a used by the WCF 900, but also may be unique across other WCF systems so as to allow the transport modules 906a, 908a to be portable. A source safe may be maintained with an enumeration or database to keep track of all transport IDs. Alternatively, transport IDs may be configurable. For example, the transport ID assignment is managed at a WCF integration level rather than a WCF design level.

The transport ID is typically not be sent in WCF messages. However, if the transport ID is sent, efficient packing of the transport ID may be implemented. Two bits of the WCF message may be reserved to allow the length of the transport ID to be included in the same byte(s) as the transport ID. This may be shown by way of non-limiting examples in Table 4.

TABLE 4

| Position | Field | Description |
|---|---|---|
| Byte 0 Bits 0-1 | Length of Transport ID | 0-6 bits (no bytes |
| | | follow) |
| | | 1-14 bits (one byte |
| | | follows) |
| | | 2-22 bits (two bytes |
| | | follow) |
| | | 4-30 bits (three bytes |
| | | follow) |
| Byte 0 Bits 2-7 | Transport ID | Bits 0-5 |
| Byte 1 | Transport ID | Bits 6-13 |
| Byte 2 | Transport ID | Bits 14-21 |
| Byte 3 | Transport ID | Bits 22-29 |

x. Device Addressing

Although the device ID's may be the same, the WCF 900 may identify the on-board architecture using a unique Device ID, such as a 32-bit unsigned integer, and off-board architecture of the WCF 900 may maintain transport address, such as a 50 character UNICODE string. This string may be, for example, a format specific to the transport, and have meaning only to one of the transport modules 906a, 908a. The string of each of the transport modules 906a, 908a may be used to determine both the destination address when sending outbound messages and the source address when handing a received message.

Generally, the on-board architecture of the WCF 900 knows its own Device ID and the WCF API for the on-board architecture might not permit device-to-device addressing; thereby allowing the on-board architecture to assume that all messages are to or from off-board architecture of the WCF 900.

The on-board architecture may cause the WCF 900 to initialize or associate each on-board transport interface with a network address of the off-board transport interface. This association may be stored in a configuration file. The network address may be given to the transport interface as an ASCII string, for instance. The API may be configured to support text characters (“TCHAR”) so as to allow the WCF 900 to be easily ported to UNICODE platforms.

In some cases, 50 characters of address may not be sufficient. Larger amounts of characters may be used. However, additional address information (e.g., message identifier (“MID”), Device Version and Serial number) may be required on an off-board send. This information might not available for received messages and/or error messages. And a serial number that uniquely addresses the on-board architecture may only be common in a few of the on-board architectures, such as a Qualcomm's mobile communication terminal (MCT).

For the WCF 900 to properly associate WCF Device ID and Transport Addresses, the WCF 900 may use symmetric addressing. Thus the WCF 900 may be configured to support a two-part address. The first part of the address may be a symmetric part that is used by the transport interface for ‘from’ and ‘error’ source identifications. The second part of the address may be auxiliary data that used for passed to the send function, and might not be used for matching returned or received messages.

xi. Timeout

A round trip timeout for an outbound message may be dependent on the message priority and possibly the message size. As such, the transport interfaces 906, 908 may be allowed to return a timeout value as a result of the request to send a message. These timeouts may be managed by the RREM 912.

xii. Message Window

Some transports may have a message or transport window, in that, if an outbound message is sent from the sending side of the WCF 900 to the receiving side of the WCF 900, the sending side should not send another message, including an Ack to a received message, until an Ack is received from the receiving side. When no Ack is expected (e.g., the message was an Ack), the sending side may wait for some period of time before attempting to send another outbound message.

This can be facilitated by having the transport modules 906a, 908a provide details on each transport window. The transport window may represent the number and timing of messages that can be sent without waiting for either an Ack or an elapsed time to reopen the window. In the case described above, the transport window might be, for example, 1 minute when an Ack is expected or 15 minutes when no Ack is expected. Thus, when the sending side of the WCF 900 sends an outbound message on such transport network to the receiving side of the WCF 900, the transport window closes, and the sending side of the WCF 900 cannot send another message to receiving side until the transport window reopens. The transport window reopens when an Ack is received or if an Ack is not expected, when the time expires. The transport window can also reopen if a timeout occurs while waiting for an Ack.

A different version of the transport window may be required for multi-part messages. For example, the window size and period of partial messages might be different than whole messages. However, a packaged message, which may contain multiple messages as noted above, may count as 1 message with respect to the transport window.

In addition, the transport window might be priority dependent. That is, high priority level outbound messages (e.g., “panic” messages) may be sent immediately regardless of the transport window. The determination of whether to override the transport window of the transports 906a, 908a may be application and transport specific. To this end, the RREM 912 may contain logic to ignore the transport window when queuing a message to a transport.

The transport window may require Acks to be queued. This could be accommodated by storing the Acks in the message table or by storing ‘no Ack sent’ status messages with the received messages in the message table.

To maintain the status of the transport window, an additional table in, for example, the transport queue 904a of, the sending side of the WCF 900 may be used. Additional code or transactional logic may be used to ensure that the transport window does not become locked out due to a race condition.

A transport window may be set so that the receiving side of the WCF 900 does not become overrun with errors, such as BUSY errors. On the other hand, if an outbound message received from the receiving side does not Ack a pending outbound message in the transport window, then it may be assumed that (i) the outbound message did not arrive at the receiving side or (ii) the outbound message has arrived at and been processed through the receiving side (taking into account the up time of the service provider). Responsively, a network management center (NMC) may periodically retry (e.g., 6 tries over 18 hours for a Normal priority message) to resend the outbound message.

The Ack for a received message may be sent even if the prior outbound message is being retried by the NMC. In this case, the status of the pending outbound message may be maintained, but the transport window may be cleared if there is a good chance that the outbound message will either be retried or clear the receiving side of the WCF 900 before the Ack is sent. This can be accommodated by allowing outbound messages to be dropped from the transport window on receipt of an Ack from the receiving side of the WCF 900. Such action may slightly increase the risk of getting a network busy (“BUSY”) error, in exchange for faster response times to later requests and faster back-to-back requests.

In another embodiment, only one packet at a time may be sent to the receiving side of the WCF 900; and subsequent packets may not be sent until a given network-level Ack is received from the receiving side. This may be accommodated by having a transport window of 1 packet, but dropping outbound messages from the transport window on receipt of a given network-level ACK. While not needed for controlling the transport window, the receiving side may use transport level Acks to optimize communications.

Alternatively, the transport window for each transport may be defined, at least in part, by a total outstanding-messages parameter and a window expiration parameter. The total outstanding-messages parameter defines the maximum number of outbound messages that may be outstanding to either the off-board or on-board architectures. The window expiration parameter defines the period of time a sent outbound message remains in the transport window awaiting acknowledgment. Like the parameters discussed above, the parameters may be stored as configuration data/file in the transport tables of the off-board and on-board architectures. The transport queue 904c may be used to check and maintain the status of the transport window.

A sent outbound message may be counted against the transport window until (i) an acknowledgement for the outbound message is received from any transport, (ii) the window expiration parameter times out, (iii) the outbound message is removed from the transport queue due to, for example, escalation by the RREM 912, (iv) a no Ack expected message window expiration time passes, and/or (v) the outbound message is removed from the window by, for example, the sending side of the WCF 900.

Commands for removing the outbound message from the window may include (i) removing a specific outbound message from the window, which may occur as a result of a receipt of a low-level status indication for the outbound message and/or (ii) removing from the window (via a function of the carried out by the transport-queue-storage manager 904g) all sent outbound messages older than a given data or time. However, the transport queue 904e may accommodate an additional status to allow an outbound message to be pending but not counted against the transport window.

Low-level message status indications may be handled through the RREM 912 as a function of an OnMessageStatus notification, for instance. The remove all outbound messages function may be handled through the transport strategy module 906c, thereby allowing transport-specific rules to be implemented. The transport strategy module 906c may include additional entry point and configuration parameters to accommodate the remove all outbound message function. These rules may apply to sent transport-level messages, but not other messages of the WCF 900. The off-board transport strategy module 906c may have an additional Application Program Interface (API) for handling message failure notifications, represented by an OnMessageFailure notification; an on-board architecture status notification, represented by an OnDeviceStatus notification; and a message received notification, represented by an OnMessageReceived notification.

The RREM 912 and an event handler of the message manager 914 may accommodate the OnMessageStatus notification to handle non-failure notifications. Additionally, a handler of the RREM 912 may allow the RREM 912 to remove an outbound message from the device transport window during event handling. Thee RREM 912 may cause pending outbound messages to have their status changed to pending, but not in the transport window, and may cause outbound messages that have been sent and not acknowledged (represented as SentNoAck messages) to have their status changed to “NONE,” by, for example, removing the SentNoAck messages from the transport queue 904e. The handler of the RREM 912 of the receiving side of the WCF 900 may also remove outbound messages from the transport window when notified of a given network-level ACK.

xiii. Network Throttle

Some networks may have additional requirements for network utilization. Consequently, the sending side of the WCF 900 may be configured to avoid sending too many outbound messages at the same time. That is, the sending side may throttle outbound messages at a network level and may control network utilization to conform to network-specific transport-window requirements.

Such utilization may be handled by allowing transport modules 906a, 908a to provide parameters to the thread that obtains available outbound messages from the OutBox 904b. The parameters might be, for example, (i) a maximum number of outbound messages to obtain and/or (ii) a predetermined period to wait before obtaining more outbound messages. These parameters may be abstracted by the transport-strategy module 906c, allowing transport-specific rules to be implemented.

Given an operational model in which the RREM 912 makes-outbound messages available to be sent on a transport, and a transport-specific-sending thread may periodically query for outbound messages to send. This could provide a simple mechanism for throttling overall network usage. If the transport modules 906a, 908a provide values for the parameters, the transport-specific-sending thread may compute the parameters based on network utilization and time of day, for instance.

xiv. Routing, Retry, Escalation, and Timeout

Rules for timeout, retry, routing (e.g., least cost routing), and escalation may be specific to an application program 406a, 406b. Timeout may be defined as the time to wait for an Ack after sending a message before assuming that the message (or its Ack) was lost in transit and should be reattempted. Retry may be defined as attempting to resend an outbound message, as a result of a timeout. If multiple transports are available on which to send the outbound message, the retry usually refers to an attempted resend on the same transport as the outbound message was previously sent.

Routing may be defined as the routing logic that selects the transport on which an outbound message should be sent when multiple transports are available. Least Cost Routing (LCR) may refer to a process that determines and routes outbound messages over different networks in an attempt to route the outbound messages using the cheapest means possible. LCR can also include tradeoff decisions between cost and timeliness. Other routing methodology may be used as well. Escalation refers to a strategy of attempting to deliver outbound messages over differing networks, often by trying the cheapest first and then retrying over successively more expensive networks as timeouts occur on the cheaper networks.

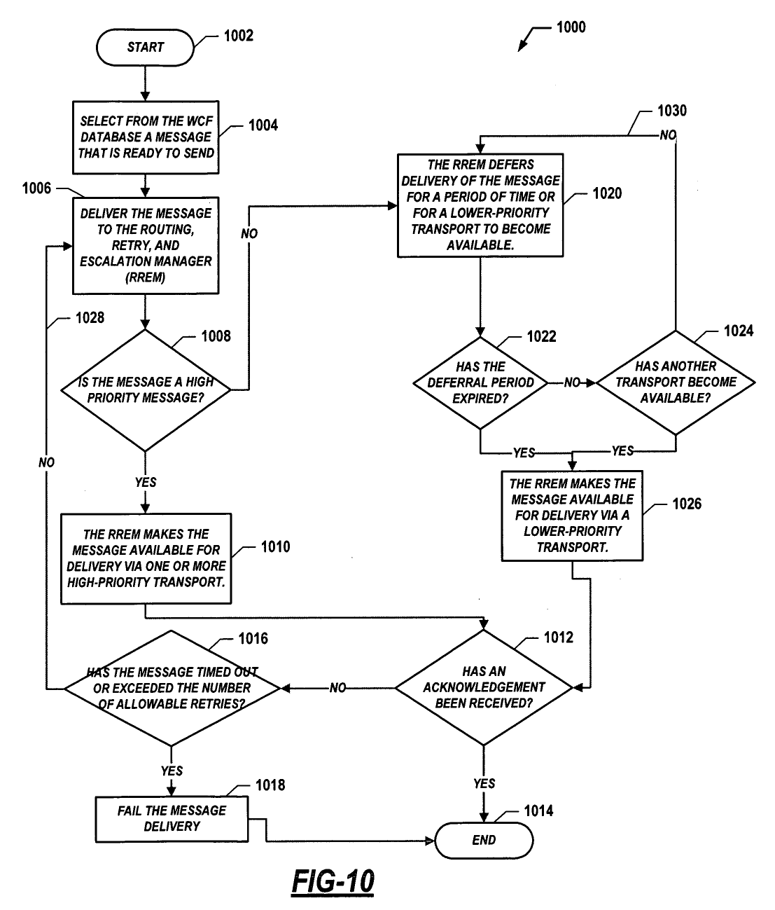

FIG. 10 illustrates a message flow 1000 using a routing, retry, and escalation manager, such as the RREM 912. The message flow begins at block 1002. At block 1004, the WCF 900 may select from the WCF database 904 an outbound message that is ready to be sent. The outbound message may be selected based on message status and priority.

The outbound message may then be handed to the RREM 912, as shown in block 1006. At block 1008, a test is performed to determine if the outbound message is set to a high priority level. If the outbound message is set to a high priority level, then the process proceeds to block 1010. In block 1010, the RREM 912 may make the outbound message available for sending by sending the message directly to one or more of the transports, thereby allowing the outbound message to be sent over multiple transports. When throttling and packaging are needed, the RREM 912 may place the outbound message on the transport queue 904e rather than sending it directly to the transport.

At block 1012, a test is preformed to determine if an Ack has been received by the sending side of the WCF 900. If an Ack has been received the process continues to block 1014 where the process of message delivery via the RREM 912 is completed. If, however, an Ack has not been received at block 1012, the process continues to block 1016. At block 1016, a test is performed to determine of the outbound message has timed out or exceeded the number or allowable retries. The RREM 912 may reset this number of retries when changing strategies, in which case the number of retries may be based on a current strategy.

If the outbound message has timed out or exceeded the number of allowable retries, the process continues to the block 1018. At block 1018, the outbound message delivery is failed. Thereafter, the process continues to block 1014 where the process of message delivery via the RREM 912 is faulted for failing to deliver the outbound message.

When the outbound message is not set to a high priority level, the RREM 912 may defer the delivery of the outbound message until some later time, as shown in block 1020. Deferral may be used to (i) hold the outbound message for a later time, (ii) hold the outbound message of a certain priority until off-peak rates are in effect, and/or (iii) hold the outbound message for a while to see if a free or cheap transport becomes available, when a multi-transport system is used. Such uses for deferral suggest that in some cases an external trigger (such as another transport becoming available) might be used to cause the WCF 900 to reroute an outbound message through the RREM 912. Thus, at block 1022 a test is performed to determine if the deferral period has expired.

If the deferral period has not expired, the process continues to block 1024. At block 1024, a test is performed to determine if another, lower priority transport become available. If the lower-priority transport becomes available, the process continues to block 1026, where the RREM 912 makes the outbound message available for delivery via the lower-priority transport. After the outbound message is sent, a test is performed to determine if an Ack has been received as shown in block 1012. The process then continues as described above.

If, on the other hand, the deferral period has expired, the process continues to block 1026, where the RREM 912 makes the outbound message available for delivery via the lower-priority transport. Thereafter, the process continues as described above.

When sending or deferring the outbound message, the message and transport window information may be kept persistent so as to assist in the next delivery to the RREM 912. This may include carrying out a next-time-to-escalate function, an escalation strategy function, a message priority strategy function, and/or a number-of-attempts-made-to-send-the-message function.

The next-time-to-escalate function may encompass waiting a predetermined amount of time, after which the outbound message becomes eligible to be sent back to the RREM 912 for a retry or escalation as shown by return paths 1028, 1030. This value may be based upon the timeout value returned by the transport interface 906, 908 when the outbound message is sent. The RREM 912, however, may modify this value. For example, the RREM 912 may multiply the timeout value by increasing factors on successive retries. Thus, a timeout value 5 minutes supplied by the transport interface may be successively increased by the RREM 912 to provide gradually increasing timeouts in cadence with the number of retries increases. In a single transport system, next time to escalate may be the same as the time at which a retry should occur.

The escalation strategy function may encompass the RREM 912 storing state data for a current escalation scheme in the form of, for example, a 32 bit signed number. This number may be used by the RREM 912 to indicate where to begin the next step of the escalation scheme. In one embodiment, the message priority may determine the initial escalation strategy. Thereafter, the escalation strategy may determine when and how an outbound message could be sent or escalated to the next transport. The number-of-attempts-made-to-send-the-message function may encompass the RREM 912 sequentially or otherwise incrementing the number of retries (taking into account message deferral).

In one embodiment, the RREM 912 may be application specific, require detailed knowledge of the characteristics of each transport, and modified to accommodate additional transports. Alternatively, the RREM 912 may be predicated upon rules-based engine that reads its rules from configuration data. As such, data and not code may be changed when adding an additional transport for the WCF 900 to communicate over.

Some transport networks, such as a WLAN (IEEE 802.11 or otherwise) and other connection-oriented networks, may be opportunistic in that they might transfer all available outbound messages when they become available and when the on-board and off-board architectures are within the coverage area of such transport networks. The RREM 912 may have the capability to handle WLANs, and in such case, the transport interfaces 906, 908 may notify the RREM 912 when another transport network becomes available. This allows the RREM 912 to form a queue for outbound messages that would be acceptable to transfer. After a connection is established, the RREM 912 can specify that all outbound messages over a certain priority can be immediately transferred.

Alternatively, outbound messages may be available to send on multiple transports at the same time. In such case, the RREM 912 may be responsible for placing messages on and off each available-to-send queue of the transport interfaces 906, 908. And successfully sending an outbound message on a transport network might require notification to the RREM 912 so that it may remove the outbound message from other transports, if desired.

In some case, an exemplary transport might not be immediately available, in which case escalation may be invoked if the transport network did not become available within a specified period of time. An example might be queuing an on-board originated message for transport over a given terrestrial network, but sending this outbound message via satellite if the vehicle did not enter coverage of the terrestrial network within 1 hour.

xv. Application Control

In some cases it may be useful for an application to be able to specify the transport that is to be used for message delivery and to be able to inhibit escalation to another transport. Examples of messages that may specify that they are not to be escalated may include messages used to detect transport address changes; and/or acknowledgement messages where the system designer decides that these should be carried on the same transport as the original message. To facilitate this, the WCF API 902 may append a transport identifier that does not have an escalate flag to these messages. The interpretation of this flag may be implemented and controlled by the RREM 912.

xvi. Packaging

Packing might allow any combination of application and Ack messages to be combined into a single outbound message. Packaging may advantageously reduce cost for networks with a per-message charge, and improve message delivery performance (e.g., provide lower latency) for networks that have a small transport window or require a long transport window delay between messages.

Outbound messages with the different priority level may be combined into a packet, taking into account, however, how message priority might affect how messages are routed by the transport. Outbound messages may be treated by the RREM 912 before and/or after packaging. For example, outbound messages may be treated by the RREM 912 after packaging since the RREM 912 may get a chance to decide how and when outbound messages are to be sent. Treatment of the messages after packaging may avoid the possibility of building a package that is too large to send over the transport.

The RREM 912 may determine transport-specific priority levels, which allows outbound messages to be grouped only if they are to share the same transport-specific priority. This may avoid transport priority complications (e.g., low priority outbound message sent with a high priority or vice-versa).

To enable packaging to take place, a delay may be established between an outbound message being available to send and actually being sent. In the absence of a delay, every outbound message could be sent immediately, thereby leaving no time for later outbound messages to be queued. The delay may operate similar to a TCP Nagle algorithm, allowing small packets to be accumulated until the transport packet is filled or, alternatively, until a predetermined timer expires (e.g., a predetermined time from when the first and/or last message was queued). The actual delay value may be sensitive to the message priority and to the timeout value applied to the outbound messages. Too long of a delay in the case of an Ack message could cause the original message to be un-intentionally re-sent.

In the case of an application message, the timeout (for retry or escalation) may begin when the outbound message is made available to be packaged or when the outbound message is actually sent to the transport. Advantages exist, however, by beginning the timeout when the outbound message is actually sent. The RREM 912 may accommodate specific timeout values for each contained outbound message within a packet. When creating the packet format for packaged outbound messages, it is desirable to allow duplicate fields to be eliminated from contained outbound messages. Thus, a contained outbound message might have additional flags indicating whether to copy a relevant field.

xvii. Multi-Part Messaging

The RREM 912 may be allowed to determine the transport and transport-specific priority of an outbound message that is larger than the transport can handle, and then defer the management of the multi-part message to a multi-part-message manager (not shown). The multi-part-message manager may then be responsible for disassembling the outbound messages into blocks for transmission over one or more of the transports, reassembling the blocks back into the sent outbound messages on the receiving side, for performing part-by-part acknowledgements, and resends.

An acknowledgement window may be used to limit the number of outstanding and unacknowledged message blocks. This window may be used to balance the cost of the number of Ack messages sent (assuming, e.g., an Ack message can acknowledge a number of message parts) and/or the cost of the number of resends. If, for example, the receiving side of the WCF 900 supports a queue of exactly one message for delivery to the receiving side's underlying system when the vehicle is off, a large acknowledgment window on the sending side may cause all but one of the outbound messages to be resent when the vehicle is later turned on.

Blocks may be sent and acknowledged per offset and size or alternatively, by block sequence number for multi-part messaging. Such acknowledgment may be particularly useful when multiple parts of the same outbound message are routed over different transports. In some cases, some of the multiple parts can be transferred and successfully acknowledged before an escalation time occurs. Thereafter, the blocks may be sent and acknowledged per offset and size. Alternatively, the entire outbound message be repartitioned and resent.

An additional database table may be deployed to hold status information for multi-part message transfers. The table might duplicate the message parts or simply refer to them. The table might be different for onboard and off-board architectures. Both disassembly and reassembly may be accommodated.

xviii. Packet Format

The format of an exemplary embodiment of a WCF Packet may be as shown in Table 5. Other embodiments may use different formats that have less or more field than shown in Table 5.

TABLE 5

| Name | Offset | Type | Description |
|---|---|---|---|
| Application ID | 0 | Unsigned | The ID of the application that this |
| | | Integer (1) | message is intended for . . . The |
| | | | applications are defined as follows: |
| | | | 1 = Proof of Delivery |
| | | | 10 = e-Technician |
| Device ID | 1 | Unsigned | The unique identifier of the on |
| | | Integer (4) | board device. This number may |
| | | | map to VIN or other vehicle |
| | | | identification code in a database |
| | | | (outside of this header). |
| Message Type | 5 | Unsigned | The session level message type: |
| | | Integer (1) | 0 = Data (e-Technician OBU |
| | | | Message) |
| | | | 1 = Acknowledge |
| | | | 2 = Init Mobitex |
| Message ID | 6 | Unsigned | An ID number assigned to the |
| | | Integer (2) | message by the communications |
| | | | manager . . . These ID's will be |
| | | | recycled. |
| Priority | 8 | Unsigned | The priority of the message |
| | | Integer (1) | |
| Length | 9 | Unsigned | The length of the application level |
| | | Integer (4) | message to follow |
| Application | 13 | various | Application-level data. |
| Level | | | |
| Message | | | |

The format of the packet format may also include an ordered delivery flag, a non-reliable delivery indicator, a versioning indicator or stamp, a length indicator, one or more multi-part messaging indicators, a cyclical redundancy checking (CRC) indicator, a device ID indicator, a message type indicator, various flags for optional and variable length fields that may require flags to be present in the message to indicate the presence and size of such data, an Application ID for some systems in which a default application may be configured with and not require that the application ID be included in each message, encryption and compression fields ordered delivery flag for indicating non-ordered and/or ordered delivery.

The ordered-delivery flag may become part of the identification of an outbound message. The non-reliable delivery indicator may be used for indicating whether non-reliable delivery is selected. The versioning indicator or stamp may be used for tracking version changes, and allow future versions to be accommodated. In particular, the version indicator for the off-board architecture may be use to handle multiple version of on-board architecture.

The Device table may be used for storing a current version number of WCF 900 so that compatible messages can be sent to between the off-board and on-board architectures. The on-board architecture may send a NAck a message back to the off-board architecture when the two devices have incorrect protocol version numbers. The processing of such a NAck may trigger the off-board architecture to re-packetized outbound messages for transmission to the on-board architecture.

The length indicator may be used for noting the length of the packet. In some cases, a transport packet may be able to hold the length so that the length of the transport packet need not be encoded into the message header of the WCF packet.

The multi-part messaging indicators may be used to accommodate multi-part messages (e.g., indicators for block size, start, offset, etc.) and acknowledgements. The multi-part messaging indicators may also be used to accommodate message packaging.

The CRC indicator may be deployed to track messages that use transports do not guarantee uncorrupted delivery. This may be made the responsibility of the transport, rather than managed directly by the WCF 900. The device ID indicator, which may be variable length field as an alternative to an unsigned integer field, may be used for determining the Device ID from the transport-specific address. This advantageously allows the packet to not carry the device ID. The message type indicator may be used to indicate the message type.

The encryption and compression fields may be used to support and indicate that given encryption and compression algorithms may be used. Additional message types may be used for encryption to support the establishment of session keys. Given that user-replaceable encryption and compression modules are supported by the WCF 900, the header fields and message types may be determined according to the given encryption & compression modules.

xix. Extraction from Application Programs

The off-board architecture of the WCF 900 may be coupled to a mapping function in which a map is created between one of the application programs 406b a message is destined for and a destination application in the WCF 900. One way of carrying out this mapping is to the use of a registry setting of the WCF to map destination application to a CLasS IDentifier (CLSID). A configuration tool may used to configure and map the registry settings. The application programs 406b may also include a target map in their own registry settings to indicate the mapping between the application programs 406b and the destination application in the WCF 900.

xx. Address Detection

The WCF 900 may be able to detect when the on-board architecture has switched to a different transport. This enables the off-board architecture to correctly address off-board-to-on-board messages for any given network. In one embodiment, the WCF 900 may include a send or “Init Network” message to send to the on-board architecture as the first network transport message after connecting with the off-board architecture.

Because detecting an address of the on-board architecture might not be possible for every transport, an extra message may be used for indicating the transport-specific address of onboard architecture. This message may be sent when the transport change is detected or at any other time. Alternatively, the off-board architecture may automatically detect the change of transports on the basis of received messages.

When a change in address occurs, the WCF 900 may send a device-change notification having a new address to the queued transport for which a change was detected. This device-change notification may not be escalated by the RREM 912 to another transport. Further, the WCF 900 may store or persist the device-change notification message for subsequent communications. The off-board architecture may then use the device-change notification messages to update the transport address for the particular onboard architecture using the address noted in the device-change notification message.

Alternatively, the onboard architecture may check the device ID on inbound messages against the device ID assigned to it. If the inbound message is received with the device ID mismatch, then the on-board architecture may reply to the off-board architecture using a NAck. The NAck may include the correct device ID of the on-board architecture. On receipt of such a NAck, the off-board architecture may post an alert message to alert a system administrator. This alert message might not be an error in systems where the architectures are portable.

The off-board architecture may also update the transport entry to associate the transport address (from which the NAck was received) with the new device ID instead of the old device ID. The off-board architecture may check the association of device ID and transport address for each inbound message. On detection of a transport address mismatch, the off-board architecture may update the device/transport address association and post a message to the system administrator.

The address of the off-board architecture may be queried while it is available and/or connected. In some case, the off-board architecture may be unconnected at any time, and in other cases, the on-board architecture may be present most of the time, but may only be available part of the time it is connected, e.g., after a startup period following the ignition of the vehicle. Consequently, the transport modules 906a, 908a may maintain device status information.

The WCF 900 may use this status information as part of the decision of when to request device identification. The status information may include a combination of flags, such as (i) an available/unavailable flag that may indicate which transport device is connected/disconnected or otherwise unreachable; (ii) an In/Out of coverage flag that indicates when the transport device is in or out of network coverage; (iii) a Can/Cannot Send flag that indicates when the transport device can/cannot accept outbound messages.

xxi. Data Collection

Data collection may be carried out for billing, tuning timeout and escalation logic for the RREM 912, addressing communication reliability questions, and others matters. Billing data may be collected on the basis of WCF messages sent and received, and on which transports were used to carry the messages. Data collection may occur on the off-board architecture of the WCF 900, where statistical analysis of the data collection may be performed. The statistical application may be inserted at the interface to the transport modules 906a, 908a.

xxii. Message Cancellation

The application programs 406a, 406b may have the ability to repeal or cancel an outbound message and/or at least attempt to do so. When carrying out ordered delivery, a canceled message might not be completely dropped because of a hole created in the delivery sequence, which may hold up the queue indefinitely. In this case, a system message having no content may be used in lieu of message cancellation. Such a message could be directed to a different application ID than originally specified. Given that the system message does not have any content in its payload, the system message may be small, thereby making it eligible for packaging with other messages over the same transport.

With reliable delivery, it is desirable to retain knowledge of which outbound messages have been received and delivered for the purposes of duplicate detection. The storage of received and delivered outbound messages can be optimized by removing contiguous message sequences and remembering which outbound messages around and from the first discontinuity. Like ordered delivery messages, a system message having no content in its payload may be used as a placeholder for the missing sequence number. This system message may be sent and acknowledged even if it is not delivered to the application programs 406b. This approach can is useful because it may (i) reduce the size of messages sent, even if it does not drop the message(s) entirely, and/or (ii) repeal the (application-level) action that would otherwise be taken at the receiving end on receipt of the message.

Another alternative may be to establish a cancellation window, e.g., 16 messages of reliable delivery outbound messages, and require that the sending side of the WCF 900 not send outbound message N+16 until outbound message N has either been acknowledged or canceled. In this case, the receiving side of the WCF 900 may check for duplicate outbound messages within a small window, and thus, may ignore the in between outbound messages once the outbound message N+16 has been received.

In an unreliable delivery situation, duplicate detection may not be performed, in which case an outbound message may be duplicated in transit. Such messages may be canceled by simply dropping them.

Cancellation may also apply to when outbound messages fail to reach their destination, e.g., when the RREM 912 or other parts of the WCF 900 determine that a message is undeliverable. The RREM 912 may, for instance, decide that the outbound message is not worth sending after a number of retries and/or an elapsed period of time. Responsively, the administrator should be alerted and the outbound messages destined for the receiving side may be put on hold or purged until the receiving device can be diagnosed and repaired or replaced. Cancellation my also be used when no Ack or other message from the receiving side has been received by the sending side for some period of time or when a transport error occurs indicating that the receiving side's transport-specific address was not valid (or some other account failure). In such case, the messages for the receiving side may be put on hold and/or purged, and the administrator may be alerted to resolve the issue.

xxiii. Broadcast

The WCF 900 may support broadcast messaging if supported by the transport provider. Since the sequence numbers used for Ack and message identification may be different for each outbound message, one or more approaches for transport-level broadcasting could be used. In one exemplary embodiment, another sequence number pool for transmission of broadcast messages may be provided. With reference to the architecture, additional logic in the RREM 912, transport queue 904e, and transport-send agents 906a, 908a may allow the RREM 912 to assign a broadcast message to different transports for different destinations and track the acknowledgement, timeout, and escalation.

xxiv. Compression

Compression may be provided in the WCF 900. When an outbound message is accepted for sending by the WCF API 902 and compression is requested, the outbound message payload may be compressed. A flag may be set to indicate that the message payload is compressed. The outbound message may be decompressed after delivery. Such compression strategy may benefit large and multi-part messages. The compressed form of each message may be self-contained, i.e., no other information than the received compressed message will be required (other than the compression engine itself) to decompress the outbound message.

xxv. Encryption

Encryption may be provided in the WCF 900. Encryption may occur during message queuing and, if enabled, after compression, so as to avoid attempting to compress encrypted data. Decryption may occur during delivery. Unlike compression, encryption may require some end-to-end messaging to establish state data used for encrypting the messages. Public/private key encryption may be used to establish and communicate a ‘session key’ that is subsequently used to encrypt the content of outbound messages.

The end-to-end messaging used to establish and maintain encryption keys may be handled by assigning a specific application ID for an encryption agent, and allowing normal messaging to occur. A flag may be used to indicating that the outbound message was encrypted, and that the encrypted outbound message content might contain additional data (e.g., a session ID) to assist a decryption agent in decrypting the received message. Additional database tables or other security mechanisms may be required to maintain the keys for encryption.

xxvi. Message Identification

Each message in the WCF 900 may be uniquely identified by a direction parameter, a device ID parameter, a message priority parameter, a message type parameter, a message service parameter, and a sequence number. More or fewer parameters may be used in each message.

In one exemplary embodiment, the message parameters other than Device ID may be combined into a 32-bit integer for identifying and providing a simple key for the WCF database 904. Table 6 illustrates a break down of the message parameters in such a 32-bit integer

TABLE 6

| Position | Field | Description |
|---|---|---|
| Byte 0 Bit 7 | Direction | 0 - Server-to-Mobile |
| | | 1 - Mobile-to-Server |
| Byte 0 Bits 3-6 | Unused | Reserved, Must be 0 |
| Byte 0 Bit 2 | Unused | Reserved, Must be 0 |
| | | Can be growth for |
| | | Message Type field. |
| Byte 0 Bits 0-1 | Message Type | 0 - App. Message |
| | | 1 - Ack Message |
| | | 2 - NAck Message |
| | | 3 - Reserved |
| Byte 1 Bit 7 | Unused | Reserved, Must be 0 |
| | | Can be growth for |
| | | Message Service field. |
| Byte 1 Bits 5-6 | Message Service | 0 - Unreliable Delivery |
| | | 1 - Reliable Delivery |
| | | 2 - Ordered Delivery |
| | | 3 - Reserved |
| Byte 1 Bits 0-4 | Message Priority | 0-31 |
| Bytes 2-3 | Sequence Number | LSB first (Little Endian) |

The values shown in Table 6 may be used as keys or message tags for tracking messages. For example, the format of Byte 1 could be used as a key for tracking the sequence number pool for the sending side of the WCF 900. It can also be used in the client API to provide a message handle, if needed.

xxvii. System Messages

Several elements of the WCF 900 make use of system messages. In one embodiment, the Application ID having a zero value may be reserved for system messages, rather than creating and reserving additional message types for system messages. Like outbound messages, the system messages can benefit from the services, e.g., escalation, provided by the WCF 900.

One or more system messages may be used to resolve versioning issues in the WCF 900. These system messages may indicate that the correct WCF version is available. The correct version number can be included in the system message payload.

One or more system messages may be used to resolve transport address issues. These messages may indicate that the transport and transport address are available. When the system message is received and placed in the InBox 904a, the transport ID and source transport address may be saved with the message. An invalid application ID, such as 255, may be deployed to detect an application errors, e.g., failing to specify a destination application.

xxviii. Triggered Delivery

The WCF 900 may provide a batch delivery process for delivery of multiple messages. To facilitate the batch processing, the WCF 900 may use the ordered delivery service to avoid out-of-order delivery of the messages in the delivery batch. Further, the sending side of the WCF 900 may not send or trigger a connection for connection-oriented transports for the messages of the delivery batch, but rather maintain the outbound messages of the delivery batch in, for example, the transport queue 904e, until (i) a given time expires (e.g., an hour vs. a few seconds or minutes), (ii) the outbound messages are picked up by another triggering message (e.g., an unrelated outbound message), and/or (iii) a stop message is queued.

Batch processing may be carried out using a Message-Priority-and-Ordered-Delivery Queue (not shown) into which outbound messages having a low priority level are placed along a stop message having high priority level. Using a queue promotion function, the WCF 900 promotes each outbound message having a lower priority level to a higher priority level ahead of the stop message. Additional packet space may be used for the Message-Priority-and-Ordered-Delivery Queue identification for all ordered delivery messages. Further, low priority level outbound messages may be escalated to expensive transport networks.

An additional message property may be provided to indicate to the RREM 912 that the messages are to be batched processed. The additional message property may be used to adjust the trigger time of the outbound messages placed in the transport queue 904e. This indication may include, for example, (i) a Priority Hint Low indication that causes the RREM 912 to use a longer trigger time on a given outbound message; (ii) a Priority Hint Normal indication that causes the RREM 912 to use the normal trigger time on the given outbound message; (iii) a Priority Hint High indication that causes the RREM 912 to use a shorter trigger time on the given outbound message; and/or (iv) a Priority Hint Immediate indication that causes the RREM 912 to use a zero trigger time on the given outbound message.

The transport-send agents 906b, 908b may initiate messaging when a trigger time is reached for queued outbound messages. A short or zero trigger time can trigger messaging to ensure that the earlier messages are delivered. Within a message priority level, the transport-send agents 906b, 908b may consider outbound messages from the oldest to the newest. Out of order sending, however, may occur if the outbound messages were selected for packaging. This means that the later outbound message (with a higher priority hint) might be sent leaving no earlier outbound message whose trigger time has passed.

An alternative queue promotion function may be used to promote an ordered delivery service for outbound message having a lower priority hint to the priority level of a new outbound message queued in the OutBox 904b. In this type queue promotion, the RREM 912 may adjust the trigger time on such messages.

xxix. Synchronous Delivery Messages

In a synchronous operation connection, the WCF 900 may receive an outbound message from a thread of the transport interfaces 906, 908, deliver the outbound message to a destination application, and have the application send reply message that can be picked up and returned to the application programs 406a, 406b within the synchronous operation. This may be facilitated by delivering every outbound message synchronously including those for which synchronous delivery was not needed. Synchronous delivery may be useful for both off-board and on-board architectures.

Synchronous delivery may directly couple a delivery thread of the transport modules 906a, 908a to receive logic of the application programs 406a, 406b. If, for example, delivery to the application program 406a blocks the delivery thread, connections for the off-board architecture may be prevented from handling messages. In such case, a thread pool may be used by a connection-oriented transport module to deliver the outbound messages to the WCF 900.

If an outbound message being delivered synchronously has a number of ordered delivery messages queued before it, or takes a significant time to process, the message processing might hold the connection open too long, which may result in a timeout and increase communications costs. The synchronous delivery may be performed by a separate thread or thread pool, which may allow the delivery thread of the transport interfaces 906, 908 to time out if the messages cannot be processed in a reasonable time.

To carry out synchronous delivery, the sending application programs 406a, 406b may specify synchronous delivery for certain inbound messages using, for example, a flag in the WCF packet. The connection-oriented transport 908 may automatically or when specified with the flag perform synchronous delivery of the received messages. To facilitate this, the connection-oriented transport 908 may have additional logic that causes the connection to be held open for a period after message delivery so as to allow for return of outbound messages to be detected. The connection-oriented transport 908 may signal the message manager 910 or delivery agent 902d to invoke synchronous delivery.

xxx. Off-board Application Identification Mapping

Push delivery on the off-board architecture may have to contend with the application program 406a on the off-board architecture being unavailable. Management of this can be handled in several ways. First, queued components may be used to queue WCF messages to the application program 406a. Second, the application program 406a may have a specific API for enabling and disabling WCF message delivery. Third, the application program 406a may use an error return code to disable message delivery until invoked.

In addition, mapping application IDs to destination components may be carried out. The map information may be put into a registry. The poll for deliverable WCF messages on a particular node may have to skip, in the list of application IDs, the WCF messages that may be delivered on that node. While possible, this query may be somewhat inefficient because it may have to construct and execute the select statement on the fly. Alternatively, the map may be stored in a database table that includes an enable/disable flag associated with the name of the node (which could then be passed in as a parameter by a calling delivery agent). Using a component interface to manage the mapping may assist in abstracting the WCF database information. If the application program 406a requests to receive messages on multiple nodes, it may receive the messages via an intermediate component, which in turn directs each message individually to an appropriate node.

xxxi. On-Board Time Object

The on-board architecture of the WCF mobile may use a time object to handle date and/or time values. These date and time values might not be exchanged between off-board and on-board architectures as part of WCF messages, but may be persisted on respective portions of the WCF 900 along the message information. The date and time values may be used to determine when a message should time out and/or escalate, even if the on-board architecture is not available when the messages are first sent.

The WCF 900 may assume that the architecture will persist date and time correctly over restarts and periods of unavailability. The WCF 900 may run on a system that has a battery backed clock or other source of date and/or time. If on-board architecture of the WCF 900 becomes available and notes that message trigger/timeout/escalation date times are far in the future, messaging may be halted. A safety check may be deployed to at least reset date times to the present. When time loss occurs, messaging may continue to function, but may not perform optimally.

xxxii. Message Logging

In the off-board architecture of the WCF 900, tracking the progress of messages through the WCF without having to enable the high levels of diagnostic and debug logging may be useful. This can be especially useful for troubleshooting. Separate logs may be kept for significant message events, and billing reconciliation and statistics collection. This may be carried out using direct machine interpretation of the logs, capturing the same information into tables, and/or other interpretation schemas.

Logs may include a success/failure indicator of the attempt. Transaction handling may be accounted for in the success/failure indicator because it is possible for an inner function to succeed while the outer transaction to fail. Logging may capture inner results, but not outer transaction results. This could be mitigated by allowing the event log data to be gathered inside the transaction but propagated out and reported outside the transaction.

Logging of messages queued (e.g., through the send API 902a or internally) and delivered to the system log 916 may capture (i) events (e.g., queued, delivered); (ii) message types (e.g., App, Ack); (iii) the Device IDs and Message Tags that identify the messages, (iv) Message Tags of Ack'd messages; (v) Date/Time stamps; (vi) Payload sizes; (vii) Application IDs; (viii) Priorities; (ix) message services, and the like.

Logging of packets sent or received on the transport interface 906, 908 may capture (i) events (e.g., sent, received); (ii) transport IDs; (iii) date/rime stamps; (iv) packet sizes; (v) to/from addresses; (vi) Device IDs, if known; (vii) transport-specific packet IDs, and the like. Logging of content contained WCF messages sent or received on the transport interfaces 906, 908 may capture (i) events (e.g., sent, received); (ii) date/time stamps; (iii) transport IDs; (iv) packet IDs; (v) Device IDs and message tags; (vi) message types; (vii) payload sizes, and the like. The payload sizes may be a proportion of packet size attributed to the message.

Logging of transport message notifications may capture (i) notification types (e.g., failure, status); (ii) date/time stamps; (iii) transport IDs; (iv) transport-specific status codes; (v) to/from addresses; (vii) packet ID, and the like. Logging of message events may capture (i) event types (e.g., queued, escalated, etc.); (ii) date/time stamps, (iii) Device IDs and Message Tags; (iv) source transport IDs; (v) source transport status codes, if applicable; (vi) message statuses (e.g., before/after), including any escalation date/time, escalation strategy and retry count; (vii) transport statuses with each transport (before/after), including the sent date/time, process date/time, transport priority, and ignore window flag; and the like.

Logging of message renumbering may capture (i) date/time stamps; (ii) Device IDs; (iii) did tags, (iv) new tag; and the like. Message numbering may take place inside the system log 916 or WCF database 904. An additional table may be used to store renumbering events and to allow extraction to the system log 916.

Errors may be matched against log entries so that failed operations can be identified. The events noted above can be logged from different processes given that the off-board architecture may be distributed. Logging management may include (i) allowing a log per process; (ii) forcing all logs into a common process to avoid logging events in transactions that may ultimately fail; and/or (iii) collecting logs in the database.

xxxiii. Extended Device Transport Status For a given terrestrial transports, certain terrestrial NAck codes may translate to an error, which states “this device is unreachable, don't attempt to send anything to it until either 35 minutes elapses, or you receive a message from the device.” The handling of this condition might not be carried out through the transport window abstraction. Instead, the transport status may be updated. The update may be, for example, “disable until now+35 minutes or unless told to re-enable.”

For WLAN transports, such as 802.11, where a device comes into coverage but may leave without providing notification, the on-board architecture may be configured to send periodic notifications while in a coverage area of the WLAN. Out of coverage may then be determined by some threshold of elapsed time after the last such notification. The transport status update might be, for example, “enable until now+threshold.” This kind of notification might be handled through WCF system messages or lower level transport messages that are invisible to WCF 900, but result in device status notifications from the transport interfaces 906, 908. For example, an off-board message-storage manager 904f may have API functions to enable and/or disable message transport (e.g., by transport/address or device ID) until some time in the future. Alternatively, a device status API in the transport modules 906a, 908a may be deployed as well.

Translation of a NAck code for a specific message into a device transport status update may be performed through the RREM 912 or added as a transport strategy item in the transport strategy modules 906c, 908c. Notifications related to received messages and potential device status notifications might not pass through the RREM 912. Handling of these messages may be carried out by the transport strategy modules 906c, 908c, using an additional API that responds to events such as (i) OnMessageStatus; (ii) OnMessageFailure; (iii) OnDeviceStatus; (iv) OnMessageReceived events.

4 Exemplary Examples of Operation

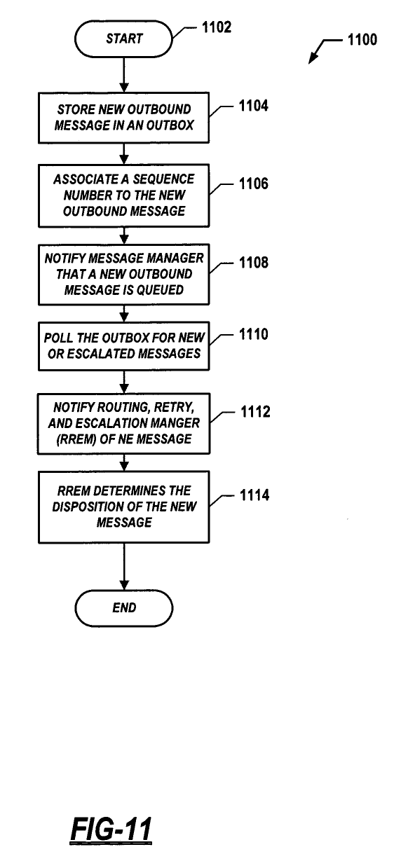

Examples of operation of function carried out by the WCF 900 are described below in FIGS. 11-16 with reference to the WCF architecture shown in FIG. 9 and the data and processing objects described above.

(a) Queue an Outbound Message

FIG. 11 is a flow diagram illustrating a flow 1100 for queuing an outbound message. The outbound message may be a client message received from WCF client application, such as application program 406a, and which may be sent using the WCF Send API 902. Alternatively, the outbound message may be an Ack received from the message manger 914 in response to a received message. At block 1102, the flow 1100 starts. Thereafter, the message-storage manager 904f stores the outbound message in the OutBox 904a, as shown in block 1104. If the outbound message is a client message, a sequence number is assigned to the outbound message, as shown in block 1106. For the Ack, the message identification may be derived from the original message, which is also shown in block 1106. If the client message is queued into a sequence number pool with no prior knowledge of sent sequence numbers, a sequence number recovery process may be carried out as described above.

At block 1108, the message manager 914 may be notified that a new message has been queued in the OutBox 904b. Alternatively, the message manager 914 may periodically poll the message storage manager 904f for new and escalated messages, as shown in block 1110. Outbound messages may be processed in first by message priority level (highest to lowest); and then message age (oldest to newest). In block 1112, the message manager 913 may notify the RREM 912 of the new message.

In block 1114, the RREM 912 may determine the disposition of the outbound message. This may include queuing the message in the transport queue 904c, specifying a message escalation time, and/or other tasks. The RREM 912 may use the device-transport-storage manager 904g to determine the transport networks available for the on-board architecture. For each available transport network, the RREM 912 may assign a transport-specific-priority level, a part identifier of 0, and a transport queue status of queued. The RREM may determine a packaging delay and compute a time at which the outgoing message will trigger a send on a connectionless transport, if so available.

This may be the mechanism by which packaging will be achieved. When the trigger time is reached for any outbound message, the transport-send agents 906b, 908b may gather all queued messages for that on-board architecture (whether or not the trigger time has been reached) and attempt to group small outbound messages into transport packets. If no other messages have been queued, just the triggering of the outbound message can be sent by itself. If the outbound message is queued with any transport and/or assigned an escalation time, its status may be updated to pending in the OutBox 904b.

For a message destined to a device with only one transport, the RREM 912 might not specify an escalation time. The RREM may store along with the outbound message an Escalation Strategy. This may be opaque state data that the RREM 912 may later use to assist in determining the action to take.

(b) Send Queued Messages

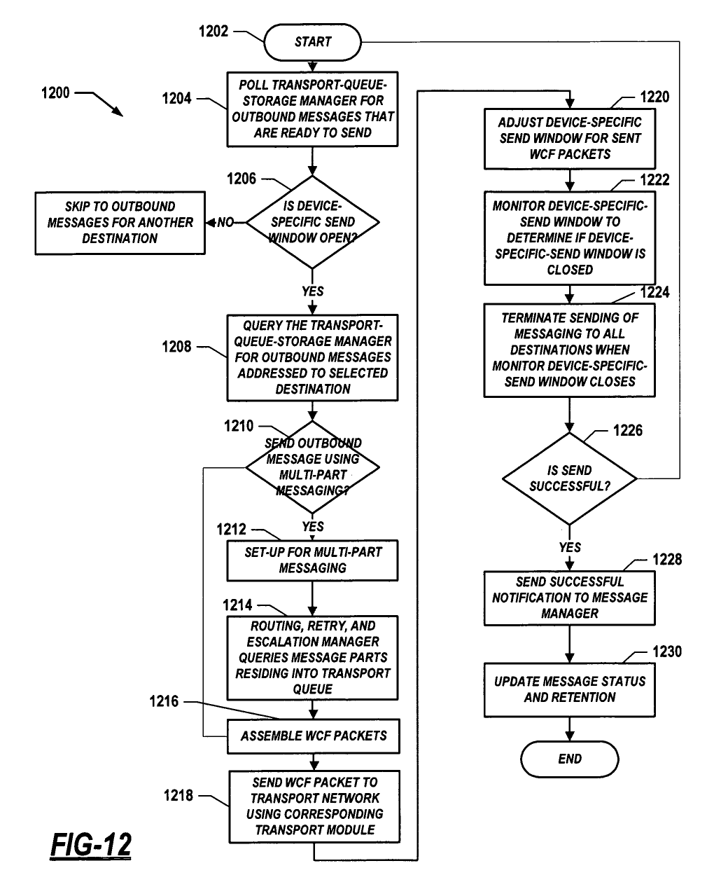

FIG. 12 is a flow diagram illustrating a flow 1200 for sending, via a connectionless transport network, an outbound message from a transport queue, such as the transport queue 904e, from an off-board architecture to an on-board architecture. At block 1202, the flow 1200 begins. At block 1204, the transport-send agent 906b of the off-board architecture may periodically poll its transport-queue-storage manager 904h for one or more queued outbound messages that are ready to be sent. This may include queued outbound messages whose trigger time has arrived, and for which either the transport window for the on-board architecture is open or the outbound message is allowed to override this transport window.

At block 1206, the transport-send agent 906b may check the device-specific send window for its transport interface manager 906d. If the send window is closed, the device may be skipped; otherwise the process moves to block 1208. In block 1208, the transport send agent may query the transport-queue-storage manager 904h for outbound messages addressed to the on-board architecture. Messages may be ordered by first, whether trigger time has expired (in order of expired then not expired); second, message priority (highest to lowest), third, transport priority (highest to lowest); fourth, outbound messages that ignore the window; fifth, message type (Ack messages before application messages); and sixth, message age (oldest to newest).

If the outbound message is not already a multi-part message, the transport-send agent 906b decides whether or not to send the outbound as a multi-part message based on the chosen transport networks Multi-Part threshold size and the WCF version of the on-board architecture, for example. If the outbound message exceeds this threshold and the on-board architecture supports multi-part messaging, the outbound message and WCF is prepared multi-part messaging, as shown in block 1212. This may include setting to true a Multi-Part flag for the outbound message in the OutBox 904b. Additionally, a Sub-Block size and number of sub-blocks may be determined based on the outbound message size. The status of the OutBox 904b may be changed from pending to Multi-Part pending.

At block 1214, the RREM 912 may queue the message parts into a portion of the transport queue 904e for the selected transport network. The entire outbound message may be escalated before any part can be placed into a different portion of the transport queue 904e. Because the RREM 912 may have already queued the outbound message in more than one portion of the transport queue 904e before the determination to send the message in multiple parts was made, the transport Multi-Part Helper 920 may remove the message from the other portion of the transport queue 904e when the outbound message is updated to Multi-Part Pending.

The transport-send agent 906b may assemble WCF Packets containing one or more outbound messages to be sent. In an exemplary embodiment, output messages with the same transport priority may be packaged. The packaging algorithm may attempt to ensure that outbound messages with higher message priority are sent before messages of lower message priority. The packaging algorithm may, however, group messages of lower message priority in packets with messages of higher message priority, as needed to fill a WCF packet to best utilize the transport packet size.

To pack multi-part messages into a packet, the transport-send agent 906b may query a composer for the remaining content size available in the packet by passing to it the multi-part message. The transport-send agent 906b may then ask the transport Multi-Part Helper 920 to provide a block of the message to be packaged using this available content size. The Transport Multi-Part Helper 920 may use parameters from the OutBox along with the pending messages in the transport queue 904e to determine what block of the output message to send. The Transport Multi-Part Helper 920 might not return a message block if the available content size is too small, or all parts for this message have already been sent. The latter may indicate an error condition, as the multi-part message may have had its message status changed to pending on the transport queue 904e.

The transport multi-part helper 920 may add (if not present) or update (if this is a resend of a part previously NAck'd) the transport queue status information indicating which block is being packaged in the outgoing packet. The status for the block taken part may be set to queued. The transport multi-part helper 920 may update the Ack Sequence number for the outbound message if the message part requires an acknowledgement with status. The determination of whether or not to request an Ack with the current message part may be based on requirements for the transport network.

If the message is an Ack to a multi-part message, the transport-send agent 906b may ask the transport multi-part helper 920 to create an appropriate Ack message content. The transport multi-part helper 920 may inspect the Ack flags to determine if the Ack requires the current status of the received outbound message or part thereof. Based on the Inbox message records, the outbound message contents may be created and returned to the transport-send agent 906b for inclusion into the outgoing packet.

If after a WCF Packet has been sent an outbound message having the highest priority level remains to be sent is lower in priority than another outbound message for another on-board architecture, packet processing may terminate for the current on-board architecture. This may prevent outbound messages having a lower priority level from being sent to one of the on-board architectures before outbound message having a higher priority level are queued for another on-board architecture. Additionally, packet processing may terminate for the current on-board architecture if a trigger time has not expired for the next remaining packet.

At block 1218, the transport-send agent 906b may send the any assembled packet to the transport network using its corresponding transport module 906a. If the transport module 906a cannot send immediately (e.g., a network round trip may be required to confirm that the packet was accepted by the network), it may send a success notification, and then provide a failure notification of message delivery failure if the outbound message subsequently cannot be accepted by the selected transport network.

At block 1220, the transport-send agent 906b may decrement the device-specific send window. When the window limit is reached, sending terminates to the current on-board architecture. The send window may be measured by packets sent. The transport-send agent 906b may monitor the transport-specific send window to determine when the window limit is reached, as shown in block 1222. When the window limit is reached, sending terminates to all on-board architectures. The send window may be measured by packets sent.

On successful Send, the transport-send agent 906b may notify the message manager 914 of each outbound message sent. For outbound messages that do not require an Ack or for outbound messages specified for unreliable delivery, the message manager 914 may (i) update the outbound message status in the OutBox to sent; (ii) update the outbound message status in the transport queue 904e to sent, no Ack expected, thereby setting the window timeout value; (ii) remove the outbound message from all other portions of the transport queue 904e; and/or (iv) remove any escalation time from the outbound message. These actions may be filtered through the RREM 912, which may modify the default actions.

For messages that do require an Ack (reliable or ordered delivery), the message manager 914 may notify the RREM 912 that the outbound message was sent and over which transport network it was sent. In carrying this out, the RREM 912 may (i) determine the timeout value that is stored back to the transport queue 904e; (ii) drop the message from other portions of the transport queues 904e; (iii) change the outbound message escalation time; (iv) update the message status to pending in the transport queue 904e; and (v) record in the transport queue 904e the time at which the outbound message was sent.

For Multi-Part message parts that do not require an Ack or messages sent as “Don't Ack this part”, the message manager 914 may (i) notify the RREM 912 that the message part was sent and over which transport network it was sent. The RREM 912 may update the message part status to pending, not in window in the transport queue. For Multi-Part message parts that do require an Ack (messages sent as “Ack just this part” or “Ack this part with current status”), the message manager may (i) notify the RREM 912 that the message part was sent and over which transport network it was sent. In carrying this out, the RREM 912 may (i) determine the timeout value that is stored back to the transport queue 904e; (ii) change the outbound message escalation time; (iii) Update the message part status to pending in the transport queue; (iv) change the status of the “main” multi-part message in the transport queue 904e to pending, not in window, if, for example, this is the last message part; and (v) record in the transport queue 904e the time at which the message part was sent.

(c) Packet Received

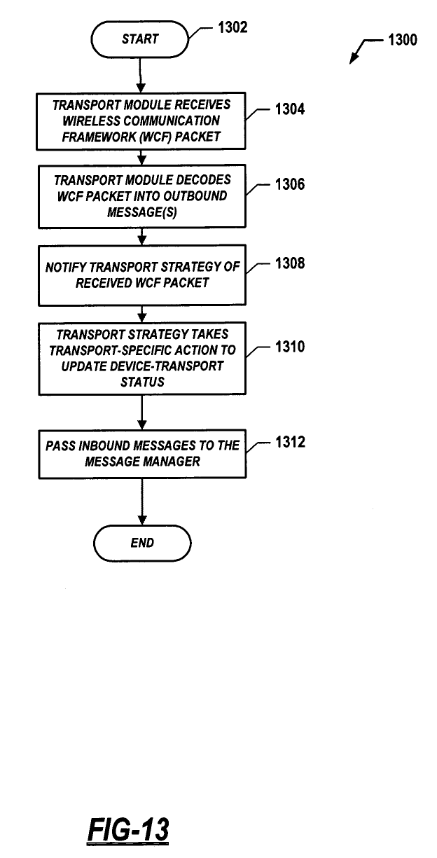

FIG. 13 is a flow diagram illustrating a flow 1300 for receiving a WCF packet at a transport module of a connectionless transport one an onboard architecture. At block 1302, the flow 1300 begins. At block 1302, the transport module 906a receives a WCF packet. The transport module 906a decodes the WCF packet into one or more outbound messages, at block 1306. The Device ID may be determined from the decoded outbound messages.

At block 1308, the transport strategy 906c may be notified that a packet was received. At block 1310, the transport strategy 906c may take transport-specific action, such as updating the device-transport status. Each decoded outbound message may be passed to the message manager 914.

(d) Acknowledgement Received

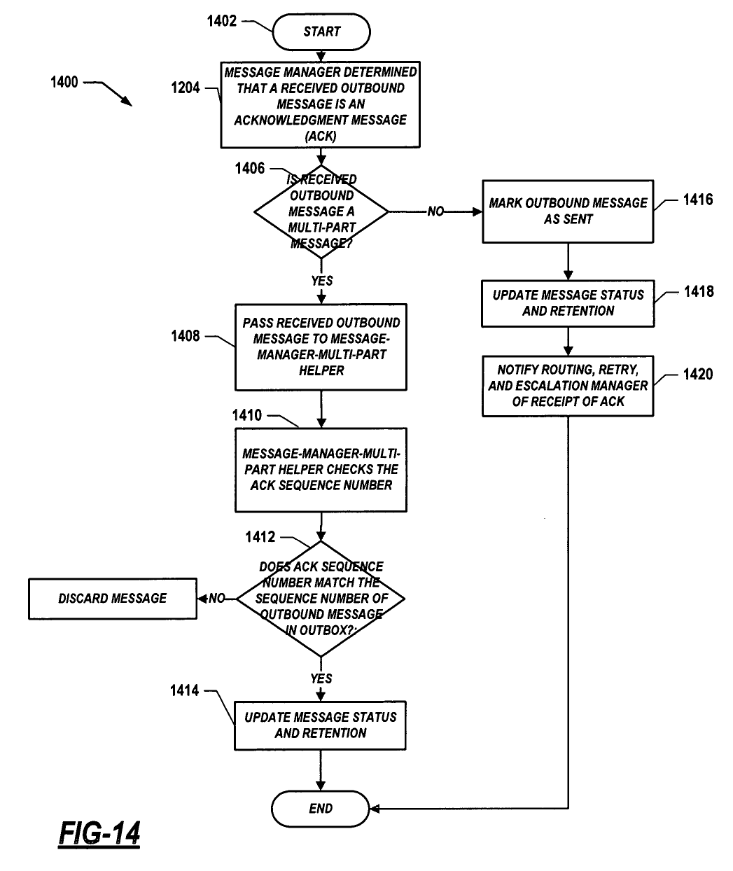

FIG. 14 is a flow diagram illustrating a flow 1400 for receiving an acknowledgement message for an outbound message that was previously sent. After the transport module 906a passes a received outbound message to the message manager 914, the flow 1400 begins at block 1402. At block 1404, the message manager 914 determines that the message is an Ack.

A test is performed at block 1406 to determine if the Ack corresponds to a Multi-Part message. If so, the message manager 914 may pass the Ack to the message-manager-multi-part helper 920 at block 1408. At block 1410, the message-manager-multi-part helper 920 may check the Ack Sequence number if the Ack is an ‘Ack part with status’. If the Ack Sequence number does not match the number in the OutBox Message, the message may be discarded, as shown in block 1412.

The message-manager-multi-part helper 920 may access the transport-queue-storage manager 904h to set the status of the outbound messages in the transport queue 904e for the message part(s) to sent or sent, but not received, as shown in block 1414 The message-manager-multi-part helper 920 may access the message-storage manager 904f to update the parameters of the outbound message, as also shown in block 1414. If the ‘last part’ flag was set and there are no outstanding message blocks, then the outbound message status may be updated to sent by the message-manager-multi-part helper 920.

Referring back to block 1406, if the received outbound message is not a multi-part message, then the outbound message in the OutBox may be marked as sent, and any escalation time may be dropped, as shown in block 1416. In the case that the sequence number pool is in recovery, the received Ack may be checked against the sequence key and, if matched, the in recovery status may be terminated.

In block 1418, the outbound message status in the transport queue 904e may also be marked as sent, and possibly deleted from the transport queue 904e. If the outbound message had a pending status in the portion of the transport queue 904 for the transport on which the Ack was received, the RREM 912 may be notified of the receipt of the Ack and the time at which the message was sent, as shown in block 1420. The RREM 912 may use this information to tune timeout values. It should be noted that if the message was escalated or retried, the time difference between sending the outbound message and receiving the Ack might not represent the round trip transport time. The RREM 912 may take into account retry and escalation status if using this information.

(e) Application Message Received

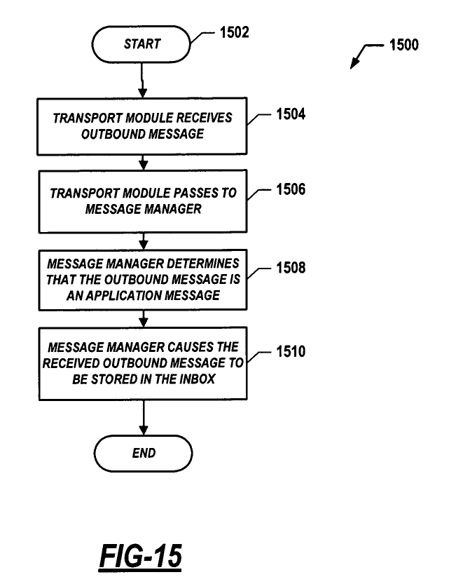

FIG. 15 is a flow diagram illustrating a flow 1500 for receiving an application message at a transport module of a connectionless transport one an on-board architecture. At block 1502, the flow 1500 begins. At block 1502, the transport module 906a receives an outbound message. The transport module 906a passed the received outbound message to the message manager 914 at block 1506. At block 1508, the message manager 914 determines that the received outbound message is an application message. The message manager 914 may use the message-storage manager 904f to store the received outbound message in the InBox 904a, as shown in block 1510. If the received outbound message is flagged with sequence number recovery information, this message may be received-sequence renumbered. The received-sequence renumbering may be carried out within the specified sequence number pool. The acknowledgement message may also contain the sequence recovery acknowledgement. If the received outbound message is a duplicate of an outbound message already in the InBox 904a, the received outbound message may be discarded.

The message manager 914 may queue an Ack as illustrated in FIG. 11 and noted above. The acknowledgement may be queued after the received outbound message is safely stored. This may be carried out to avoid a situation in which an Ack is sent, but the received outbound message is lost. If the message was stored or determined to be a duplicate of another outbound message with an unhandled status, the message manager 914 may notify the message-delivery agent 902d that the outbound message has arrived.

(f) Deliver Received Messages

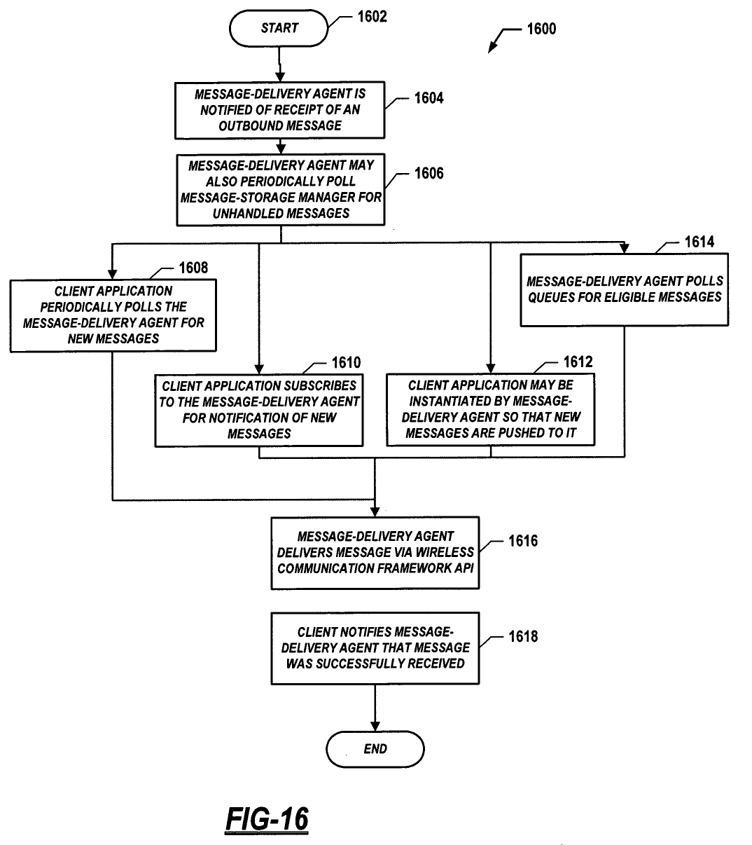

FIG. 16 is a flow diagram illustrating a flow 1600 for delivering an unhandled message in an InBox of the WCF 900 to a client application, such as one of the application programs 406a, 406b. At block 1602, the flow 1600 begins. At block 1604, the message-delivery agent 906b may be notified of the receipt of an outbound message. The message-delivery agent 906b may also periodically poll the message-storage manager 904f for unhandled messages to be delivered, as shown in block 1606.

The actual mechanism of delivery may depend on the client application and its use of the WCF API 902. In one embodiment, the delivery mechanisms may include client application periodically polling the message-delivery agent 902d for new messages, as shown in block 1608. The client application may specify its Destination Application ID when requesting messages so that the message-delivery agent 902d is able to identify the received outbound messages destined for the particular client application.

Alternatively, the client application may subscribe with the message-delivery agent 902d for notification of new messages, as shown in block 1610. The client application may specify its Destination Application ID when subscribing for notification.

In another alternative, the client application may be instantiated (by CLSID) by the message-delivery agent 902d and may have the received outbound messages pushed to it, as shown in block 1612. The mapping of Destination Application ID to CLSID may be accomplished through a configuration mechanism, e.g., the registry as noted above.

In yet another alternative, the message-delivery agent 902d may query for messages eligible for delivery, as shown in block 1614. The received outbound messages may have a status of unhandled in the InBox 904a. If ordered delivery, received outbound messages may be followed (e.g., in sequence number order) by a received outbound message that has already been handled and/or have the first possible sequence number.

At block 1616, the message-delivery agent 902d may deliver the messages using the WCF API 902. On successful processing of the outbound message, the client application may make a call to the message-delivery agent to mark the delivered messages as handled, as shown in block 1618. For pushed and notified messages, multi-threaded delivery (e.g., a thread pool) may be deployed. This may increase concurrency for deliveries that are not CPU bound.

5 Alternative Data and Processing Objects for the Wireless Communication Framework

The following outlines alternative data and processing objects for use with a Wireless Communication Framework, such as the WCF 900 that is illustrated in FIG. 9. The use of following alternative data and processing objects, however, is not limited to the architecture disclosed in FIG. 9. For simplicity, data and processing objects are provided in outline and table form. Such format is commonly known and used by those of skilled in the art.

Like above, the following alternative data and processing objects may represent some of the types of information that is passed between the elements of the WCF 900, and some of the processing that occurs within the WCF 900 and the across a WCF API 902. The data and processing objects may be represented individually by objects and collectively by tables or other storage mechanisms in the WCF 900.

(a) Alterative WCF Message

The alternative WCF Message object may be a message type that is sent and received by client applications over the WCF API 902. As shown in Table 7, the WCF Message table may include one or more of the following properties.

TABLE 7

| Property | Type | Description |
|---|---|---|
| DeviceID | Int32 | Device ID that message may be |
| | | to/from |
| Priority | Byte (0-31) | Priority of the message. 0 may be the |
| | | lowest priority, 31 may be the |
| | | highest. Priority may be used: |
| | | To choose which messages are |
| | | sent first |
| | | As an input to routing and |
| | | escalation |
| Content | Binary Data | The actual message content |
| | | (payload). |
| | | With compression and encryption, this |
| | | becomes virtual content. |
| Length | Int32 | The length of the message content. |
| | | The length property can only be read; |
| | | it set by writing the content. |
| | | With compression and encryption this |
| | | may become the length the client |
| | | expects and might not be the actual |
| | | length of the contained data. |
| Application ID | Byte | ID of the application to which the |
| | | message may be addressed at the |
| | | receiving WCF. |
| | | App ID 0 may be reserved for WCF |
| | | System messages. |
| | | App ID 255 (default) may be reserved |
| | | to detect uninitialized App IDs. |
| | | The Application ID may be irrelevant |
| | | for Ack messages. |
| Service Type | Enum | The type of delivery service requested |
| | | for the message. Service types |
| | | include: |
| | | 0 - Unreliable |
| | | 1 - Reliable |
| | | 2 - Ordered Delivery |
| MessageTag | Int32 | An ID assigned to a message. The |
| | | tag may be assigned when the |
| | | message is accepted by the Send API. |
| | | A message may be fully and uniquely |
| | | identified by its DeviceID and |
| | | MessageTag. (Subject to the rollover |
| | | of sequence numbers, which occurs |
| | | after 2\hat{ }16 messages of the same |
| | | priority and service type). |
| | | Note that the Send API might not |
| | | update this property directly in the |
| | | message, instead the tag may be |
| | | returned as an [out] parameter of the |
| | | send function. This is because the |
| | | message may be marshaled by value |
| | | for efficienty reasons. |
| TransportID | Int32 | For a message to be sent, the |
| | | TransportID on which the sender can |
| | | request that the message be sent. A |
| | | value of 0 leaves the transport |
| | | knowledge up to the RREM. |
| | | For a received message, the transport |
| | | on whch the message was received. |
| SendOptions | Int32 | A combination of flags specifying |
| | | options for sending the message. |
| | | This property may be meaningless for |
| | | received messages. Options include |
| | | the following transport flags: |
| | | Transport_Any = 0x0 |
| | | Transport_Specified = 0x1 |
| | | Force the message to be sent on |
| | | the transport specified in the |
| | | TransportID property. |

(b) Message Tag

The Message Tag may a 32 bit number that, when combined with Device ID, uniquely identifies a message (subject to the 2\hat{ }16 rollover of sequence numbers). As shown in Table 8, the Message Tag may include one or more of the following fields.

TABLE 8

| Position | Field | Description |
|---|---|---|
| Byte 3 Bit 7 | Direction | 0 - Server-to-Mobile |
| | | 1 - Mobile-to-Server |
| Byte 3 Bits 3-6 | Unused | Reserved, Must be 0 |
| Byte 3 Bit 2 | Unused | Reserved, Must be 0 |
| | | Can be growth for |
| | | Message Type field. |
| Byte 3 Bits 0-1 | Message Type | 0 - App. Message |
| | | 1 - Ack Message |
| | | 2 - Multi-Part Message |
| | | 3 - Reserved |
| Byte 2 Bit 7 | Unused | Reserved, Must be 0 |
| | | Can be growth for |
| | | Message Service field. |
| Byte 2 Bits 5-6 | Message Service | 0 - Unreliable Delivery |
| | | 1 - Reliable Delivery |
| | | 2 - Ordered Delivery |
| | | 3 - Reserved |
| Byte 2 Bits 0-4 | Message Priority | 0-31 |
| Bytes 0-1 | Sequence Number | LSB first (Little Endian) |

(c) Sequence Pool ID

The Sequence Pool ID may be an 8 bit number that, when combined with Device ID, identifies the sequence number pool (on the sending side) from which a sequence number is drawn. The Sequence Pool ID may be used to optimize sequence number assignment. Sequence Pool ID may be defined to be the same as Byte 2 of the Message Tag and may include one or more of the fields shown in TABLE 9.

TABLE 9

| Position | Field | Description |
|---|---|---|
| Bit 7 | Unused | Reserved, Must be 0 |
| | | Can be growth for |
| | | Message Service field. |
| Bits 5-6 | Message Service | 0 - Unreliable Delivery |
| | | 1 - Reliable Delivery |
| | | 2 - Ordered Delivery |
| | | 3 - Reserved |
| Bits 0-4 | Message Priority | 0-31 |

(d) WCF Inner Message

The WCF Inner Message object may be the message type passed between components of the WCF 900. The WCF Inner Message may extend the WCF Message with properties of interest to the WCF 900. The WCF Inner Message object may include one or more of parameters, such as those listed in Table 10.

TABLE 10

| Property | Type | Description |
|---|---|---|
| Direction | Enum | 0 - Server-to-Mobile |
| | | 1 - Mobile-to-Server |
| Message Type | Enum | 0 - App. Message |
| | | 1 - Ack Message |
| | | Future message types may be |
| | | defined. |
| SequenceNumber | Int16 | Sequence number used to identify a |
| | | message via the message protocol. |
| | | Ack messages may use the same |
| | | sequence number as the message to |
| | | which they are making an Ack. App. |
| | | messages may be assigned a |
| | | sequence number when accepted by |
| | | the Send function. A message's |
| | | sequence number might not change |
| | | once assigned. |
| WCF Version | UInt8 | Received messages only: the version |
| | | of WCF that was used to send this |
| | | message. |

The following fields are used in sequence number recovery. They can
be used in both outgoing and incoming messages.

| | | |
|---|---|---|
| Resequence | bool | If true, a sequence recovery is in |
| | | progress and the Sequence Seed and |
| | | Sequence Tag may be sent with each |
| | | message (in the same Sequence Pool) |
| | | until the sequence recovery is |
| | | acknowledged. When acknowledged, |
| | | this flag may be cleared for all |
| | | messages in the same pool. |
| SequenceSeed | Int16 | The initial sequence number chosen |
| | | (at random) when (re) initializing |
| | | sequence numbers. |
| SequenceTag | Int32 | The 32-bit tag, chosen at random, |
| | | used to uniquely identify the sequence |
| | | seed. |

Additions for version 2

| | | |
|---|---|---|
| CompressionEnabled | bool | Enable or disable compression for |
| | | this message. (Version 2) |
| EncryptionEnabled | bool | Enable or disable encryption for this |
| | | message. |
| Compressor | UInt8 | The enumerated type reflecting the |
| | | compression algorithm used. |
| Inner Length | Int32 | Actual length of the content |
| Inner Content | Binary | Compressed and/or encrypted |
| | Data | content. |

(e) WCF OutBox Message

The OutBox 904b may be used to keep messages sent by the local WCF until the messages have been acknowledged or sent with no acknowledgement required, An OutBox message may include the properties of WCF Message and WCF Inner Message, and parameters shown in Table 11.

TABLE 11

| Property | Type | Description |
|---|---|---|
| QueuedDateTime | Date/ | The GMT date/time at which the |
| | Time | message was queued for sending. |
| | | An additional time zone field may be |
| | | needed in the database to enable |
| | | time-zone-agnostic computations if |
| | | the database does not support GMT- |
| | | based operations. |
| | | This date/time may used to |
| | | compute message age when |
| | | ordering messages. |
| OutBoxMessageStatus | Enum | 10 - Queued |
| | | 20 - Pending |
| | | 21 - Pending Multi-Part Msg |
| | | 30 - Sent |
| | | 40 - Undeliverable |
| | | The initial value may be set to |
| | | Queued. |
| EscalationDateTime | Date/ | The GMT Date/Time at which the |
| | Time | message will be delivered to the |
| | | RREM for escalation. |
| | | The initial value may be set to the |
| | | QueuedDateTime. |
| EscalationRetryCount | Int32 | A number maintained by the RREM |
| | | to track the number of times a |
| | | message has been retried. The |
| | | RREM may reset this number when |
| | | escalating the message to a |
| | | different transport. |
| | | The initial value may be set to 0. |
| EscalationStrategy | Int32 | A number maintained by the RREM |
| | | to maintain status information about |
| | | the message. |
| | | The initial value may be set to 0. |

The following fields are used in sequence number assignment:

| | | |
|---|---|---|
| SequencePoolID | UInt8 | The Sequence Pool ID of the |
| | | message. |
| | | May be meaningful only for Message |
| | | Type = App Message. |
| SequenceLastAssigned | bool | A flag used in sequence number |
| | | assignment. |

Additions for version 2

| | | |
|---|---|---|
| IsMultiPart | bool | A flag used to indicate whether or |
| | | not the message is multi-part. |
| SubBlockSize | Byte | Indicates the sub block size. |
| | | 0 - 16 Bytes |
| | | 1 - 32 Bytes |
| NumSubBlocks | Int16 | Number of sub-blocks in this |
| | | message |
| FirstUnAckBlockOfffset | Int16 | Block offset to the first |
| | | unacknowledged block in the |
| | | message. |
| AckSeqNum | Byte | If MPAckType is ‘Ack with Window’, |
| | | this value may reflect the current |
| | | sequence number for the |
| | | acknowledgement. |

A message may be deleted from the OutBox 904b when its status is set to sent, the parameter SequenceLastAssigned is set to false, and the message is no longer present in any portion of the transport queue 904e (e.g., holding a position in a send window).

As a space optimization, the OutBox 904b may delete the payload of messages when the status is set to sent. But the message must be kept due when SequenceLastAssigned is set to true.

An Ack message may have a non-empty content field. Ack messages with empty content will be treated as a simple Ack (a positive acknowledgement of receipt of a message). Ack messages with non-empty content will contain an Ack type byte that indicates both the meaning of the Ack (e.g., NAck) and what type of data can follow.

(f) Sequence Number Assignment

When a message is placed in the OutBox 904b has a Message Type set to App Message, a sequence number may be assigned. This may occur within a transaction as follows. First, the Priority and Message Service may be combined to form the Sequence Pool ID. Second, a select instruction may be preformed to find a message with matching Device ID and Sequence Pool ID, and with the parameter SequenceLastAssigned set to true. If such a message is found, then a 1 may be added to the found sequence number. If the found sequence number is 32768, then subtract 65536. This calculation may be done using an Int32. The new message may be stored with the calculated sequence number. The values of Resequence, SequenceSeed, and SequenceTag parameters may be copied from the found record. The SequenceLastAssigned parameter may be set to true. The SequenceLastAssigned parameter may be set to false in the found record. And the SequenceLastAssigned parameter may used to maintain the memory of the last (and hence next) sequence number used. Otherwise, sequence number recovery may be carried out.

This may include (i) deleting from the transport queue 904e and the messages in the OutBox 904b with having a Message Type set to App Message and matching Sequence Pool ID and Device ID; (ii) randomizing an initial value for the SequenceSeed parameter and another initial value for the SequenceTag parameter; and (iii) storing the new message with the SequenceNumber parameter set to the SequenceSeed parameter. The values for the SequenceSeed and SequenceTag, SequenceLastAssigned parameters may be set to true and Resequence parameter may be set to true, except for messages with Message Service set to Unreliable, which may be stored with the Resequence set to false

Later messages may inherit the last queued message's Resequence property. Thus every message may attempt re-sequencing until the resequencing is acknowledged.

When a message is placed in the OutBox 904b with Message Type set to Ack, the Ack can specify the values for the Resequence, SequenceSeed, and SequenceTag parameters. These may be specified with the Resequence parameter set to true for an Ack queued in response to a message received with the Resequence parameter set to true. Ack messages may have the SequenceLastAssigned parameter set to false as the sequence numbers for Ack messages may be generated by the WCF 900 from which the messages were received.

When an Ack message is received with the Resequence parameter set to true, and the SequenceSeed and SequenceTag parameters along with messages in the OutBox 904b with Message Type set to Ack Message and matching Device ID, the Sequence Pool ID, SequenceSeed and SequenceTag parameters may be modified to set Resequence to false.

(g) On-Board architecture Sequencing Considerations

The on-board architecture implementation of sequence number assignment may be as follows. The on-board architecture might not allow messages within a Sequence Pool to skip sequence numbers. Thus, the knowledge of last sequence number assigned and the persistence of unacknowledged messages must be managed jointly. The on-board architecture might not allow messages within a Sequence Pool to duplicate sequence numbers. The on-board architecture might not (i) send (over a transport) a message that has not been persisted, and/or (ii) persist the use of a sequence number without simultaneously persisting the message that uses that sequence number

In this context, persistence assumes that the last saved state is recoverable even in the event of unexpected program or WCF 900 or overall system termination (crash, power failure). The on-board architecture may be able to detect and discard partially saved messages and be sure that such messages have not been sent.

The on-board architecture may keep the sequence number pool in memory during normal operation, and scan the existing messages at startup to determine the last sequence numbers used. Sequence number assignment may be thread-safe in a multi-threaded implementation.

(h) Unreliable Delivery Sequence Numbers

Message sequence numbers may be assigned in the OutBox 904b for messages with the Message Service set to Unreliable Delivery, but these sequence numbers might not be transmitted in WCF packets. On receipt of such a message, the receiving WCF may construct an appropriate sequence number when storing the message in the InBox 904a.

(i) Receive-Side Sequence Numbering

On the receive side, the WCF 900 may keep track of a Current-Sequence Number and Next Sequence Number for each Sequence Pool. This sequence numbers may have a different meaning depending on the message service of the sequence pool.

For Ordered Delivery messages, the Next Sequence Number may be the next message sequence number that can be delivered. Successful delivery of that message (or completion of a deferred delivery) may advance this number allowing the next message to be delivered immediately or when it arrives. This sequence number may be used for re-ordering messages for ordered delivery. A message can be delivered when its sequence number is the same as the next sequence number.

For Ordered Delivery and Reliable Delivery messages, the Current Sequence Number may represent the first discontinuity in received sequence numbers, and may be used to manage the receive-side transport window. A message with a ‘prior’ sequence number within 256 sequence numbers may be considered a duplicate, and thus discarded and Ack'd. A message with a ‘same or later’ sequence number within 256 sequence numbers may be considered within the transport window and stored (or discarded if it matches a message already saved and Ack'd. A message with any other sequence number is considered outside the transport window and can be discarded without Ack. This situation may occur if the sending side initiated a re-sequence, but a prior message was still in transit.

For Reliable Delivery messages, the Next Sequence Number might not be used. For Unreliable Delivery messages, the Next Sequence Number may be used at receive time to assign a sequence number to the message. It may advance for each sequence number assigned. The Current Sequence Number might not be used. WCF Server may maintain this information in a separate table in the InBox 904a.

The on-board architecture may use the InBox 904a to remember this information and scan the InBox 904a at startup to determine current values. It can then cache the information.

(j) Receive-Side Sequence Recovery

On the receive side (i.e. receipt of application messages), sequence number recovery may be performed under at least the following cases. These cases may apply to Ordered Delivery and Reliable Delivery messages.

i. Case 1: Sequence Recovery with Matching Seed and Tag

If the received message matches the Sequence Seed and Sequence Tag, then this re-sequence operation may have already been processed and the received message may be inserted in the InBox 904a with no additional processing. The Ack message may still echo the re-sequence information.

ii. Case 2: Sequence Recovery with No Undelivered Messages

This case can occur during sequence pool initialization (i.e. the first time a message was sent from a sequence pool) and when the send-side sequencing information has been lost and is being recovered.

For an ordered delivery sequence pool, delivered messages may be deleted except the message whose sequence number matches the Next Sequence Number to be delivered (there will be one such message if it was accepted with deferred delivery and has not yet completed). If such a message exists, it may be renumbered to one sequence number prior to the new sequence seed.

For a non-ordered delivery sequence pool, delivered messages may be deleted. The new sequence seed and tag may be stored for the sequence pool.

If a deferred delivery message was found, the Next Sequence Number to be delivered may be set to one prior to the received sequence seed. This may ensure that the deferred delivery completion will release the first message of the new sequence. Otherwise the Next Sequence Number may be set to the received Sequence Seed.

If the received message's sequence number is the same as the new sequence seed, then the Current Sequence Number can be set to one beyond the received sequence seed, otherwise it may be set to the sequence seed.

iii. Case 3: Sequence Recovery with Undelivered Messages

This case can occur during when the send-side sequencing information has been lost and is being recovered. For an ordered delivery sequence pool, delivered messages may be deleted except the message whose sequence number matches the Next Sequence Number to be delivered (there will be one such message if it was accepted with deferred delivery and has not yet completed).

For a non-ordered delivery sequence pool, delivered messages may be deleted. All remaining messages may be renumbered to form a contiguous set of sequence numbers up to but not including the received Sequence Seed.

If a deferred delivery message was found, the Next Sequence Number to be delivered may be set to one prior to the received sequence seed. This may ensure that the deferred delivery completion will release the first message of the new sequence. Otherwise the Next Sequence Number may be set to the received Sequence Seed.

If the received message's sequence number is the same as the new sequence seed, then the Current Sequence Number can be set to one beyond the received sequence seed, otherwise it should be set to the sequence seed.

iv. Case 4: Received Message with No Current/Next Sequence Number

This case can occur if the receive-side database was lost. Since there is no current/next sequence number, it may be assumed that the InBox 904a is also empty of messages for the matching sequence pool.

Such a message may be NAck'd with WCFAckType_NackEmptySequencePool parameter, and then discarded. On receipt of a message with the WCFAckType-NackEmptySequencePool set to true and that matches a message in the OutBox 904b, a sending WCF may initiate resequencing for the affected sequence pool. Within the affected sequence pool in the OutBox 904b (I) the matched message, if already marked as acknowledged, may be reset to outbox status queued and removed from all transport queues; and (ii) a new numbering sequence may be assigned, with the sequence seed being 256 plus the last assigned sequence number. A new, random sequence tag may be assigned.

For a reliable delivery pool, (i) an acknowledged application messages may be discarded; (ii) an unacknowledged application messages may be removed from all transport queues and reset to an outbox status of queued; and (ii) messages may be renumbered and retagged, preserving their order but closing sequence holes left by messages that were already discarded. Numbering may start with the new sequence seed. Each message may have its Resequence parameter set to true and shall be set to have the new sequence tag.

For an ordered delivery pool, (i) an acknowledged application messages up to the first unacknowledged message may be discarded; (ii) remaining application messages may be removed from the transport queues 904e and reset to an outbox status of queued; and (iii) messages may be renumbered and retagged, preserving their order. Holes left in the sequence by messages previously discarded may be filled with empty (zero length) system messages. Numbering may start with the new sequence seed. Each message may have its Resequence parameter set to true, and may be set to have the new sequence tag.

(k) InBox Message

The InBox 904a may be used to store messages until they have been successfully delivered. An InBox message may extend WCF Message and WCF Inner Message. The InBox message may include one or more of the parameters shown in Table 12.

TABLE 12

| Property | Type | Description |
|---|---|---|
| DeliveryStatus | Enum | The status of message delivery. |
| | | 5 - Multi-Part message in progress |
| | | 10 - Unhandled |
| | | 20 - Pending (not used) |
| | | 30 - Handled |
| TransportAddress | Char | The transport-specific address for |
| | (127) | the device on the transport on which |
| | | this message was received. |

Additions for Version 2

| | | |
|---|---|---|
| IsMultiPart | Bool | A flag used to indicate whether or |
| | | not the message is multi-part. |
| SubBlockSize | Byte | Indicates the sub block size. |
| | | 0 - 16 Bytes |
| | | 1 - 32 Bytes |
| HighestUnRcvdBlockOffset | Int16 | Sub-block offset to the last received |
| | | block + 1. |
| NumberMissingBlocks | Byte | Number of missing blocks |

(l) InBox Message Missing Blocks

Missing blocks may indicate where “holes” are in the received Multi-Part message. If packets are received out of order, or dropped/lost, the InBox Message can contain “holes,” where the received data is not contiguous. This container allows for the “holes” to be identified. A record may be kept for each missing block in an InBox Message. The InBox Message may include one or more of the properties shown in TABLE 13

TABLE 13

| Property | Type | Description |
|---|---|---|
| BlockOffset | Int16 | Number of sub-blocks offset in the |
| | | InBox message that this “hole” starts |
| | | with. |
| BlockSize | Int16 | Number of sub-blocks included in |
| | | this message “hole”. |

(m) WCF Device Table

The WCF Device table may be used by the off-board architecture to keep track of the on-board architectures that the WCF 900 can communicate with. The WCF Device table may have the one or more of the parameters shown in TABLE 14.

TABLE 14

| Property | Type | Description |
|---|---|---|
| DeviceID | Int32 | The unique ID assigned to the WCF |
| | | Device and used as the address of |
| | | the device for the purpose of client |
| | | messaging. The ID may be unique |
| | | within the confines of the set of |
| | | devices that are part of the same |
| | | WCF system. |
| DeviceCode | Char(20) | A user-assigned identification of the |
| | | device. |
| WCF Version | UInt8 | The version of WCF that is known to |
| | | be installed on this device. |

(n) WCF Transport

Since an on-board architecture may have one or more transports, the WCF Device transport table in the off-board architecture may include one or more of the transport interfaces, such as transport interfaces 906, 908. The WCF Transport table may be used to keep track of the available transport networks and their configuration properties. The on-board architecture may keep this data in a configuration file rather than a table. The WCF transport table or filed may have one or more of the properties shown in TABLE 15.

TABLE 15

| Property | Type | Description |
|---|---|---|
| TransportID | Int32 | The Unique ID assigned to the |
| | | transport. the provider may |
| | | maintain the assignment of these |
| | | IDs across all WCFs. |
| TransportName | Char(20) | A descriptive name for the |
| | | transport. |
| MaxPacketSize | Int32 | The largest packet that can be sent |
| | | over this transport. |

The following properties may be used by the standard Transport
Strategy component. Custom Transport Strategy components
might not use the following properties.

| | | |
|---|---|---|
| DevicePendingWindow | Int16 | The maximum number of messages |
| | | that can be outstanding to a device |
| | | on this transport. A message is |
| | | ‘outstanding’ once it is sent, until |
| | | either: |
| | | An acknowledgement is |
| | | received for the message |
| | | The DeviceWindowTime |
| | | expires for a message that will |
| | | not be acknowledged |
| | | The message times out or is |
| | | escalated out of the transport |
| | | queue. |
| DeviceWindowTime | Int32 | The number of seconds that a |
| | | message remains in the |
| | | DevicePendingWindow if no |
| | | acknowledgement is expected for |
| | | the message. |
| NetworkSendMax | Int16 | The maximum number of messages |
| | | that can be sent on the transport |
| | | before requiring a pause of at least |
| | | NetworkSendWait. These |
| | | parameters may be tuned together |
| | | to throttle the rate at which |
| | | outbound messages are sent on the |
| | | transport. |
| NetworkSendWait | Int16 | The number of seconds to wait, |
| | | after sending NetworkSendMax |
| | | messages, before sending |
| | | messages again on the transport. |
| | | Note that to allow messaging to |
| | | occur at the throttled rate, the |
| | | Transport Send Agent might not |
| | | need to wait the full duration |
| | | unless it actually sent |
| | | NetworkSendMax |
| | | messages in the last batch. |

Additions for version 2

| | | |
|---|---|---|
| MPThreshold | Int32 | If a message size exceeds this |
| | | threshold, it may be sent as a |
| | | multi-part message. |
| MinMpSize | Int16 | Minimum block size for a |
| | | multi-part message part. |
| MaxMpSize | Int16 | Maximum block size for a |
| | | multi-part message part. |
| MPAckType | Byte | Type of Multi-Part |
| | | Acknowledgement. |
| | | 1 - Ack Just This Part |
| | | 2 - Ack with Window |
| MPAckWindow | Byte | When MPAckType is ‘Ack with |
| | | Window’ this reflects the number |
| | | of message parts that can be |
| | | sent before requesting an |
| | | acknowledgement for all message |
| | | parts in the window. |

The following properties are only required by WCF
On-board architecture:

| | | |
|---|---|---|
| TransportLocalDeviceID | Char(127) | A value that can be queried of the |
| | | transport by WCF On-board |
| | | architecture and compared to prior |
| | | values in order to detect changes in |
| | | the transport device connected to |
| | | the WCF On-board architecture. |
| | | This mechanism may be used to |
| | | detect address changes so that the |
| | | WCF Server can be notified. |

(o) WCF Device Transport Table

The WCF Device Transport table may hold the information about which transport networks and corresponding transport-specific addresses are available to the on-board architectures. This information may be only required on the off-board architecture.

A WCF Device transport table may have one or more of the parameters shown in TABLE 16.

TABLE 16

| Property | Type | Description |
|---|---|---|
| DeviceID (PK) | Int32 | The ID of the device having this |
| | | transport |
| TransportID (PK) | Int32 | The ID of the transport |
| TransportAddress | Char(127) | The transport-specific address on |
| | | which messages are exchanged with |
| | | the WCF On-board architecture |
| | | device. For example, Mobitex MAN |
| | | Number. |
| | | This address may be required to be |
| | | supported symmetrically by the |
| | | transportd module, i.e., provided for |
| | | both send and receive operations as |
| | | well as notification of send failures. |
| TransportAddressAux | Char(127) | Additional address information |
| | | required by the transport when |
| | | sending a message. |
| Status | Enum | An indication of the transport's |
| | | status for this device. The statuses |
| | | may include: |
| | | 10 - Enabled |
| | | 15 - Disabled until date/time |
| | | 20 - Disabled |
| ReEnableDateTime | Date/Time | For status Disabled until date/time, |
| | | this is the date/time at which the |
| | | status will be changed back to |
| | | enabled. |

(p) Transport Queue

The transport queue 904e may hold information about messages that are to be sent on a transport and tracks the status transport-specific status of those messages. The off-board architecture may implement the transport queue 904e as a single table using the Transport ID parameters to distinguish between different portions of the transport queue 904e.

A message in the transport queue 904e may include one or more of the parameters shown in TABLE 17. When obtaining a message from the transport queue 904e, the message parameter from the OutBox 904b may also be available.

TABLE 17

| | | |
|---|---|---|
| Property | Type | Description |

The following fields identify a message in the OutBox, and
form part of the primary key

| | | |
|---|---|---|
| DeviceID | Int32 | DeviceID of the message |
| MessageTag | Int32 | The MessageTag of the message |

The following field identifies the Transport Queue in which
the message is queued, and forms part of the primary key.
Note that the same message is permitted to be queued
in multiple transport queues.

| | | |
|---|---|---|
| TransportID | Int32 | The ID of the transport to which the |
| | | message is queued. |

The following fields are copied from Message OutBox and
are intended to support the Sequence Number Recovery
step of flushing transport queue messages, without
requiring a join to the Message OutBox table.

| | | |
|---|---|---|
| Message Type | Enum | 0 - App. Message |
| | | 1 - Ack Message |
| | | 2 - Multi-Part Message |
| SequencePoolID | UInt8 | The Sequence Pool ID of the |
| | | message. |
| | | May be meaningful only for Message |
| | | Type = App Message. |

The following fields may be some of the specific properties
used for a WCF Transport Queue Message.

| | | |
|---|---|---|
| Status | Enum | The status of this message in the |
| | | Transport Queue: |
| | | 10 - Queued |
| | | 11 - Queued, ask for Ack |
| | | 20 - Pending |
| | | 21 - Pending Not In Window |
| | | 30 - Sent No Ack Req. |
| | | 40 - Sent |
| | | 41 - Sent, But not received (NAck'd) |
| | | Messages with status Sent (40/41) |
| | | may be deleted. |
| TransportPriority | UInt8 | The transport-specific priority |
| | | assigned to this message when it |
| | | was queued to be sent. |
| IgnoreWindow | bool | If set, this message can be sent to |
| | | the device even if the device-specific |
| | | send window would otherwise block |
| | | the message. |
| SentDateTime | Date/Time | The date/time at which the message |
| | | was successfully transferred to the |
| | | transport (status changed to |
| | | Pending). |
| ProcessDateTime | Date/Time | The date/time at which the message |
| | | must be processed according to its |
| | | status. |
| | | Queued - the trigger date/time at |
| | | which the message can initiate a |
| | | transport packet |
| | | Pending, Pending Not In Window - |
| | | the timeout date/time at which the |
| | | RREM will be notified that no Ack |
| | | was received. |
| | | Sent No Ack - the window date/time |
| | | at which the message will no longer |
| | | be considered as in the transport's |
| | | device window. |
| PacketID | UInt32 | A rotating ID used to track |
| | | messages that were sent in the |
| | | same transport packet. The |
| | | Transport Send Agent (for each |
| | | transport) may maintain the counter. |
| | | A set of messages (on the same |
| | | transport) with the same PacketID |
| | | may be considered to count as only |
| | | one message for transport-device |
| | | and network send windows. |
| TransportTag | UInt32 | An ID assigned by the transport |
| | | during Send that can be later used |
| | | to associate delivery failure |
| | | notifications with the affected |
| | | message(s). |

Added for Version 2

| | | |
|---|---|---|
| BlockOffset | Int16 | Number of sub-blocks offset in the |
| | | OutBox message that this message |
| | | part starts with. |
| BlockSize | Int16 | Number of sub-blocks included in |
| | | this message part. |

(q) Application Map

On the off-board architecture, the Application Map may provide a mapping from Application ID to destination application components for applications that may use push delivery. The Application Map may include one or more of the parameters shown in TABLE 18.

TABLE 18

| Property | Type | Description |
|---|---|---|
| ApplicationID | Byte | ID of the application to which the |
| | | message will be delivered. |
| Node | Char(50) | Name of the computer on which to |
| | | deliver messages for this Application |
| | | ID. Corresponds to the value |
| | | returned by GetComputerName on |
| | | that computer. |
| Enabled | Bool | Indicates whether or not message |
| | | delivery is enabled. |
| TargetMoniker | Char(128) | String, moniker for the destination |
| | | application. This value may be |
| | | passed directly to CoGetObject. To |
| | | use a ProgID use the form |
| | | “new: progid” e.g., |
| | | “new: MyApp.MyComponent.” To use |
| | | a CLSID use the form “new: {CLSID}”. |
| | | Note that the use of a moniker is |
| | | intended to facilitate a simple |
| | | transition to queued components, by |
| | | allowing the “queue:” form of the |
| | | moniker to be used. |
| TryAfter | Date/Time | Date/time after which to attempt |
| | | deliveries. This date/time is set |
| | | shortly in the future when a delivery |
| | | failure occurs. |
| AssumeDeferred | Bool | If True, assume that when the target |
| | | component returns S_OK it means |
| | | S_WCF_DEFERRED_DELIVERY. |

(r) WCF Event Log

The WCF Event Log on the off-board architecture may be used to track significant message events as described above. The Table 19 describes the Event Log fields and the data that may be stored in them per event. Other events may be stored as well.

| | | | Event Type | | | | | | |
|---|---|---|---|---|---|---|---|---|---|
| | | | | | Transport | Transport | | | |
| | | | Message Saved | | Queue | Packet Sent/ | Contained Message | Message | |
| Property | Type | Description | or Updated | RREM Event | Update | Received | In Transport Packet | Renumber | Purge |
| DateTime | Date/Time | Date/Time at | x | X | x | x | x | x | x |
| | | which the log | | | | | | | |
| | | entry was made. | | | | | | | |
| Event | Int16 | Identifies the | x | X | x | x | x | x | x |
| | | event recorded | OutBoxAdd | RREMQueued | TQAdd | TPSent | TPSentMessage | OutBox | OutBoxPurge |
| | | | OutBoxUpdate | RREMTimeout | TQUpdate | TPReceived | TPReceivedMessage | Renumber | InBox |
| | | | InBoxAdd | RREMEscalation | TQRemove | | | InBox | Purge |
| | | | InBoxUpdate | RREMSent | | | | Renumber | |
| | | | | RREMAcked | | | | | |
| | | | | RREMDeliveryError | | | | | |
| | | | | RREMMessageStatus | | | | | |
| DeviceID | Int32 | Source/Destination Device | x | x | x | x | x | x | x |
| | | | | | | 0 if received | | | |
| | | | | | | message decode failed. | | | |
| MessageTag | Int32 | Tag of affected | x | x | x | | x | Old Tag | |
| | | message | | | | | | | |
| MessageTag2 | Int32 | Second tag | Tag Of Message | Tag Of Message Acked | Tag Of | | Tag Of Message | New Tag | |
| | | value if needed | Acked if Ack | if Ack Message | Message | | Acked if Ack | | |
| | | | Message | | Acked if Ack | | Message | | |
| | | | | | Message | | | | |
| PacketID | Int32 | ID of Packet | | If applicable | x | x | x | | |
| | | sent/received | | | | | | | |
| | | on transport. | | | | | | | |
| Length | Int32 | Length of | on save or | | | Length of | Calculated Length | | |
| | | packet/message | change | | | transport packet | of WCF Message. | | |
| | | | Length of content | | | | Initially, WCF | | |
| | | | | | | | Payload size. | | |
| ApplicationID | Uint8 | Target | on save or | | | | x | | x |
| | | Application | change | | | | | | |
| Priority | UInt8 | Message Priority | on save | | | | x | | |
| | | May be redundant | | | | | | | |
| ServiceType | UInt8 | Message | on save | | | | x | | |
| | | Service Type | | | | | | | |
| | | May be redundant | | | | | | | |
| TransportID | Int32 | | on save | Event Source | x | | x | | x |
| TransportCode | Int32 | Transport- | | If applicable | | | | | |
| | | specific error | | | | | | | |
| | | code or status code | | | | | | | |
| Status | Int32 | Status of | New Message | | New | | | | |
| | | Message or | Status | | Transport | | | | |
| | | Transport Queue | | | Queue | | | | |
| | | | | | Message Status | | | | |
| DTParam1 | Date/Time | | Escalation DT | | TQProcess | | | | |
| | | | (Outbox only) | | DT | | | | |
| LParam1 | Int32 | | Escalation | | Transport | Transport | Resequence Flag | | |
| | | | Strategy (Outbox | | Priority | Priority (Sent | | | |
| | | | Only) | | | Only) | | | |
| LParam2 | Int32 | | Retry Count | | Ignore | | If resequence, | | |
| | | | (Outbox Only) | | Window | | sequence seed. | | |
| | | | | | Flag | | | | |
| SParam1 | Char(128) | | From Address | | | Transport | | | |
| | | | (InBox only) | | | Address | | | |
| Result | Int32 | A result code | Success or | Success - written in | Success | 0 | 0 | 0 | 0 |
| | | for the | DB Error code: | transaction. | | Error | | | |
| | | operation. | Duplicate | Error HRESULT - | | HRESULT on | | | |
| | | 0 = success | Outside Window | written after transaction | | received | | | |
| | | | SeqPool Not | failure. | | message if | | | |
| | | | Found | | | decode | | | |
| | | | | | | failed. | | | |
| Transactioned | n/a | Indicates | y | Should be logged as | y | n | n | y | y |
| | | whether this log | | part of the transaction, | | | | | |
| | | record is to be | | but logged with a ‘failed’ | | | | | |
| | | rolled back if | | code if the transaction | | | | | |
| | | the transaction | | fails and the event was | | | | | |
| | | is rolled back. | | derived externally (sent, | | | | | |
| | | | | error, status). | | | | | |
| | | | | The internal events | | | | | |
| | | | | (queued, escalated, | | | | | |
| | | | | timeout) don't really | | | | | |
| | | | | matter if the transaction | | | | | |
| | | | | rolls back, because they | | | | | |
| | | | | will be retried if needed. | | | | | |
| | | | | Acked will only be | | | | | |
| | | | | logged as part of a | | | | | |
| | | | | transaction. | | | | | |
| Logged From | n/a | Logged from a | Stored Procedure | Message Manager | Stored | Transport | Transport Send | Stored Procedure | Stored Procedure |
| | | component or | | Event Handler (in | Procedure | Send Agent | Agent (Sent) | | |
| | | stored | | transaction) | | (Sent) | Transport (Received) | | |
| | | procedure | | Transport | | Transport (Received) | | | |
| | | | | (transaction failed) | | | | | |

(s) Last Message Event

The Last Message Event table may be used on off-board architecture to keep a duplicate copy of the most recently logged WCF Message Event entries. Specifically, the last Message Event may be kept per Device, Transport, and Event Type. This may allows an inexpensive query to be used to determine device status information such as last packet sent/received. The information is also available from the Message Event Log table, but may be more expensive to obtain.

(t) WCF Packet Formats—Version 1

WCF Messages may be formatted into WCF Packets for delivery over the transport modules 906a, 908a. This formatting takes place immediately before the WCF packet is sent to the transport modules 906a, 908a. The WCF Packet may include one or more of the fields shown in TABLE 20.

TABLE 20

| Position | Field | Description |
|---|---|---|
| Byte 0 Bits 0-3 | WCF Version | The version of the WCF Packet format. |
| | | This version number identifies the |
| | | format of the packet. A receiving WCF |
| | | may attempt to decode the packet if |
| | | the version number is recognized. |
| | | Note that Bit 3 can be used to indicate |
| | | an “extended” version number (i.e. |
| | | more version number bits elsewhere in |
| | | the packet) if it becomes necessary to |
| | | extend beyond versions 0-7. |
| Byte 0 Bits 4-7 | Packet Type | An enumerated value indicating the |
| | | type of this packet. |
| | | 0 - Single App Message (Message |
| | | Type = App Message) |
| | | 1 - Single Ack Message (Message |
| | | Type = Ack Message) |
| | | 8 - Packaged Message (contains |
| | | multiple messages) |

i. Single Application Message and Single Ack Message

For Single Application and Single Ack Messages, the Packet Identification Byte may be followed by the Standard Header as shown in the Table 21. Other headers may be used as well.

TABLE 21

| Position | Field | Description |
|---|---|---|
| Byte 1 Bits 0-1 | Length Flag | 0 - Length not included |
| | | 1 - 1 byte Length included |
| | | 2 - 2 byte Length included |
| Byte 1 Bit 2 | Re-Sequence Flag | If set, this message is part of a |
| | | Sequence Number Recovery and |
| | | includes the SequenceSeed and |
| | | SequenceTag fields. |
| Byte 1 Bit 3 | CRC Flag | If set, this packet may have a trailing |
| | | 2-byte CRC, otherwise the transport |
| | | module guaranteed not to corrupt the |
| | | message. |
| Byte 1 Bits 4-5 | Device ID Flag | 0 - Device ID omitted (note: this |
| | | reserves the capability to omit Device |
| | | ID as a space optimization.) |
| | | 1 - 2 byte Device ID |
| | | 2 - 3 byte Device ID |
| | | 3 - 4 byte Device ID |
| Byte 1 Bits 6-7 | Unused | Reserved, may be 0. |
| | | May be used in the future for |
| | | Compression & Encryption flags. |
| Bytes 2-A | Length | Length of the entire WCF Packet. |
| | | 0 to 2 bytes, LSB first, depending on |
| | | the value of the length flag. |
| Bytes A + 1-B | DeviceID | Device ID - the WCF On-board |
| | | architecture that is the source or |
| | | destination of the message. |
| | | 0 to 4 bytes, depending on the value |
| | | of the Device ID flag. |
| Bytes B + 1-C | SequenceSeed | 2 bytes, LSB first, may be present if |
| | | the Re-Sequence flag is set. |
| Bytes C + 1-D | SequenceTag | 4 bytes, LSB first, may be present if |
| | | the Re-Sequence flag is set. |
| Byte D + 1 Bit 7 | Unused | Reserved, Must be 0 |
| | | Can be growth for Message Service |
| | | field. |
| Byte D + 1 Bits 5-6 | Message Service | 0 - Unreliable Delivery |
| | | 1 - Reliable Delivery |
| | | 2 - Ordered Delivery |
| | | 3 - Reserved |
| Byte D + 1 Bits 0-4 | Message Priority | 0-31 |
| Bytes D + 2-D + 3 | Sequence Number | 2 bytes, LSB first |
| | | Not present for Message Service = Unreliable |
| | | Delivery |

Single Application messages may contain a destination application ID as shown in TABLE 22:

TABLE 22

| Position | Field | Description |
|---|---|---|
| Byte D + 4 | Application ID | Destination Application ID |

Single Application and Single Ack messages may contain the content shown in Table 23:

TABLE 23

| Position | Field | Description |
|---|---|---|
| Bytes D + 4/D + 5-E | Content | Client message bytes. |
| | | May be empty. |

Single Application and Single Ack Messages with a CRC flag set may contain a two-byte CRC, as shown in Table 24.

TABLE 24

| Position | Field | Description |
|---|---|---|
| Bytes E + 1-E + 2 | CRC-16 | 2 Byte CRC, present only if the CRC |
| | | Flag is set. |
| | | Algorithm: CRC-CCITT (Same as |
| | | e-Technician OBU Message). |
| | | Stored MSB first to allow CRC to be |
| | | run over entire packet. |

ii. Packaged Message

In the case of Packet Type set to a Packaged Message, the SequenceSeed and SequenceTag parameters may be duplicated by multiple messages within the Packaged Message. For space optimization purposes, the first values seen may be incorporated into the header of the Packaged Message, and then each contained message flagged as to whether it inherits values from the header of the Packaged Message.

Contained messages may share the same Device ID. For packaged Message, the Packet Identification Byte may followed by the Packaged Message Header. This header may be similar to the Standard Header. The Packaged Message Header may include (i) a flag that may be used to capture whether Application ID is present in the header, thereby allowing duplicate Application ID bytes to be dropped from contained messages; and (ii) the Message Identification fields (e.g., Message Service, Priority, and/or Sequence Number) might be omitted because they can be different for each contained message.

The Packaged Message Header may include one or more of the fields shown in Table 25.

TABLE 25

| Position | Field | Description |
|---|---|---|
| Byte 1 Bits 0-1 | Length Flag | 0 - Length not included |
| | | 1 - 1 byte Length included |
| | | 2 - 2 byte Length included |
| Byte 1 Bits 2-3 | Re-Sequence Flag | If set, this message is part of a |
| | | Sequence Number Recovery and |
| | | includes the SequenceSeed and |
| | | SequenceTag fields. |
| Byte 1 Bit 3 | CRC Flag | If set, this packet may have a trailing |
| | | 2-byte CRC. |
| Byte 1 Bits 4-5 | Device ID Flag | 0 - Device ID may be omitted (note: |
| | | this reserves the capability to omit |
| | | Device ID as a space optimization.) |
| | | 1 - 2 byte Device ID |
| | | 2 - 3 byte Device ID |
| | | 3 - 4 byte Device ID |
| Byte 1 Bit 6 | Application | If set, the Application ID field may |
| | ID Flag | be present in the header. |
| Byte 1 Bit 7 | Unused | Reserved, may be 0. |
| Bytes 2-A | Length | Length of the entire WCF Packet. |
| | | 0 to 2 bytes, LSB first, depending on |
| | | the value of the length flag. |
| Bytes A + 1-B | DeviceID | Device ID - the WCF On-board |
| | | architecture that is the source or |
| | | destination of the message. |
| | | 0 to 4 bytes, depending on the value |
| | | of the Device ID flag. |
| Bytes B + 1-C | SequenceSeed | 2 bytes, LSB first, may be present if |
| | | the Re-Sequence flag is set. |
| Bytes C + 1-D | SequenceTag | 4 bytes, LSB first, may be present if |
| | | the Re-Sequence flag is set. |
| Byte D + 1 | Application ID | Destination Application ID, may be |
| | | present if the Application ID |
| | | Flag is set. |

Each contained message may include one or more of the fields shown in TABLE 26.

TABLE 26

| Position | Field | Description |
|---|---|---|
| Byte 0 Bit 0 | Contained Length | Indicates how many bytes follow for |
| | Flag | the length of the contained message. |
| | | For Message Type App Message: |
| | | 0 - 1 byte Contained Length |
| | | 1 - 2 bytes Contained Length |
| | | For Message Type Ack Message: |
| | | 0 - 0 bytes Contained Length (i.e. |
| | | Content field is empty and has a length |
| | | of 0). |
| | | 1 - 1 byte Contained Length |
| | | Ack messages may be limited to 255 |
| | | bytes of content. |
| Byte 0 Bit 1-2 | Message Type | An enumerated value indicating the |
| | | type of this contained message. |
| | | 0 - App. Message |
| | | 1 - Ack Message |
| | | 2 - Reserved |
| | | 3 - Reserved |
| Byte 0 Bits 3-4 | Inherit Re-Sequence | 0 - the contained message might not |
| | Flag | contain or inherit the re-sequence |
| | | fields Resequence Flag, |
| | | SequenceSeed and SequenceTag. |
| | | When extracted, Resequence may be |
| | | set to false. |
| | | 1 - The contained message may |
| | | inherit the Resequence Flag, |
| | | SequenceSeed and SequenceTag |
| | | fields from the Packaged Message |
| | | Header. |
| | | 2 - The contained message may have |
| | | Resequence Flag set to true and |
| | | contain its own values for |
| | | SequenceSeed and SequenceTag. |
| Byte 0 Bit 5 | Inherit Application | 0 - this contained message may have |
| | ID Flag | its own value for Application ID, if it is |
| | | of type App Message. |
| | | 1 - This contained message may |
| | | inherit the Application ID field from the |
| | | Packaged Message Header, if this |
| | | message is of type App Message. |
| | | Messages of types other than App |
| | | Message may not contain or inherit |
| | | Application ID. |
| Byte 0 Bit 6 | Unused | Reserved, may be set to 0. |
| | | The Compression Enabled flag may be |
| | | placed here. |
| Byte 0 Bit 7 | Unused | Reserved, may be set to 0. |
| | | The Encryption Enabled flag may be |
| | | placed here. |
| Bytes 1-B | Contained Length | Length of the Content part of the |
| | | message. This may be the length of |
| | | the content field only, and might not |
| | | include the length and flag bytes. |
| | | 0 to 2 bytes, LSB first, depending on |
| | | the value of the contained length flag. |
| Bytes B + 1-C | SequenceSeed | 2 bytes, LSB first, may be present if |
| | | the flags indicate that this contained |
| | | message has its own value for this |
| | | field. |
| Bytes C + 1-D | SequenceTag | 4 bytes, LSB first, may be present if |
| | | the flags indicate that this contained |
| | | message has its own value for this |
| | | field. |
| Byte D + 1 Bit 7 | Unused | Reserved, Must be 0 |
| | | Can be growth for Message Service |
| | | field. |
| Byte D + 1 Bits 5-6 | Message Service | 0 - Unreliable Delivery |
| | | 1 - Reliable Delivery |
| | | 2 - Ordered Delivery |
| | | 3 - Reserved |
| Byte D + 1 Bits 0-4 | Message Priority | 0-31 |
| Bytes D + 2-D + 3 | Sequence Number | 2 bytes, LSB first |
| | | Not present for Message Service = Unreliable |
| | | Delivery |

Contained messages that are Application Messages may contain the destination application ID, as shown in TABLE 27:

TABLE 27

| Position | Field | Description |
|---|---|---|
| Byte D + 4-E | Application ID | Destination Application ID |
| | | May be present if the flags indicate |
| | | that this message does not inherit the |
| | | value from the Packaged Message |
| | | Header. |

Contained messages that are Application or Ack Messages may contain one of more of the message content fields shown in Table 28.

TABLE 28

| Position | Field | Description |
|---|---|---|
| Bytes E + 1-F | Content | Client message bytes |

iii. System Messages

A system message may be an Application Message addressed to Application ID 0. The first byte of the system message may identify the type of the system message and thereby it's content. Table 20 lists some of the system messages and corresponding system identification number. Other System messages and corresponding identification numbers are possible as well.

TABLE 29

| System | |
|---|---|
| Message ID | Name |
| 0 | WCF Filler |
| | This message may have no content |
| | Additional data bytes: none. |
| 1 | WCF Version Mismatch |
| | The On-board architecture device received a message |
| | with an unrecognized or unsupported WCF Version |
| | number. |
| | Additional data bytes: none. |
| 2 | Device Transport Change |
| | The On-board architecture Device either: |
| | Received a message addressed to a different |
| | DeviceID |
| | Determined that the transport-specific address of |
| | the device had changed. |
| | Additional data bytes: none |
| | This message is sent with send option |
| | WCFSendOption_Transport_Specified so that the |
| | message will be received on the affected transport. |
| 3 | Unrecognized System Message |
| | The On-board architecture Device received a system |
| | message that may have an unrecognized System |
| | Message ID (i.e. not an |
| | EWCF2SystemAppMessageType) . . . |
| | Additional data bytes: |
| | System Message ID of unrecognized message |
| | (1 byte). |
| 4 | WCF Ping Request |
| | This message can be initiated by either On-board |
| | architecture or Server . . . A WCF Ping Response |
| | message may be sent in response to this message |
| | Additional data bytes: |
| | EWCFServiceType to be used by WCF Ping |
| | Response (1 byte) |
| | Priority level to be used by WCF Ping Response |
| | (1 byte) |
| | Other (arbitrary bytes) |
| 5 | WCF Ping Response |
| | This message may be sent in response to a WCF Ping |
| | Request. |
| | Additional data bytes: |
| | Other (arbitrary bytes) as supplied in the WCF |
| | Ping Request message |
| 6 | Get Message Counts |
| | WCFMessageDirection_On-board architectureToServer: |
| | The On-board architecture Device is sending a |
| | GetMessageCounts message. |
| | Additional data bytes: none |
| | WCFMessageDirection_ServerToOn-board architecture: |
| | The On-board architecture Device sent a |
| | GetMessageCounts message. |
| | Additional data bytes: |
| | Result of WCF_GetUnreadMessageCount( ) (4 |
| | bytes) |
| | Result of WCF_GetUnsentMessagCount( ) (4 |
| | bytes) |
| 7 | InitializationFailure |
| | This message may be initiated by the on-board |
| | architecture, hence it's always an On-board architecture |
| | to Server message. |
| | Additional data bytes: |
| | Result of initialization failure(4 bytes) |

iv. Ack/NAck Messages

Ack/NAck messages may be identified as Message Type 1. An Ack/NAck message with empty content (length=0) may be an Ack message. An Ack/NAck message with non-empty content may be identified by its first byte. The remaining content depends on the specific Ack type. Some Ack/NAck message types and corresponding identification numbers are listed in Table 30. Other Ack/NAck message and corresponding identification numbers are possible as well.

TABLE 30

| Ack/ | |
|---|---|
| NAck | |
| Type | Name |
| 1 | WCFAckType_NackEmptySequencePool |
| | NAck: Message received into empty sequence pool. |
| | A receiving WCF sends this NAck if it receives a message (not |
| | containing resequence information) into a reliable or ordered |
| | delivery sequence pool for which there is no record of what the |
| | current sequence number should be. |
| | A sending WCF, on receipt of this NAck and matching it to an |
| | unacknowledged outbox app message, may initiate resequencing |
| | for the sequence pool in question. |

(u) WCF Packet Formats—Version 2

WCF Messages may be formatted into WCF Packets for delivery over the transport modules 906a, 908a. This formatting takes place immediately before the WCF packet is sent to the transport modules 906a, 908a. The WCF Packet may include one or more of the fields shown in TABLE 31.

TABLE 31

| Position | Field | Description |
|---|---|---|
| Byte 0 Bits 0-3 | WCF Version | The version of the WCF Packet format. |
| | | This version number identifies the |
| | | format of the packet. A receiving WCF |
| | | must only attempt to decode the |
| | | packet if the version number is |
| | | recognized. |
| | | Note that Bit 3 can be used to indicate |
| | | an “extended” version number (i.e. |
| | | more version number bits elsewhere in |
| | | the packet) if it becomes necessary to |
| | | extend beyond versions 0-7. |
| Byte 0 Bits 4-7 | Packet Type | An enumerated value indicating the |
| | | type of this packet. |
| | | 0 - Single App Message (Message |
| | | Type = App Message) |
| | | 1 - Single Ack Message (Message |
| | | Type = Ack Message) |
| | | 2 - Single Multi-Part Message Part |
| | | (Message Type = Multi-Part Message) |
| | | 8 - Packaged Message (contains |
| | | multiple messages) |

i. Single Application Message and Single Ack Message

For Single Application Message, Single Ack Message, and Single Multi-Part Message Part, the Packet Identification Byte may be followed by the Standard Header as shown in the Table 32.

TABLE 32

| Position | Field | Description |
|---|---|---|
| Byte 1 Bits 0-1 | Length Flag | 0 - Length not included |
| | | 1 - 1 byte Length included |
| | | 2 - 2 byte Length included |
| Byte 1 Bit 2 | Re-Sequence Flag | If set, this message may be part of a |
| | | Sequence Number Recovery and |
| | | include the SequenceSeed and |
| | | SequenceTag fields. |
| Byte 1 Bit 3 | CRC Flag | If set, this packet may have a trailing |
| | | 2-byte CRC, otherwise the transport |
| | | module might not guaranteed to not to |
| | | corrupt the message. |
| Byte 1 Bits 4-5 | Device ID Flag | 0 - Device ID may be omitted (note: |
| | | this reserves the capability to omit |
| | | Device ID as a space optimization.) |
| | | 1 - 2 byte Device ID |
| | | 2 - 3 byte Device ID |
| | | 3 - 4 byte Device ID |
| Byte 1 Bits 6-7 | Unused | Reserved, may be 0. |
| | | May be used for Compression & |
| | | Encryption flags. |
| Bytes 2-A | Length | Length of the entire WCF Packet. |
| | | 0 to 2 bytes, LSB first, depending on |
| | | the value of the length flag. |
| Bytes A + 1-B | DeviceID | Device ID - the WCF On-board |
| | | architecture that is the source or |
| | | destination of the message. |
| | | 0 to 4 bytes, depending on the value |
| | | of the Device ID flag. |
| Bytes B + 1-C | SequenceSeed | 2 bytes, LSB first, may be present if |
| | | the Re-Sequence flag is set. |
| Bytes C + 1-D | SequenceTag | 4 bytes, LSB first, may be present if |
| | | the Re-Sequence flag is set. |
| Byte D + 1 Bit 7 | Unused | Reserved, may be 0 |
| | | Can be growth for Message Service |
| | | field. |
| Byte D + 1 Bits 5-6 | Message Service | 0 - Unreliable Delivery |
| | | 1 - Reliable Delivery |
| | | 2 - Ordered Delivery |
| | | 3 - Reserved |
| Byte D + 1 Bits 0-4 | Message Priority | 0-31 |
| Bytes D + 2-E | Sequence Number | 2 bytes, LSB first |
| | | Not present for Message Service = Unreliable |
| | | Delivery |

Single Application Message may contain the destination application ID as shown in Table 33.

TABLE 33

| Position | Field | Description |
|---|---|---|
| Byte E + 1 | Application ID | Destination Application ID |

Single Application and Single Ack Messages may contain the payload as shown in Table 34:

TABLE 34

| Position | Field | Description |
|---|---|---|
| Bytes E + 2-F | Content | Client message bytes. |
| | | May be empty. |

Single Multi-Part Message Part may contain the message pay load shown in Table 35.

TABLE 35

| Position | Field | Description |
|---|---|---|
| Byte E + 1 | Flags | Bit 0: Size of sub-blocks |
| | | 0: 16 bytes |
| | | 1: 32 bytes |
| | | Bit 1: Size of “offset” |
| | | 0: 1 byte |
| | | 1: 2 bytes |
| | | Bits 2-3: Size of “number of sub- |
| | | blocks” |
| | | 0: 1 byte |
| | | 1: 2 bytes |
| | | 2: Not present |
| | | Bits 4-5: Ack Request |
| | | 0: Don't Ack this part |
| | | 1: Ack just this part |
| | | 2: Ack this part with current |
| | | status |
| | | 3: Unused, reserved |
| | | Bit 6: Last Part |
| | | 0: Not the last part |
| | | 1: The last part |
| | | Bit 7: Unused, must be 0 |

The following byte only present if Flags (above) bits 4-5 indicate Ack
type 2 (Ack this part with current status.

| | | |
|---|---|---|
| E + 2-E₁ 1 Byte | Ack sequence # | Sequence number to be included in |
| | | Ack/NAck reply. |
| E₁ + 1-E₂ 1 or 2 | Offset of | Offset of this block within the |
| Bytes | this Block | message. |
| E₂ + 1-E₃ 1 or 2 | Number of | The number of sub-blocks. |
| Bytes | Sub-Blocks | |

The following byte only present when the ‘Last’ flag is set.

| | | |
|---|---|---|
| E₃ + 1-E₄ 1 Byte | Application ID | The application to which the message |
| | | is being sent. |

The following bytes only present when data is being sent/resent.

| | | |
|---|---|---|
| Bytes E₄ + 1-F | Data | N sub-blocks of data |
| | | If the Last Part flag is set, no more |
| | | data follows this set of sub-blocks, |
| | | otherwise the data must be a multiple |
| | | of the sub-block size. |

Single Multi-Part Ack Message may contain the Ack message payload as shown in Table 36.

TABLE 36

| Position | Field | Description |
|---|---|---|
| E + 1 1 Byte | Ack Message | Multi Part Ack Message |
| | Type | |
| E + 2 1 Byte | Flags | Echo the flags of the Part Message |
| | | Size of “offset” may be different |
| | | in order to accommodate the list |
| | | of offsets in this message. |

If in response to “Ack Just This Part”:

| | | |
|---|---|---|
| E + 3-E₁ 1 or 2 | Offset of block | Offset of the block being |
| Bytes | | acknowledged |
| E₁ + 1-F 1 Byte | Number of sub- | Number of sub-blocks received at |
| | blocks received | that offset (i.e. the N from N Blocks |
| | | of Data) |
| | | 0 if data at the specified offset was |
| | | not received (i.e. this is a NAck). |

If in response to “Ack this part with
current status”:

| | | |
|---|---|---|
| E + 3 1 Byte | Ack | Sequence number passed in the |
| | Sequence # | request. |
| E + 4-E₁ 1 or 2 | Offset of block | 1 + the offset of the highest |
| Bytes | | sub-block received. |

Missing blocks: repeat the following for each missing set of blocks
(E₁ + 1-F)

| | | |
|---|---|---|
| E₁ + 1-E₂ 1 or 2 | Offset of block | Offset of the missing block within the |
| Bytes | | message. |
| E₂ + 1 1 Byte | Size of block | Number of sub-blocks missing |

Single App Message, Single Ack Message and Single Multi-art Message Part with a CRC flag may contain a two-byte CRC as shown in Table 37.

TABLE 37

| Position | Field | Description |
|---|---|---|
| Bytes F + 1-F + 2 | CRC-16 | 2 Byte CRC, present only if the CRC |
| | | Flag is set. |
| | | Algorithm: CRC-CCITT (Same as |
| | | e-Technician OBU Message). |
| | | Stored MSB first to allow CRC to be |
| | | run over entire packet. |

ii. Packaged Message

In the case of Packet Type set to Packaged Message, the SequenceSeed and SequenceTag parameters may be duplicated by multiple messages within the Packaged Message. For space optimization purposes, the first values seen may be incorporated into the header of the Packaged Message, and then each contained message flagged as to whether it may inherit values from the header of the Packaged Message.

Contained messages may all share the same Device ID. For Packaged Messages, the Packet Identification Byte may be followed by the Packaged Message Header. This header may be similar to the Standard Header. The Packaged Message Header may include (I) a flag that may be used to capture whether Application ID is present in the header, allowing duplicate Application ID bytes to be dropped from contained messages, and (i) the Message Identification fields (e.g., Message Service, Priority, and/or Sequence Number) may be omitted because they can be different for each contained message.

The Packaged Message Header may include one or more of the fields shown in Table 38.

TABLE 38

| Position | Field | Description |
|---|---|---|
| Byte 1 Bits 0-1 | Length Flag | 0 - Length not included |
| | | 1 - 1 byte Length included |
| | | 2 - 2 byte Length included |
| Byte 1 Bits 2-3 | Re-Sequence | If set, this message may be part of a |
| | Flag | Sequence Number Recovery and |
| | | includes the SequenceSeed and |
| | | SequenceTag fields. |
| Byte 1 Bit 3 | CRC Flag | If set, this packet may be a trailing 2- |
| | | byte CRC. |
| Byte 1 Bits 4-5 | Device ID Flag | 0 - Device ID may be omitted (note: |
| | | this reserves the capability to omit |
| | | Device ID as a space optimization.) |
| | | 1 - 2 byte Device ID |
| | | 2 - 3 byte Device ID |
| | | 3 - 4 byte Device ID |
| Byte 1 Bit 6 | Application | If set, the Application ID field may be |
| | ID Flag | present in the header. |
| Byte 1 Bit 7 | Unused | Reserved, may be 0. |
| Bytes 2-A | Length | Length of the entire WCF Packet. |
| | | 0 to 2 bytes, LSB first, depending on |
| | | the value of the length flag. |
| Bytes A + 1-B | DeviceID | Device ID - the WCF On-board |
| | | architecture that is the source or |
| | | destination of the message. |
| | | 0 to 4 bytes, depending on the value |
| | | of the Device ID flag. |
| Bytes B + 1-C | SequenceSeed | 2 bytes, LSB first, may be present if |
| | | the Re-Sequence flag is set. |
| Bytes C + 1-D | SequenceTag | 4 bytes, LSB first, may be present if |
| | | the Re-Sequence flag is set. |
| Byte D + 1 | Application ID | Destination Application ID, may be |
| | | present if the Application ID Flag is set. |

Each contained message may include one or more of the fields shown in TABLE 39.

TABLE 39

| Position | Field | Description |
|---|---|---|
| Byte 0 Bit 0 | Contained Length | Indicates how many bytes follow for |
| | Flag | the length of the contained message. |
| | | For Message Type App Message: |
| | | 0 - 1 byte Contained Length |
| | | 1 - 2 bytes Contained Length |
| | | For Message Type Ack Message: |
| | | 0 - 0 bytes Contained Length (i.e. |
| | | Content field is empty and has a length |
| | | of 0). |
| | | 1 - 1 byte Contained Length |
| | | Note: Ack messages may be limited to |
| | | 255 bytes of content. |
| | | For Multi-Part Message Part: |
| | | 0, 1 - Not Used. |
| Byte 0 Bit 1-2 | Message Type | An enumerated value indicating the |
| | | type of this contained message. |
| | | 0 - App. Message |
| | | 1 - Ack Message |
| | | 2 - Multi-Part Message Part |
| | | 3 - Reserved |
| Byte 0 Bits 3-4 | Inherit Re-Sequence | 0 - the contained message might not |
| | Flag | contain or inherit the re-sequence |
| | | fields Resequence Flag, |
| | | SequenceSeed and SequenceTag. |
| | | When extracted, Resequence may be |
| | | set to false. |
| | | 1 - The contained message may |
| | | inherit the Resequence Flag, |
| | | SequenceSeed and SequenceTag |
| | | fields from the Packaged Message |
| | | Header. |
| | | 2 - The contained message may have |
| | | Resequence Flag set to true and |
| | | contains its own values for |
| | | SequenceSeed and SequenceTag. |
| Byte 0 Bit 5 | Inherit Application | 0 - this contained message may have |
| | ID Flag | its own value for Application ID, if it is |
| | | of type App Message. |
| | | 1 - This contained message may |
| | | inherit the Application ID field from the |
| | | Packaged Message Header, if this |
| | | message may be of type App |
| | | Message. |
| | | Messages of types other than App |
| | | Message might not contain or inherit |
| | | Application ID. |
| Byte 0 Bit 6 | Unused | Reserved, set to 0. |
| | | The Compression Enabled flag may be |
| | | placed here. |
| Byte 0 Bit 7 | Unused | Reserved, set to 0. |
| | | The Encryption Enabled flag may be |
| | | placed here. |
| Bytes 1-B | Contained Length | Length of the Content part of the |
| | | message. This may be the length of |
| | | the content field only, and might not |
| | | include the length and flag bytes. |
| | | 0 to 2 bytes, LSB first, depending on |
| | | the value of the contained length flag. |
| Bytes B + 1-C | SequenceSeed | 2 bytes, LSB first, may be present if |
| | | the flags indicate that this contained |
| | | message has its own value for this |
| | | field. |
| Bytes C + 1-D | SequenceTag | 4 bytes, LSB first, may be present if |
| | | the flags indicate that this contained |
| | | message has its own value for this |
| | | field. |
| Byte D + 1 Bit 7 | Unused | Reserved, Must be 0 |
| | | Can be growth for Message Service |
| | | field. |
| Byte D + 1 Bits 5-6 | Message Service | 0 - Unreliable Delivery |
| | | 1 - Reliable Delivery |
| | | 2 - Ordered Delivery |
| | | 3 - Reserved |
| Byte D + 1 Bits 0-4 | Message Priority | 0-31 |
| Bytes D + 2-E | Sequence Number | 2 bytes, LSB first |
| | | Not present for Message Service = Unreliable |
| | | Delivery |

Contained Application Message may contain the destination application ID as shown in TABLE 40.

TABLE 40

| Position | Field | Description |
|---|---|---|
| Byte E + 1-F | Application ID | Destination Application ID |
| | | Only present if the flags indicate that |
| | | this message does not inherit the value |
| | | from the Packaged Message Header. |

Contained Application and/or Ack Messages may contain the message payload fields as shown in Table 41.

TABLE 41

| Position | Field | Description |
|---|---|---|
| Bytes F + 1-G | Content | Client message bytes |

Contained Multi-Part Message parts may contain one or more of the message payload fields shown in Table 42.

TABLE 42

| Position | Field | Description |
|---|---|---|
| Byte E + 1 | Flags | Bit 0: Size of sub-blocks |
| | | 0: 16 bytes |
| | | 1: 32 bytes |
| | | Bit 1: Size of “offset” |
| | | 0: 1 byte |
| | | 1: 2 bytes |
| | | Bits 2-3: Size of “number of sub- |
| | | blocks” |
| | | 0: 1 byte |
| | | 1: 2 bytes |
| | | 2: Not present |
| | | Bits 4-5: Ack Request |
| | | 0: Don't Ack this part |
| | | 1: Ack just this part |
| | | 2: Ack this part with current |
| | | status |
| | | 3: Unused, reserved |
| | | Bit 6: Last Part |
| | | 0: Not the last part |
| | | 1: The last part |
| | | Bit 7: Unused, must be 0 |

The following byte only present if Flags (above) bits 4-5
indicate Ack type 2 (Ack this part with current status.

| | | |
|---|---|---|
| E + 2-E₁ 1 Byte | Ack sequence # | Sequence number to be included in |
| | | Ack/NAck reply. |
| E₁ + 1-E₂ 1 or 2 | Offset of this | Offset of this block within the |
| Bytes | Block | message. |
| E₂ + 1-E₃ 1 or 2 | Number of | The number of sub-blocks. |
| Bytes | Sub-Blocks | |

The following byte only present when the ‘Last’ flag is set.

| | | |
|---|---|---|
| E₃ + 1-E₄ 1 Byte | Application ID | The application to which the message |
| | | is being sent. |

The following bytes only present when data is being sent/resent.

| | | |
|---|---|---|
| Bytes E₄ + 1-G | Data | N sub-blocks of data |
| | | If the Last Part flag is set, no more |
| | | data follows this set of sub-blocks, |
| | | otherwise the data must be a multiple |
| | | of the sub-block size. |

Single Multi-Part Ack Message may contain the one or more of the Ack message payload fields shown in Table 43.

TABLE 43

| Position | Field | Description |
|---|---|---|
| E + 1 1 Byte | Ack Message | Multi Part Ack Message |
| | Type | |
| E + 2 1 Byte | Flags | Echo the flags of the Part Message |
| | | Size of “offset” may be different |
| | | in order to accommodate the list |
| | | of offsets in this message. |

If in response to “Ack Just This Part”:

| | | |
|---|---|---|
| E + 3-E₁ 1 or 2 | Offset of block | Offset of the block being |
| Bytes | | acknowledged |
| E₁ + 1-G 1 | Number of sub- | Number of sub-blocks received at that |
| Byte | blocks received | offset (i.e. the N from N Blocks of |
| | | Data) |
| | | 0 if data at the specified offset was |
| | | not received (i.e. this is a NAck). |

If in response to “Ack this part with current status”:

| | | |
|---|---|---|
| E + 3 1 Byte | Ack | Sequence number passed in the |
| | Sequence # | request. |
| E + 4-F 1 or 2 | Offset of block | 1 + the offset of the highest sub-block |
| Bytes | | received. |

Missing blocks: repeat the following for each missing
set of blocks (F + 1-G)

| | | |
|---|---|---|
| F₁ + 1-F₂ 1 | Offset of block | Offset of the missing block within the |
| or 2 Bytes | | message. |
| F₂ + 1 1 Byte | Size of block | Number of sub-blocks missing |

Messages with a CRC flag set may contain a two-byte CRC as shown in Table 44. Other flag sets are possible as well.

TABLE 44

| Position | Field | Description |
|---|---|---|
| Bytes G + 1-G + 2 | CRC-16 | 2 Byte CRC, present only if the CRC |
| | | Flag is set. |
| | | Algorithm: CRC-CCITT (Same as |
| | | e-Technician OBU Message). |
| | | Stored MSB first to allow CRC to be |
| | | run over entire packet. |

iii. System Messages

A system message may be an Application Message addressed to Application ID 0. The first byte of the system message may identify the type of the system message and thereby it's content. Table 45 lists some of the system messages and corresponding system identification number. Other System messages and corresponding identification numbers are possible as well.

TABLE 45

| System | |
|---|---|
| Message ID | Name |
| 0 | WCF Filler |
| | This message may have no content |
| | Additional data bytes: none. |
| 1 | WCF Version Mismatch |
| | The On-board architecture device received a message |
| | with an unrecognized or unsupported WCF Version |
| | number. |
| | Additional data bytes: none. |
| 2 | Device Transport Change |
| | The On-board architecture Device either: |
| | Received a message addressed to a different |
| | DeviceID |
| | Determined that the transport-specific address of |
| | the device had changed. |
| | Additional data bytes: none |
| | This message is sent with send option |
| | WCFSendOption_Transport_Specified so that the |
| | message will be received on the affected transport. |
| 3 | Unrecognized System Message |
| | The On-board architecture Device received a system |
| | message that may have an unrecognized System |
| | Message ID (i.e. not an |
| | EWCF2SystemAppMessageType) . . . |
| | Additional data bytes: |
| | System Message ID of unrecognized message |
| | (1 byte). |
| 4 | WCF Ping Request |
| | This message can be initiated by either On-board |
| | architecture or Server.. A WCF Ping Response |
| | message may be sent in response to this message |
| | Additional data bytes: |
| | EWCFServiceType to be used by WCF Ping |
| | Response (1 byte) |
| | Priority level to be used by WCF Ping Response |
| | (1 byte) |
| | Other (arbitrary bytes) |
| 5 | WCF Ping Response |
| | This message may be sent in response to a WCF Ping |
| | Request. |
| | Additional data bytes: |
| | Other (arbitrary bytes) as supplied in the WCF |
| | Ping Request message |
| 6 | Get Message Counts |
| | WCFMessageDirection_On-board architectureToServer: |
| | The On-board architecture Device is sending a |
| | GetMessageCounts message. |
| | Additional data bytes: none |
| | WCFMessageDirection_ServerToOn-board architecture: |
| | The On-board architecture Device sent a |
| | GetMessageCounts message. |
| | Additional data bytes: |
| | Result of WCF_GetUnreadMessageCount( ) (4 |
| | bytes) |
| | Result of WCF_GetUnsentMessagCount( ) (4 |
| | bytes) |
| 7 | InitializationFailure |
| | This message may be initiated by the on-board |
| | architecture. |
| | Additional data bytes: |
| | Result of initialization failure(4 bytes) |

iv. Ack/NAck Messages

Ack/NAck messages may be identified as Message Type 1. An Ack/NAck message with empty content (length=0) may be an Ack message. An Ack/NAck message with non-empty content may be identified by its first byte. The remaining content depends on the specific Ack type. Some Ack/NAck message types and corresponding identification numbers are listed in Table 46. Other Ack/NAck message and corresponding identification numbers are possible as well.

TABLE 46

| Ack/NAck | |
|---|---|
| Type | Name |
| 1 | WCFAckType_NackEmptySequencePool |
| | NAck: Message received into empty sequence pool. |
| | A receiving WCF sends this NAck if it receives a message |
| | (not containing resequence information) into a reliable |
| | or ordered delivery sequence pool for which there is |
| | no record of what the current sequence number |
| | should be. |
| | A sending WCF, on receipt of this NAck and matching it |
| | to an unacknowledged outbox app message, may |
| | initiate resequencing for the sequence pool in question. |
| 2 | Multi-Part Ack Message |

(v) Services Provided by the WCF Architecture

The following sections identify the services exposed by the architecture of the WCF. In one exemplary embodiment, the off-board architecture may be implemented as component object model (“COM”) objects. The on-board architecture may be implemented as C++ classes. Other platforms may be used aw well.

i. WCF Send API

WCF Send API component 902a may be a component used by the client to send messages. It may expose one or more of the following services:
SendMessage
   Purpose: Send a message
   Input Parameters:
      The WCF Message
   Output Parameters:
      The Message Tag
GetMaxMessageSizes
   Purpose: Determine the largest messages that can be sent using all/one of the existing transport modules in the current system. A message of the returned ‘all’ size or smaller can be sent on all currently installed transports. A message of the returned ‘one’ size or smaller can be sent on at least one currently installed transport.
   Input Parameters:
      The Device ID for which to retrieve sizes (Server side only; On-board architecture side assumes ‘self’)
   Output Parameters:
      Maximum message size that can be sent on all transports
      Maximum message size that can be sent on at least one transport
   Notes:
      Support of this function on WCF Server requires that the WCF Transport information (table) include the transport max packet size, which can be obtained from the transport module when it is first run. It may also be store the Length/CRC included flags. On WCF On-board architecture, the Transport Module can be queried directly.
      The returned sizes may be adjusted for the WCF Packet overhead. It may specify some of the message parameters (message service, priority, etc.) to determine the packet overhead based on factors such as:
         What fields will be required in the message
         Will the message carry the overhead of a re-sequence operation.
      An alternative approach may be to calculate the maximum overhead and calculate the max packet size based on that value. This might not make optimum use of the transport packets and so may be avoided if possible.

ii. WCF Receive API

The WCF Receive API component 902b may be a component that a client instantiates in order to poll for messages or subscribe for notification of messages. It may expose the following services:
GetMessage
   Purpose: Get the first available message deliverable to this application.
   Input Parameters:
      The Application ID of the calling application
   Output Parameters:
      A WCF Message (or none, if no message available)
   Notes:
      A successful call to GetMessage might not mark the message as delivered and might not release subsequent ordered delivery messages. The caller may call ProcessedMessage to indicate successful processing. Subsequent calls to GetMessage without calling ProcessedMessage may retrieve the same message, if it is still the highest priority undelivered message.
ProcessedMessage
   Purpose: Mark a message as delivered and release any subsequent ordered delivery message.
   Input Parameters:
      Message Tag and Device ID (Server side only) of the message retrieved using GetMessage.
   Output Parameters:
      None
AdviseMessages
   Purpose: Subscribe for notification of message arrival.
   Input Parameters:
      The Application ID of the calling application
      A reference to a notification sink on which arrival will be notified
   Output Parameters:
      A cookie to reference the subscription
   Notes:
      WCF Receive API is anticipated to be an in-process component. Within a single process, one subscriber to any given Application ID is permitted. WCF Receive API may not have the ability to detect subscriptions from multiple processes or machines; such multiple subscriptions could result in the same message being retrieved by multiple subscribers, or messages being somewhat interleaved between the subscribers.
UnadviseMessages
   Purpose: Unsubscribe for notification of message arrival.
   Input Parameters:
      The Application ID of the calling application
   Output Parameters:
      None

iii. Message Notification Sink

A client application may implement this interface to subscribe to the notification mechanism of the WCF Receive API component 902b.
OnMessageAvailable
   Purpose: Notify the client that a message is available. The client may call GetMessage to retrieve the message.
   Input Parameters:
      The Application ID for which a message is available.
   Output Parameters:
      None
   Notes:
      WCF Receive API (when subscribed to for notifications) may run an internal thread that polls the database periodically for undelivered messages. If any such messages exist, it may notify the subscriber. The subscriber may call GetMessage/ProcessedMessage repeatedly until no more messages remain. GetMessage/ProcessedMessage may be called from within the notification.

iv. WCF Delivery Agent

The message-delivery agent 902d may be specific to platforms that support COM. It may be implemented on the off-board architecture, and supported for on-board architecture on platforms such as Windows and Windows CE/PocketPC.

The message-delivery agent 902d may push received messages to destination applications on the basis of a mapping from Application ID to CLSID. The message-delivery agent 902d may be loaded and run by a service process for the WCF 900. The message-delivery agent 902d may expose the following services:
Initialize
   Purpose: Read the local configuration from the registry and begin delivering messages.
   Input Parameters:
      None.
   Output Parameters:
      None
   Notes:

This function may start an internal thread that belongs to the COM MTA. This thread may periodically poll the database for undelivered messages and attempt to deliver them to the specified message recipients.
Shutdown
   Purpose: Stop delivering messages.
   Input Parameters:
      None.
   Output Parameters:
      None

v. Message Delivery Sink

This interface may be implemented by a component that cam receive messages via the message-delivery agent 902d. It may expose the following services:
OnMessage
   Purpose: Deliver a message to the client.
   Input Parameters:
      A WCF Message.
   Output Parameters:
      None
   Returns:
      S_OK—the message was processed successfully, or could not and will not be processed and is being discarded. The message may be marked as delivered, and any subsequent ordered delivery message may be released.
      S_WCF_DEFERRED_DELIVERY—the message was accepted for processing. The message may be marked as delivered, but any subsequent ordered delivery message shall not yet be released for delivery. The application promises to subsequently call the Deferred Delivery Helper to release any subsequent message.
      E_WCF_DISABLE_DELIVERY—the application cannot accept messages at this time. Don't deliver any more messages until delivery is explicitly enabled.
      E_xxx—message delivery failed, the Message Delivery Agent should try again later.
   Notes:
      In one exemplary embodiment, the Message Delivery Agent may deliver each message through the following steps:
         Map Application ID to the registered CLSID
         CoCreateInstance on the CLSID to create the recipient object
         Invoke the OnMessage method on the recipient object
         Update the message status as indicated by the result of OnMessage
         Release the recipient object
      A feature to support a COM+ Queued Component as the delivery target is to support a configuration setting that directs the delivery agent to assume S_OK really means S_WCF_DEFERRED_DELIVERY.
      The initial Delivery Agent may run a single thread to deliver messages. Subsequent enhancements may include use of a thread pool. Since ordered delivery control may be managed, the destination application may be protected from concurrently receiving ordered delivery messages in the same ordered delivery sequence. The thread pool will allow greater concurrency of delivery, which may be especially useful for applications that block for I/0 on the node processing delivery.

vi. Deferred Delivery Helper

This Deferred Delivery Helper may instantiated and invoked from an application to release ordered delivery when a delivered message was responded to with S_WCF_DEFERRED_DELIVERY. The Deferred Delivery Helper may expose the following service.
CompleteDeferredDelivery
   Purpose: Release subsequent ordered delivery messages.
   Input Parameters:
      Device ID of receive message (WCF Server only)
      Message Tag of received message
   Output Parameters:
      None

vii. Delivery Control API

The Delivery Control API may configure and control message delivery to applications via the message-delivery agent 902d. The Delivery Control API may expose the following services.
SetTargetApplication
   Purpose: Configure an application for receiving messages.
   Input Parameters:
      Application ID
      Node name on which to deliver messages
      Moniker for target component
      Current enabled status
   Output Parameters:
      None
DropTargetApplication
   Purpose: Remove an application for receiving messages.
   Input Parameters:
      Application ID
   Output Parameters:
      None
EnableTargetApplication
   Purpose: Enable an application for receiving messages.
   Input Parameters:
      Application ID
   Output Parameters:
      None
DisableTargetApplication
   Purpose: Disable an application for receiving messages.
   Input Parameters:
      Application ID
   Output Parameters:
      None
GetTargetApplications
   Purpose: Return a list of target applications and settings.
   Input Parameters:
      None
   Output Parameters:
      List of target applications

viii. On-board architecture Control API

The On-board architecture Control API may provide the client with control over the WCF. It may include the following services.
Initialize
   Purpose: Initialize WCF.
Shutdown
   Purpose: Shutdown WCF.
GetTransports
   Purpose: Get a list of available transports.
GetTransportStatus
   Purpose: Get the status and signal strength of each transport.

ix. Device Management API

The Device Management API may provide methods for managing information about the off-board architecture, including their addresses. This API may provide the implementation of IWCFHostAddressUpdate as documented in the Error! Reference source not found. Error! Reference source not found., which is incorporated herein by reference in its entirety. This interface may provide UpdateDeviceAuxAddress, which may be used to update the auxiliary address data for a device.

x. Message Manager

The Message Manager may process (i) received messages, (ii) timed events for outgoing messages (for events such as Queued, Timeout, Escalation), and (iii) transport events for outgoing messages (for events such as Sent, Delivery Error). These activities can be combined for the on-board architecture. The off-board architecture may keep these functions separated.

xi. Message Manager Receiver

The Message Manager Receiver component may handle incoming messages. It may expose the following service.
OnMessage
   Purpose: Deliver a message to the Message Manager Receiver.
   Input Parameters:
      A WCF Message, including extended properties.
   Output Parameters:
      None

xii. Message Manager Agent

The Message Manager Agent component may periodically query the OutBox 904b for queued messages and messages whose escalation time has expired. It also may periodically query the transport queues 904e for messages that have timed out. It may notify the RREM 912 of such messages to allow the RREM 912 to decide what action to take for each message.

For the off-board architecture, the Message Manager Agent may be loaded and run by a service process for the WCF 900. The Message Manager Agent may expose the following services:
Initialize
   Purpose: Begin polling for messages to process
   Input Parameters:
      None.
   Output Parameters:
      None
   Notes:
      This function may start an internal thread that belongs to the COM MTA. This thread may periodically poll the database for relevant messages and process them through the RREM.
Shutdown
   Purpose: Stop processing messages.
   Input Parameters:
      None.
   Output Parameters:
      None

xiii. Message Manager Event Handler

The Message Manager Event Handler component may be invoked by a transport to handle transport-related events, and by the message manager agent to handle other events. It may expose the following services:
OnMessageSent
   Purpose: Handle notification that a message was successfully sent via a transport.
   Input Parameters:
      Device ID of the message (WCF Server Only).
      Message Tag of the message
      Transport ID of the transport
   Output Parameters:
      None
OnDeliveryError
   Purpose: Handle notification that a delivery error was reported by a transport.
   Input Parameters:
      Device ID of the message (WCF Server Only).
      Message Tag of the message
      Transport ID of the transport
      Indication of whether the error is recoverable or fatal
      Transport-specific error code
   Output Parameters:
      None
OnMessageStatus
   Purpose: Handle notification of message status from a transport.
   Input Parameters:
      Device ID of the message (WCF Server Only).
      Message Tag of the message
      Transport ID of the transport
      Transport-specific status code
   Output Parameters:
      None
OnMessageManagerAgentEvent
   Purpose: Handle notification that the message manager agent wants a message processed.
   Input Parameters:
      The Event, one of:
         Queued (the message was queued to be sent)
         Timeout (a timeout occurred in a transport queue)
         Escalation (the escalation time was reached)
      Device ID and Message Tag of the message
      Transport ID of the transport on which the timeout occurred (Timeout only)
   Output Parameters:
      None

xiv. Message Manager Multi-Part Helper
OnMessage
   Purpose: Handle processing of multi-part messages for the Message Manager.
   Input Parameters:
      The WCF message with Multi-Part message extended information.
   Output Parameters:
      None
OnAck
   Purpose: Handle processing of a received multi-part message acknowledgement.
   Input Parameters:
      The WCF message with Multi-Part extended information.
   Output Parameters:
      None

xv. Message Storage Manager

The Message-Storage Manager 904f may abstract access to the InBox 904a, OutBox 904b, and Transport Queue 904e. It also may have access to the Device, Transport, and Device Transport storage tables. Its responsibilities may include (i) managing the storage of messages and message status, (ii) assigning sequence numbers and determining when sequence number recovery is necessary, (iii) providing query access to messages and message properties, and (iv) providing methods to update messages. For efficient access, various storage managers may be combined.

The Message-Storage Manager 904f may expose the following services.
GetOutBoxMessage
   Purpose: Obtain the properties of a message in the OutBox, optionally provide transport queue information for a specified or all transport queues.
UpdateOutBoxMessage
   Purpose: Update the properties of a message in the OutBox, optionally update transport queue information for specified transport queues. If a message is marked as Sent, clear any resequence operation associated with the same Sequence Pool.
UpdateOutBoxMPMessage
   Purpose: Update the multi-part specific properties of a Multi-Part message in the OutBox.
SaveOutBoxMessage
   Purpose: Create a new message in the OutBox, if necessary, assign a sequence number, and initiate a re-sequence operation.
GetInBoxMessage
   Purpose: Obtain the properties of a message in the InBox.
UpdateInBoxMessage
   Purpose: Update the properties of a message in the InBox.
UpdateInBoxMPMessage
   Purpose: Update the multi-part specific properties of Multi-Part InBox message.
SaveInBoxMessage
   Purpose: Create a message in the InBox, optionally handle any instructed re-sequencing operation. This function may also check whether the message lies within the expected receive window and return an indication of the message's status.
CompleteDeferredDelivery
   Purpose: Release subsequent ordered delivery message for a delivered InBox message.
GetRREMMessages
   Purpose: Get a list (with a specified maximum size) of message identifications for messages that may be processed by the RREM because they are Queued or their Escalation/Timeout periods have expired.
GetTransportQueueDevicesForSend
   Purpose: Get a list (with a specified maximum size) of Device IDs to which messages are available to be sent (based on status and expired trigger time) for a specified transport.
GetTransportMessagesForSend
   Purpose: Get a list (with a specified maximum size) of message information (message identification, priority, transport priority, flags, size, etc.) needed by the Transport Send Agent to group messages for sending to a specified device over a specified transport.
GetTransportQueueDeviceWindow
   Purpose: Obtain the current message count in the send window for a specified Device ID and transport. Along the way, update the Transport Queue for messages that can be dropped from the window.
GetDeliverableMessagesByApp
   Purpose: Get a list (with a specified maximum size) of message identifications for messages that are available to be delivered. This form allows an application ID to be passed to retrieve messages.
GetDeliverableMessagesByNode
   Purpose: WCF Server only: Get a list (with a specified maximum size) of message identifications for messages that are available to be delivered, for a specified node.
GetDeviceTransports
   Purpose: Get a list of transports that can be used with a specified device. Also return transport properties.
GetTransportProperties
   Purpose: Get properties of a specified transport.
UpdateDeviceTransport
   Purpose: Update a device/transport association and properties.
SaveTargetApplication
   Purpose: Save a target application and its settings.
RemoveTargetApplication
   Purpose: Remove a target application and its settings.
UpdateTargetApplication
   Purpose: Update a target application and its settings.
GetPendingBlockListForMessage
   Purpose: For a particular OutBox message, return a list of blocks sent, but not yet acknowledged.
UpdateTransportQueueMPMessage
   Purpose: Update the multi-part specific information for a specific Transport Queue message.

xvi. Off-Board Architecture Transaction Support

The off-board architecture may support transactions for message-specific operations. In general, retrieval operations may be non-transactional, while receiving and processing retrieved information may be considered transactional. Exemplary transactional processing is discussed in the examples below. Transactional processing may be carried out through the use of COM+. The transactional processing discussed below assumes COM+mechanisms. A fallback position is to make use of native SQL Server transactions.

### xvii. EXAMPLE 1

### Create Outbound Message

The client may already be in a transaction

Client may instantiate a WCF Message (COM+ Transaction Disabled) and fill in the properties

Client may instantiate WCF Send API (COM+Transaction Required) and send the message

WCF Send API may instantiate Message Storage Manager (COM+ Transaction Required) and save the message

Control returns to the client, and the transaction ends

Message Manager Agent may query the Message Storage Manager (COM+ No Transaction) for messages to route to the RREM

For each message:
Message Manager Agent may start a transaction
Message Manager Agent may instantiate the Message Storage Manager (COM+ Transaction Required) and gets all information for the message. It may check whether the message still needs to be routed to the RREM
Message Manager Agent may instantiates the RREM (COM+ Transaction Don't Care) and ask it to disposition the message
Message Manager Agent may ask the Message Storage Manager (COM+ Transaction Required) to update the message properties (including transport queue information)
Message Manager Agent may end the transaction.
The above transaction can be managed by placing it in a Message Manager Agent Helper Component, specified as COM+ Transaction Required. Since RREM dispatch can be considered as just another event type, this behavior can be placed in the Message Manager Event Handler.

### xviii. EXAMPLE 2

### Send Queued Messages

Transport Send Agent may instantiate the Message Storage Manager (COM+ No Transaction) and periodically query for devices that have messages that can be sent. For each Device:

Transport Send Agent may query the Message Storage Manager for messages that can be sent to the device, and for the current device transport window status.
For each message that the Transport Send Agent decides to pack into a WCF Packet:

Transport Send Agent may query the Message Storage Manager for the message (which may or may not be in a transaction) and check whether the message is still eligible to be sent on this transport and in this packet.

Transport Send Agent may formats the message into a WCF Packet

Transport Send Agent may send the packet using the transport module

Transport Send Agent may notify (via the Transport component) the Message Manager Event Handler that the send was performed for each message.

For each sent message:
Message Manager Event Handler may starts a transaction
Message Manager Event Handler may instantiate the Message Storage Manager (COM+ Transaction Required) and gets all information for the message. It may check whether the message is still queued to the transport that notified it ‘sent’.
Message Manager Event Handler may instantiate the RREM (COM+Transaction Don't Care) and asks it to determine the disposition the message.
Message Manager Event Handler may asks the Message Storage Manager (COM+ Transaction Required) to update the message properties (including transport queue information)
Message Manager Event Handler may end the transaction.
The above transaction can be managed by specifying the Message Manager Event Handler as COM+ Transaction required.

### xix. EXAMPLE 3

### Acknowledgement Received

Transport Module may receive a message and notify (via the Transport component) the Message Manager Receiver of the received message.
Message Manager Receiver may start a transaction
Message Manager Receiver may instantiate the Message Storage Manager (COM+ Transaction Required) and get all information for the message
Message Manager Receiver may instantiate the RREM (COM+ Transaction Don't Care) and notify it of the acknowledgement
Message Manager Receiver may ask the Message Storage Manager (COM+ Transaction Required) to update the message properties (including transport queue information) and handle the acknowledgement
Message Manager Receiver may end the transaction The above transaction can be managed by specifying the Message Manager Receiver as COM+ Transaction required.

### xx. EXAMPLE 4

### Data Message Received

Transport Module may receives a message and notify (via the Transport component) the Message Manager Receiver of the received message.
Message Manager Receiver may start a transaction
Message Manager Receiver may instantiate the Message Storage Manager (COM+ Transaction Required) ask it to store the message in the InBox
If the message requires acknowledgement and was saved successfully (or was a duplicate) Message Manager Receiver may create an acknowledgement message and ask the Message Storage Manager (COM+ Transaction Required) to save the Ack message in the OutBox.
Message Manager Receiver may end the transaction
The above transaction can be managed by specifying the Message Manager Receiver as COM+ Transaction required.

### xxi. EXAMPLE 5

### Deliver Received Messages (Message Delivery Agent)

The Message Delivery Agent may periodically check for deliverable messages using the Message Storage Manager.

For each deliverable message:
Message Delivery Agent may start a transaction
Message Delivery Agent may instantiate the Message Storage Manager (COM+ Transaction Required) and read the message. Message Delivery Agent may check whether the message is still eligible to be delivered.
Message Delivery Agent may instantiate the target application (COM+ transaction setting per the application's needs—for transactional messaging this would be Requires Transaction) and deliver the message.
If the message was accepted, Message Delivery Agent may update the message status using the Message Storage Manager.
Message Delivery Agent may end the transaction. Note that if the application used transactional messaging to defer the message handling, the transaction may continue in a separate stage.

If the message was accepted with deferred delivery, the application component may later instantiates the Deferred Delivery Helper (COM+ Transaction Supported) and notify it of the completion of delivery. The Deferred Delivery Helper may instantiate the Message Storage Manager (COM+ Transaction Required) and updates the ordered delivery status.

### xxii. EXAMPLE 6

### Transport Delivery Error Notification

Transport Send Agent may notifies the Transport component that a delivery error occurred

The Transport component may use the provided information to identify the affected message(s).

For each affected message the Transport component may notify the Message Manager Event Handler
Message Manager Event Handler may start a transaction
Message Manager Event Handler may instantiate the Message Storage Manager (COM+ Transaction Required)
In the case of a permanent and fatal error, the Message Manager Event Handler may use the Message Storage Manager (COM+ Transaction Required) to disable the transport for the device.
Message Manager Event Handler may use the Message Storage Manager (COM+ Transaction Required) to get all information for the message.
Message Manager Event Handler may instantiate the RREM (COM+ Transaction Don't Care) and asks it to determine the disposition of the message.
Message Manager Event Handler may ask the Message Storage Manager (COM+ Transaction Required) to update the message properties (including transport queue information)
Message Manager Event Handler may end the transaction.
The above transaction can be managed by specifying the Message Manager Event Handler as COM+ Transaction required.

xxiii. Routing, Retry, and Escalation Manager

The RREM may expose the one or more of the following services:
OnMessageEvent
   Purpose: Handle a message event.
   Input Parameters:
      The Event, one of:
         Queued (the message was queued to be sent)
         Sent (the message was accepted by a transport)
         Delivery Error (a transport notified of a delivery error)
         Message Status (a transport notified of message status)
         Timeout (a timeout occurred in a transport queue)
         Escalation (the escalation time was reached)
         Ack'd (an acknowledgement was received)
      The WCF Message (including all extended properties, except perhaps the content).
      Message Tag of the message
      Transport ID of the transport (Queued, Escalated only)
      Transport Error Information (Delivery Error only):
         Indication of whether the error is recoverable or fatal
         Transport-specific error code
      Transport Status Code (Message Status only)
      A flag indicating whether or not this message requires an Ack.
      A list of all transports (WCF Server: for the Device ID to which the message is addressed). For each such transport:
         Whether the message is in that transports queue, and if so also the following parameters:
         Status (within the transport queue)
         TransportPriority
         IgnoreWindow
         SentDateTime
         ProcessDateTime
   Output Parameters:
      A flag as to whether to mark the message as undeliverable in the Message OutBox
      Updated RREM parameters for the Message OutBox:
         EscalationDateTime
         EscalationRetryCount
         EscalationStrategy
      For each transport:
         An action to take with respect to the message and the Transport Queue: one of Do Nothing, Update, Queue, Remove; If other than Do Nothing or Remove, update the values for the RREM-assigned transport parameters as follows:
         TransportPriority
         IgnoreWindow
         ProcessDateTime
      Status It might be reasonable to allow the RREM to change a message status from Pending to Sent No Ack (and provide a different ProcessDateTime) to leave the message in the device transport window when an Ack was received on an alternate transport. Thus the WCF would have some say in the windowing strategy for the transport. On the other hand, perhaps this behavior belongs in the Transport Strategy).
      For Ack processing, the Message Manager may pre-populate the transport entries with the Remove action. The RREM can override this with an update if it so chooses.
   Notes:
      The Message Manager may pre-populate the output parameters with default values to provide, for example, a safety net for an RREM error.

xxiv. Transport Manager

The Transport Manager may expose one or more of the following services:
Initialize
   Purpose: Locate and initialize each transport
   Input Parameters:
      None.
   Output Parameters:
      None
   Notes:
      For WCF On-board architecture, the initialize method may need to be customized in order to locate and create the correct Transport Modules and Transport Strategy objects, as these may be created directly. This may be accommodated through a call to one or more factory methods, so as to isolate the code that must be customized.
      For WCF Server, the configuration of each Transport Module may include the CLSID or class name of the associated Transport Strategy object.
Shutdown
   Purpose: Shutdown and unload each transport.
   Input Parameters:
      None.
   Output Parameters:
      None
GetTransports
   Purpose: Obtain references to each loaded transport.
   Input Parameters:
      None.
   Output Parameters:
      List of references to WCF Transport objects.

xxv. Transport Management Interface

The transport management interface may expose one or more of the following services:
Initialize
   Purpose: Initialize the transport
   Input Parameters:
      A reference to the contained Transport Module, which the Transport Manager has created but not initialized. The Transport component takes ownership of the Transport Module.
      A reference to the contained Transport Strategy, which the Transport Manager has created but not initialized. The Transport component takes ownership of the Transport Module.
   Output Parameters:
      None
   Notes:
      This function may create a Transport Send Agent then initialize in turn the Transport Strategy, Transport Module, and Transport Send Agent.
      This function may subscribe to the Transport Module's AdviseXXX methods with a reference to the Transport component's implementation of IWCFxxxNotificationSink and IWCFxxxMessageSink. The Transport component (or an internal subcomponent) may implement these methods and handle message and notification events.
Shutdown
   Purpose: Shutdown the Transport Send Agent and Transport Module, and release the last reference to the contained components (WCF Server) or delete the contained components (WCF On-board architecture).
   Input Parameters:
      None.
   Output Parameters:
      None
OnMessage
   Purpose: Handle receipt of a message
   Input Parameters:
      Per IWCFxxxMessageSink.
   Output Parameters:
      Per IWCFxxxMessageSink
   Notes:
      This function may decode the received packet into one or more WCF Message objects and then invoke the Message Manager Receiver for each contained message.
      This function may be implemented by an internal sub-object.
OnMessageFailure
   Purpose: Handle receipt of a message failure notification.
   Input Parameters:
      Per IWCFxxxNotificationSink.
   Output Parameters:
      Per IWCFxxxNotificationSink
   Notes:
      This function may identify the affected message(s) and then invoke the Message Manager Event Handler for each contained message.
      This function may be implemented by an internal sub-object.
      A message sent that does not require an Ack may no longer be present in the transport queue when this notification arrives. If the transport module provides sufficient information to specifically identify the message but the message is not in the transport queue, the notification may be disregarded.
OnMessageStatus
   Purpose: Handle receipt of a message status notification.
   Input Parameters:
      Per IWCFxxxNotificationSink.
   Output Parameters:
      Per IWCFxxxNotificationSink
   Notes:
      This function may identify the affected message(s) and then invoke the Message Manager Event Handler for each contained message.
      This function may be implemented by an internal sub-object.
      A message sent that does not require an Ack may no longer be present in the transport queue when this notification arrives. If the transport module provides sufficient information to specifically identify the message but the message is not in the transport queue, the notification may be disregarded.
OnStatusChange
   Purpose: Handle notification of a change in Transport Module status.
   Input Parameters:
      Per IWCFxxxNotificationSink.
   Output Parameters:
      Per IWCFxxxNotificationSink
   Notes:
      This function may maintain the Transport Module's last reported status for query by the Transport Send Agent via AbleToSend.
      This function may be implemented by an internal sub-object.
OnDeviceStatus (WCF Server Only)
   Purpose: Handle notification of a change in Device Transport status.
   Input Parameters:
      Per IWCFxxxNotificationSink.
   Output Parameters:
      Per IWCFxxxNotificationSink
   Notes:
      This function may maintain the Transport Module's last reported status for query by the Transport Send Agent via AbleToSend.
      This function may be implemented by an internal sub-object.
OnMessageSent
   Purpose: Handle notification that a message was successfully sent via a transport.
   Input Parameters:
      Device ID of the message (WCF Server Only).
      Message Tag of the message
   Output Parameters:
      None
   Notes:
      This function may be called by the Transport Send Agent. It may reflect the notification to the Message Manager.
AbleToSend
   Purpose: Determine whether the Transport Module (according to its status) is able to accept messages at this time
   Input Parameters:
      None
   Output Parameters:
      True or False

xxvi. Transport Strategy Module

The Transport Strategy module 906c may expose one or more of the following services.
Initialize
   Purpose: Initialize the Transport Strategy
   Input Parameters:
      A reference to the Transport Module object for which the strategy is being initialized
   Output Parameters:
      None
Shutdown
   Purpose: Shutdown the Transport Strategy. This may allow for resource cleanup (e.g., WCF Server version should release any references to the Transport Module).
   Input Parameters:
      None
   Output Parameters:
      None
GetDevicePendingwindow
   Purpose: Obtain the transport's device pending window.
   Input Parameters:
      None
   Output Parameters:
      The device pending window
GetDeviceWindowTime
   Purpose: Obtain the transport's device window time.
   Input Parameters:
      None
   Output Parameters:
      The device window time
GetNetworkSendMax
   Purpose: Obtain the transport's maximum messages to send at a time
   Input Parameters:
      None
   Output Parameters:
      The transport's maximum messages to send at a time
GetNetworkSendWait
   Purpose: Obtain the transport's time to wait after sending max messages
   Input Parameters:
      None
   Output Parameters:
      The transport's time to wait after sending max messages
OnMessageStatus (WCF Server Only)
   Purpose: Perform transport-specific handling of notification of message status. Message-specific handling is performed by the RREM.
   Input Parameters:
      Device ID
      Device Address
      Transport Specific Status Code
   Output Parameters:
      None
OnMessageFailure (WCF Server Only)
   Purpose: Perform transport-specific handling of notification of message failure
   Input Parameters:
      Device ID
      Device Address
      Transport Specific Error Code
   Output Parameters:
      None
OnDeviceStatus (WCF Server Only)
   Purpose: Perform transport-specific handling of notification of device status
   Input Parameters:
      Device Address
      Device Aux Address
      Transport-Specific Status Code
      Device ID (if known)
   Output Parameters:
      None
OnMessageReceived (WCF Server Only)
   Purpose: Perform transport-specific handling of notification of message received
   Input Parameters:
      Device ID
      Device Address
   Output Parameters:
      None

xxvii. Transport Send Agent

The Transport Send Agents 906c, 908c may expose one or more of the following services.
Initialize
   Purpose: Initialize the Transport Send Agent
   Input Parameters:
      A reference to the Transport Module object
      A reference to the Transport object (to which OnMessageSent notifications should be passed)
      A reference to the Transport Strategy Object
   Output Parameters:
      None
   Notes:
      This function may start an internal thread that periodically polls the Transport Queue for messages to be sent.
      The Transport Send Agent may include a safety check that limits the transport-specific priority requested during send to the maximum priority supported by the Transport Module. This helps protect the Transport Module from possible errors in the RREM.
Shutdown
   Purpose: Shutdown the Transport Send Agent
   Input Parameters:
      None
   Output Parameters:
      None
   Notes:
      This function may terminate the internal thread and release held object references.

xxviii. Transport Multi-Art Helper
GetMPContent
   Purpose: Create the content for a multi-part message block to be placed into an outgoing packet.

Input Parameters:
MaxMPSize
MinMPSize
Remaining Space in Packet
DeviceID
Message Tag
Transport ID
Output Parameters:
   Buffer containing the packet content for the message block.
GetMPAckContent
   Purpose: Create the content for an acknowledgment to a multi-part message to be placed into an outgoing packet.
   Input Parameters:
      IWCFMessagelnternal
   Output Parameters:
      Buffer containing the packet content for the acknowledgement message block.

xxix. System Log

The System Log component may provides one or more of the following services:
Open Log
Close Log
Log a message
Set/query the log threshold

xxx. Message Log

The Message Log component provides one or more of the following services:
SaveRREMEventMessageLogEntry
SaveTransportPacketEventEntry
SaveTransportPacketContainedMessageEventEntry

The following Message Event Log events may be logged directly from their stored procedure implementations (i) Message saved or updated, (ii) Transport Queue message saved/updated/removed, and/or (iii) Message Renumbered

Conclusion

In the exemplary embodiments described herein include on-board vehicle systems and other vehicle mounted devices may include or be utilized with any appropriate voltage source, such as a battery, an alternator and the like, providing any appropriate voltage, such as about 12 Volts, about 24 Volts, about 42 Volts and the like. Further, the embodiments described herein may be used with any desired system or engine. Those systems or engines may comprises items utilizing fossil fuels, such as gasoline, natural gas, propane and the like, electricity, such as that generated by battery, magneto, solar cell and the like, wind and hybrids or combinations thereof. Those systems or engines may be incorporated into another systems, such as an automobile, a truck, a boat or ship, a motorcycle, a generator, an airplane and the like.

In the embodiments described above, the WCF includes computing systems, controllers, and other devices containing processors. These devices may contain at least one Central Processing Unit (“CPU”) and a memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the described methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It should be understood that the exemplary embodiments are not limited to the above-mentioned memories and that other memories may be supported.

It should be understood that various alternatives to the embodiments of the invention described herein may be employed in practicing the invention. Exemplary embodiments have been illustrated and described. Further, the claims should not be read as limited to the described order or elements unless stated to that effect. In addition, use of the term “means” in any claim is intended to invoke 35 U.S.C. §112, ¶ 6, and any claim without the word “means” is not so intended.

1. A system comprising:
at least one application program operable to originate to and terminate from a target unit electronic messages;
at least one transport module for exchanging with the target unit the electronic messages originated to and terminated from the at least one application program, the at least one transport module adapted to provide connectivity to the target unit via at least one of a plurality of networks; and
a communication framework adapted to select one of the at least one transport module based on dynamic-delivery policies, and in turn, to pass between the selected at least one transport modules and the application program the electronic messages originated to and terminated from the target unit.

2. The system of claim 1, wherein the at least one application program specifies delivery parameters for carrying out electronic messaging with the target unit.

3. The system of claim 1, wherein each of the plurality of networks is of a different communication format type, wherein each of the at least one transport module abstracts parameters indicative of one of the different communication format types to provide connectivity to the target unit via at least one of the plurality of networks, and wherein when the communication framework selects one of the at least one transport module of a given communication format type based on dynamic-delivery policies, it passes between the selected one of the at least one transport module and the application program the electronic messages originated to and terminate from the target unit according to the communication format corresponding to the given communication format type.

4. The system of claim 1, wherein the communication framework includes a multi-part message manager adapted to disassemble messages from the application program and reassemble incoming messages received across one of the plurality of networks from the target unit.

5. The system of claim 1, wherein the communication framework includes a routing, retry, and escalation manager adapted to select one of the plurality transport modules based on a priority assigned to the message.

6. The system of claim 5, wherein the priority assigned to the message is assigned by the -application program

7. The system of claim 6, wherein the priority assigned to the message is assigned by the routing, retry, and escalation manager, and whereby the routing, retry, and escalation manager is operable to assign the priority based on conditions of the wireless communication framework.

8. The system of claim 5, wherein the priority assigned to the message is assigned by the routing, retry, and escalation manager.

9. The system of claim 5, wherein the routing, retry, and escalation manager is adapted to select one of the at least one transport module that corresponds to a reliable and network when the priority of the message is high, and select one of the at least one transport module that corresponds to a low cost network when the priority of the message is low.

10. The system of claim 5, wherein the routing, retry, and escalation manager is adapted to batch the message with a plurality of other messages when the priority of the message is batch priority, and dispatch the message when a predetermined number of the other messages are batched with the message.

11. The system of claim 1, wherein the wireless communication framework is adapted to determine which of the plurality of networks are available to the target, and wherein the wireless communication framework is adapted to select the one or more of the plurality of transport modules that corresponds to the plurality of networks that are available to the target.

12. The system of claim 1, wherein the communication framework includes a message storage manager adapted to store the message until the message has been successfully transferred or delivered.

13. The system of claim 1, wherein the at least one of the plurality of networks is a wireless network.

14. A method for effectuating messaging between a computer and a target unit, the method comprising:
providing a computer including an application program and a communication framework;
dispatching the message from the application program to the communication framework;
processing the message in the communication framework to select at least one of a plurality of transport modules based on criteria dictated by the application program, each of the plurality of transport modules configured to connect to a respective one of a plurality of networks to establish messaging across the respective one of the plurality of networks; and
dispatching the message across a respective one of the networks to the target unit via the selected at least one of the plurality of transport modules.

15. The method of claim 14, wherein the step of processing the message in the communication framework includes:
identifying a priority assigned to the message by the application program; and
selecting the transport module based on the priority assigned by the application program.

16. The method of claim 15, wherein the step of processing the message further comprises:
selecting at least one transport module corresponding to a reliable network when the priority of the message is high; and
selecting at least one transport module corresponding to a low cost network when the priority of the message is low.

17. The method of claim 15, further comprising:
selecting a first of the least one the transport module that corresponds to a low cost network when the priority of the message is mix processing;
attempting to dispatch the message through the low cost network over a predetermined time period;
selecting a second of the at least one transport module that corresponds to a reliable network if the message is unable to be dispatched through the low cost network by a completion of the predetermined time period; and
dispatching the message across the reliable network.

18. The method according to claim 15, further comprising:
batching the message with a plurality of other messages when the priority of the message is batch priority; and
dispatching the message in the dispatching step when a predetermined number of the other messages are batched with the message.

19. The method of claim 15, wherein the step of processing the message further comprises:
determining which of the plurality of networks are available to the target unit; and
selecting at least one of the plurality of transport modules in the processing the message step that corresponds to one of the available networks.

20. The method of claim 15, further comprising the steps of:
maintaining the message in a storage area hosted by the communication framework when the message is unable to be transmitted to the target unit; and
transmitting the message to the target unit when the target unit is available for transmission.

21. The method of claim 14, further comprising:
disassembling the message into a plurality of chunks during the step of processing the message; and
transmitting the plurality of the chunks to the target unit during the step of dispatching.

22. The method of claim 21, wherein the step of disassembling comprises:
disassembling the message into a first predetermined chunk size if an available message size of the network corresponding to the selected transport module is greater than a prescribed size; and
disassembling the message into a second predetermined chunk size if the available message size of the network corresponding to the selected transport module is less than the prescribed size.

23. The method of claim 21, further comprising maintaining a record of what portion of the plurality of chunks has been sent to the target unit.

24. The method of claim 14, further comprising:
receiving a disassembled message in the communication framework across one of the plurality of networks from the target unit;
reassembling chunks of the disassembled message to form an assembled message; and
transmitting the assembled message to the application program.

25. The method of claim 14, further comprising:
determining if the message is urgent or non-urgent in the step of processing the message;
dispatching the message without requiring an acknowledgement when the message is determined to be non-urgent; and
requiring an acknowledgement from the target unit to verify receipt of the message after the dispatching step when the message is determined to be urgent.

26. The method of claim 14, further comprising:
assigning an order to the message, by the application program, with respect to at least one other message to form a plurality of prioritized messages in a priority order;
maintaining the message in the communication framework until all of the plurality of prioritized messages are received in the communication framework; and
dispatching each of the prioritized messages according to the priority order.

27. The method of claim 14, wherein the network is a wireless network.

28. The method of claim 14, wherein the network is a satellite network.

29. A method for effectuating messaging between a first unit and a second unit, the method comprising the steps of:
providing the first unit including a first plurality of application programs and a first communication framework, the first communication framework adapted to provide messaging capabilities for each of the first plurality of application programs;
providing the second unit including a second plurality of application programs and a second communication framework, the second communication framework adapted to provide messaging capabilities for each of the second plurality of application programs;
dispatching a message from one of the first application programs to the first communication framework;
processing the message with the first communication framework;
dispatching the message from the first communication framework to the second communication framework via a network;
processing the message with the second communication framework; and
dispatching the message to one of the second application programs.

30. The method of claim 29, wherein the step of processing the message with the first communication framework further comprises selecting at least one of a plurality of transport modules corresponding to the network based on criteria dictated by the one application program, each of the plurality of transport modules configured to connect to a respective one of a plurality of networks to establish messaging across the respective one of the plurality of networks.

31. The method of claim 30, wherein the step of processing the message in the first communication framework includes:
identifying a priority assigned to the message by the application program;
selecting at least one transport module corresponding to a reliable network when the priority of the message is high; and
selecting the transport module corresponding to a low cost network when the priority of the message is low.

32. The method of claim 31, further comprising:
selecting a first of the plurality of transport modules that corresponds to a low cost network when the priority of the message is mix processing;
attempting to dispatch the message through the low cost network over a predetermined time period;
selecting a second of the plurality of transport modules that corresponds to a reliable network when the message is unable to be dispatched through the low cost network by a completion of the predetermined time period; and
dispatching the message across the reliable network.

33. The method of claim 30, wherein the step of processing the message further comprises:
determining which of the plurality of networks are available to the target unit; and
selecting at least one of the plurality of transport modules in the processing the message with the first communication framework step to correspond to one of the available networks.

34. The method of claim 29, further comprising:
maintaining the message in a storage area hosted by the first communication framework when the message is unable to be transmitted to the second unit; and
transmitting the message to the second unit when the second unit is available for transmission.

35. The method of claim 29, further comprising:
disassembling the message into a plurality of chunks during the step of processing the message with the first communication framework;
dispatching the disassembled message to the second unit in the dispatching step; and
reassembling the disassembled message in the step of processing the message by the second communication framework.

36. The method of claim 35, further comprising:
disassembling the message into a first predetermined chunk size if an available message size of the network corresponding to the selected transport module is greater than a prescribed size; and
disassembling the message into a second predetermined chunk size if the available message size of the network corresponding to the selected transport module is less than the prescribed size.

37. The method according to claim 29, further comprising:
determining if the message is urgent or non-urgent in the step of processing the message with the first communication framework;
dispatching the message without requiring an acknowledgement when the message is determined to be non-urgent; and
requiring an acknowledgement from the target unit to verify receipt of the message after the dispatching step when the message is determined to be urgent.

38. The method according to claim 29, further comprising:
assigning an order to the message, by the first application program, with respect to at least one other message to form a plurality of prioritized messages in a priority order;
maintaining the message in the first communication framework until all of the plurality of prioritized messages are received in the first communication framework; and
dispatching each of the prioritized messages according to the priority order in the dispatching step.

39. The method according to claim 29, wherein the processing in the processing step includes formatting the message for the one of the second plurality of application programs.

40. A computer system comprising:
an application program means;
a plurality of transport module means for connecting to a respective one of a plurality of network means, the plurality of network means for providing a transport medium for sending and receiving electronic messaging to a target unit; and
a communication framework means for selecting one of the transport module means based on characteristics dictated by the application program means.

41. The computer system of claim 40, wherein the communication framework means includes a multi-part message manager means for disassembling messages from the application program means and reassembling incoming messages received from the target unit.

42. The computer system o claim 41, wherein the communication framework means includes a routing, retry, and escalation manager means for selecting one of the plurality transport module means based on a priority assigned to the message.

43. The computer system of claim 42, wherein the routing, retry, and escalation manager means selects the transport module corresponding to a reliable network when the priority of the message is high and selects the transport module corresponding to a low cost network when the priority of the message is low.

44. The computer system of claim 30, wherein the at least one network means is a wireless network.
